(19) United States
(12) Patent Application Publication
(10) Pub. No.: US 2014/0341285 A1
(43) Pub. Date: Nov. 20, 2014

(54) IMAGE PROCESSING DEVICE AND IMAGE PROCESSING METHOD

(71) Applicant: Sony Corporation, Tokyo (JP)

(72) Inventors: Hironari Sakurai, Tokyo (JP); Yoshitomo Takahashi, Kanagawa (JP); Shinobu Hattori, Tokyo (JP)

(73) Assignee: Sony Corporation, Tokyo (JP)

(21) Appl. No.: 14/370,499

(22) PCT Filed: Jan. 23, 2013
(86) PCT No.: PCT/JP2013/051264

§ 371 Date: Jul. 3, 2014

(30) Foreign Application Priority Data
Jan. 31, 2012 (JP) 2012-018979

(51) Int. Cl. H04N 19/597; H04N 13/00; H04N 19/44

(52) U.S. Cl. CPC H04N 19/00769; H04N 19/00533; H04N 13/0022
USPC 375/240.12

(57) ABSTRACT

The present technology relates to an image processing device and an image processing method that are capable of improving the encoding efficiency of a parallax image by using information relating to the parallax image. A correction unit sets a calculation precision of a calculation that is used when performing a depth weighting prediction process that uses a depth weighting coefficient and a depth offset with the depth image as a target. A correction unit performs the depth weighting prediction process in relation to the depth image according to the calculation precision that is set, and generates a depth prediction image. A calculation unit generates a depth stream by encoding the depth image using the depth prediction image. The present technology can be applied to an encoding device of the parallax image, for example.

### TECHNICAL FIELD

The present technology relates to an image processing device and an image processing method; in particular, to an image processing device and an image processing method that are capable of improving the encoding efficiency of a parallax image by using information relating to the parallax image.

### BACKGROUND ART

In recent years, there is a focus on 3D images, and an encoding method of the parallax image that is used in generation of multi-view 3D images is proposed (for example, refer to NPL 1). Furthermore, a parallax image is an image formed of parallax values that indicate the distances in the horizontal direction of positions on a screen between each pixel of a color image of a viewpoint corresponding to the parallax image and the pixels of a color image of a viewpoint, which is a base point, that correspond to those pixels.

In addition, with the object of further improving the encoding efficiency in comparison to the AVC (Advanced Video Coding) method, progress has been made in the standardization of an encoding method known as HEVC (High Efficiency Video Coding), and at the time of writing, August 2011, NPL 2 has been published as a draft.

### CITATION LIST

### Non Patent Literature

NPL 1: “Call for Proposals on 3D Video Coding Technology”, ISO/IEC JTC1/SC29/WG11, MPEG 2011/N12036, Geneva, Switzerland, March 2011
NPL 2: Thomas Wiegand, Woo-jin Han, Benjamin Bross, Jens-Rainer Ohm, Gary J. Sullivian, “WD3: Working Draft 3 of High-Efficiency Video Coding”, JCTVC-E603_d5 (version 5), 20 May 2011

### SUMMARY OF INVENTION

### Technical Problem

However, an encoding method that improves the encoding efficiency of a parallax image by using information relating to the parallax image was not devised.

The present technology was made in consideration of this situation, and is capable of improving the encoding efficiency of the parallax image by using information relating to the parallax image.

### Solution to Problem

An image processing device of a first aspect of the present technology is an image processing device that includes a setting unit that sets a calculation precision of a calculation that is used when performing a depth weighting prediction process with a depth image as a target using a depth weighting coefficient and a depth offset; a depth weighting prediction unit that generates a depth prediction image by performing the depth weighting prediction process in relation to the depth image using information relating to the depth image according to the calculation precision that is set by the setting unit; and an encoding unit that generates a depth stream by encoding the depth image using the depth prediction image that is generated by the depth weighting prediction unit.

An image processing method of the first aspect of the present technology corresponds to the image processing device of the first aspect of the present technology.

In the first aspect of the present technology, the calculation precision of the calculation that is used when performing the depth weighting prediction process that uses the depth weighting coefficient and the depth offset with the depth image as the target is set, the depth weighting prediction process is performed in relation to the depth image using the information relating to the depth image according to the calculation precision that is set, the depth prediction image is generated, and the depth stream is generated by encoding the depth image using the depth prediction image that is generated.

An image processing device of a second aspect of the present technology is an image processing device that includes a reception unit that receives a depth stream, which is encoded using a depth prediction image that is corrected using information relating to a depth image, and the information relating to the depth image; a decoding unit that generates the depth image by decoding the depth stream that is received by the reception unit; a setting unit that sets a calculation precision of a calculation that is used when performing a depth weighting prediction process with the depth image that is generated by the decoding unit as a target using a depth weighting coefficient and a depth offset; and a depth weighting prediction unit that generates the depth prediction image by performing the depth weighting prediction in relation to the depth image using the information relating to the depth image that is received by the reception unit according to the calculation precision that is set by the setting unit, in which the decoding unit decodes the depth stream using the depth prediction image that is generated by the depth weighting prediction unit.

An image processing method of the second aspect of the present technology corresponds to the image processing device of the second aspect of the present technology.

In the second aspect of the present technology, a depth stream, which is encoded using a depth prediction image that is corrected using information relating to a depth image, and the information relating to the depth image are received; the depth image is generated by the received depth stream being decoded; a calculation precision of a calculation that is used when performing a depth weighting prediction process with the depth image that is generated as a target using a depth weighting coefficient and a depth offset is set; and the depth prediction image is generated by the depth weighting prediction being performed in relation to the depth image using the information relating to the depth image that is received according to the calculation precision that is set. The depth prediction image is used during the decoding of the depth stream.

### Advantageous Effects of Invention

According to the first aspect of the present technology, it is possible to improve the encoding efficiency of the parallax image using the information relating to the parallax image.

In addition, according to the second aspect of the present technology, it is possible to decode the encoded data of the parallax image in which the encoding efficiency is improved by encoding using the information relating to the parallax image.

### BRIEF DESCRIPTION OF DRAWINGS

FIG. 1 is a block diagram that shows a configuration example of one embodiment of an encoding device to which the present technology is applied.

FIG. 2 is a diagram that illustrates a parallax maximum value and a parallax minimum value of viewpoint generation information.

FIG. 3 is a diagram that illustrates parallax precision parameters of the viewpoint generation information.

FIG. 4 is a diagram that illustrates an inter-camera distance of the viewpoint generation information.

FIG. 5 is a block diagram that shows a configuration example of a multi-view image encoding unit of FIG. 1.

FIG. 6 is a block diagram that shows a configuration example of an encoding unit.

FIG. 7 is a diagram that shows a configuration example of an encoded bitstream.

FIG. 8 is a diagram that shows an example of syntax of a PPS of FIG. 7.

FIG. 9 is a diagram that shows an example of syntax of a slice header.

FIG. 10 is a diagram that shows an example of syntax of a slice header.

FIG. 11 is a flowchart that illustrates an encoding process of the encoding device of FIG. 1.

FIG. 12 is a flowchart that illustrates a multi-view encoding process of FIG. 11 in detail.

FIG. 13 is a flowchart that illustrates a parallax image encoding process of FIG. 12 in detail.

FIG. 14 is a flowchart that illustrates a parallax image encoding process of FIG. 12 in detail.

FIG. 15 is a block diagram that shows a configuration example of one embodiment of a decoding device to which the present technology is applied.

FIG. 16 is a block diagram that shows a configuration example of a multi-view image decoding unit of FIG. 15.

FIG. 17 is a block diagram that shows a configuration example of a decoding unit.

FIG. 18 is a flowchart that illustrates a decoding process of a decoding device 150 of FIG. 15.

FIG. 19 is a flowchart that illustrates a multi-view decoding process of FIG. 18 in detail.

FIG. 20 is a flowchart that illustrates a parallax image decoding process of FIG. 16 in detail.

FIG. 21 is a diagram that illustrates a delivery method of information that is used in correction of a prediction image.

FIG. 22 is a diagram that shows a configuration example of an encoded bitstream in a second delivery method.

FIG. 23 is a diagram that shows a configuration example of an encoded bitstream in a third delivery method.

FIG. 24 is a block diagram that shows a configuration example of a slice encoding unit.

FIG. 25 is a block diagram that shows a configuration example of an encoding unit.

FIG. 26 is a block diagram that shows a configuration example of a correction unit.

FIG. 27 is a diagram for illustrating a parallax value and a position in a depth direction.

FIG. 28 is a diagram that shows an example of a positional relationship between imaged objects.

FIG. 29 is a diagram that illustrates a relationship between maximum and minimum positions in the depth direction.

FIG. 30 is a diagram for illustrating the positional relationship between the imaged objects, and luminosity.

FIG. 31 is a diagram for illustrating the positional relationship between the imaged objects, and the luminosity.

FIG. 32 is a diagram for illustrating the positional relationship between the imaged objects, and luminosity.

FIG. 33 is a flowchart that illustrates the parallax image encoding process in detail.

FIG. 34 is a flowchart that illustrates the parallax image encoding process in detail.

FIG. 35 is a flowchart for illustrating a prediction image generation process.

FIG. 36 is a block diagram that shows a configuration example of a slice decoding unit.

FIG. 37 is a block diagram that shows a configuration example of a decoding unit.

FIG. 38 is a block diagram that shows a configuration example of a correction unit.

FIG. 39 is a flowchart that illustrates a parallax image decoding process in detail.

FIG. 40 is a flowchart for illustrating a prediction image generation process.

FIG. 41 is a diagram that shows a configuration example of one embodiment of a computer.

FIG. 42 is a diagram that shows a schematic configuration example of a television device to which the present technology is applied.

FIG. 43 is a diagram that shows a schematic configuration example of a mobile telephone to which the present technology is applied.

FIG. 44 is a diagram that shows a schematic configuration example of a recording and reproduction device to which the present technology is applied.

FIG. 45 is a diagram that shows a schematic configuration example of an imaging device to which the present technology is applied.

### DESCRIPTION OF EMBODIMENTS

### One Embodiment

### [Configuration Example of One Embodiment of Encoding Device]

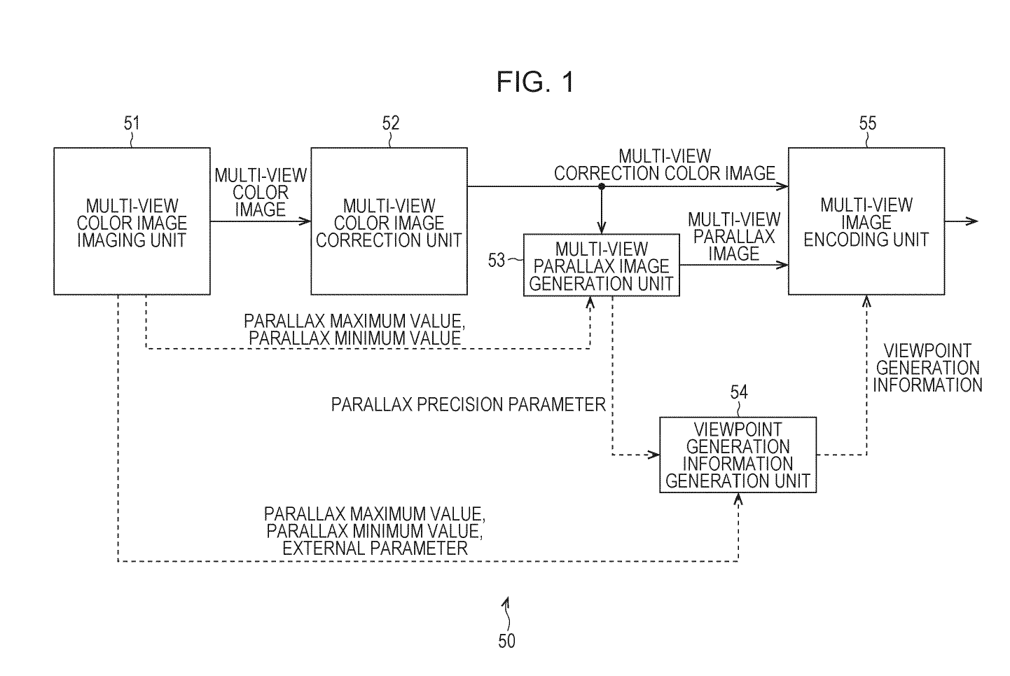

FIG. 1 is a block diagram that shows a configuration example of one embodiment of an encoding device to which the present technology is applied.

An encoding device 50 of FIG. 1 is configured of a multi-view color image imaging unit 51, a multi-view color image correction unit 52, a multi-view parallax image correction unit 53, a viewpoint generation information generation unit 54, and a multi-view image encoding unit 55.

The encoding device 50 encodes the parallax image of a predetermined viewpoint using information relating to the parallax image.

Specifically, the multi-view color image imaging unit 51 of the encoding device 50 images color images of multiple viewpoints and supplies the images to the multi-view color image correction unit 52 as a multi-view color image. In addition, the multi-view color image imaging unit 51 generates an external parameter, the parallax maximum value and the parallax minimum value (described in detail hereinafter). The multi-view color image imaging unit 51 supplies the external parameter, the parallax maximum value and the parallax minimum value to the viewpoint generation information generation unit 54, and supplies the parallax maximum value and the parallax minimum value to the multi-view parallax image generation unit 53.

Furthermore, the external parameter is a parameter that defines the position in the horizontal direction of the multi-view color image imaging unit 51. In addition, the parallax maximum value and the parallax minimum value are the maximum value and the minimum value of the parallax values on a global coordinate that can be assumed in the multi-view parallax image, respectively.

The multi-view color image correction unit 52 performs color correction, luminosity correction, distortion correction and the like in relation to a multi-view color image that is supplied from the multi-view color image imaging unit 51. Accordingly, the focal length in the horizontal direction (an X direction) of the multi-view color image imaging unit 51 in the post-correction multi-view color image is shared by all viewpoints. The multi-view color image correction unit 52 supplies the post-correction multi-view color image to the multi-view parallax image generation unit 53 and the multi-view image encoding unit 55 as a multi-view corrected color image.

The multi-view parallax image generation unit 53 generates a multi-view parallax image from the multi-view corrected color image that is supplied from the multi-view color image correction unit 52 based on the parallax maximum value and the parallax minimum value that are supplied from the multi-view color image imaging unit 51. Specifically, the multi-view parallax image generation unit 53 obtains the parallax values of each pixel from the multi-view corrected color image in relation to each viewpoint of the multiple viewpoints, and normalizes the parallax values based on the parallax maximum value and the parallax minimum value. Furthermore, the multi-view parallax image generation unit 53 generates the parallax image, in which the parallax values of each pixel that is normalized in relation to each viewpoint of the multiple viewpoints are set to the pixel values of each pixel of the parallax image.

In addition, the multi-view parallax image generation unit 53 supplies the multi-view parallax image that is generated to the multi-view image encoding unit 55 as the multi-view parallax image. Furthermore, the multi-view parallax image generation unit 53 generates the parallax precision parameter that indicates the precision of the pixel values of the multi-view parallax image, and supplies the parallax precision parameter to the viewpoint generation information generation unit 54.

Using a multi-view corrected color image and the parallax image, the viewpoint generation information generation unit 54 generates the viewpoint generation information that is used when generating the color image of a viewpoint other than the multiple viewpoints. Specifically, the viewpoint generation information generation unit 54 obtains the inter-camera distance based on the external parameter that is supplied from the multi-view color image imaging unit 51. The inter-camera distance is, for each viewpoint of the multi-view parallax image, the distance between the position in the horizontal direction of the multi-view color image imaging unit 51 when imaging the color image of the viewpoint, and the position in the horizontal direction of the multi-view color image imaging unit 51 when imaging the color image that has parallax that corresponds to the color image and the parallax image.

The viewpoint generation information generation unit 54 sets the parallax maximum value, the parallax minimum value and the inter-camera distance from the multi-view color image imaging unit 51, and the parallax precision parameter from the multi-view parallax image generation unit 53 as the viewpoint generation information. The viewpoint generation information generation unit 54 supplies the viewpoint generation information that is generated to the multi-view image encoding unit 55.

The multi-view image encoding unit 55 encodes the multi-view corrected color image that is supplied from the multi-view color image correction unit 52 using the HEVC method. In addition, of the viewpoint generation information that is supplied from the viewpoint generation information generation unit 54, the multi-view image encoding unit 55 uses the parallax maximum value, the parallax minimum value and the inter-camera distance as the information relating to the parallax, and encodes the multi-view parallax image that is supplied from the multi-view parallax image generation unit 53 using a method that conforms to the HEVC method.

In addition, of the viewpoint generation information that is supplied from the viewpoint generation information generation unit 54, the multi-view image encoding unit 55 subjects the parallax maximum value, the parallax minimum value and the inter-camera distance to delta encoding. The multi-view image encoding unit 55 includes the parallax maximum value, the parallax minimum value and the inter-camera distance, which are delta encoded, in the information (the encoding parameters) relating to the encoding that is used when encoding the multi-view parallax image. Furthermore, the multi-view image encoding unit 55 delivers a bitstream formed of the multi-view corrected color image and the multi-view parallax image that are encoded, the information relating to the encoding that includes the parallax maximum value, the parallax minimum value and the inter-camera distance that are delta encoded, the parallax precision parameter and the like from the viewpoint generation information generation unit 54 as an encoded bitstream.

As described above, since the multi-view image encoding unit 55 subjects the parallax maximum value, the parallax minimum value and the inter-camera distance to delta encoding then performs delivery, it is possible to reduce the code amount of the viewpoint generation information. Since there is a high likelihood that the parallax maximum value, the parallax minimum value and the inter-camera distance are not caused to greatly change between pictures in order to provide a comfortable 3D image, performing delta encoding is effective in the reduction of the code amount.

Furthermore, in the encoding device 50, the multi-view parallax image is generated from the multi-view corrected color image; however, the multi-view parallax image may be generated by a sensor that detects the parallax values during the imaging of the multi-view color image.

### [Description of Viewpoint Generation Information]

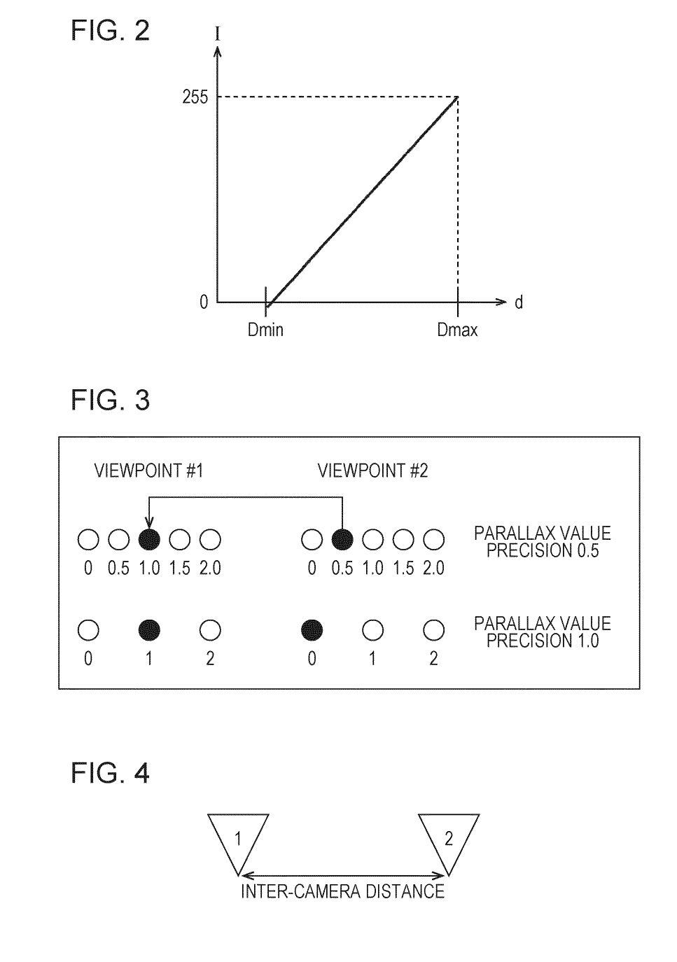

FIG. 2 is a diagram that illustrates the parallax maximum value and the parallax minimum value of the viewpoint generation information.

Furthermore, in FIG. 2, the horizontal axis is a pre-normalization parallax value, and the vertical axis is the pixel value of the parallax image.

As shown in FIG. 2, the multi-view parallax image generation unit 53 normalizes the parallax values of each pixel to a value of, for example, 0 to 255 using a parallax minimum value Dmin and a parallax maximum value Dmax. Furthermore, the multi-view parallax image generation unit 53 generates the parallax image, in which the parallax values of each pixel after normalization that are a value of one of 0 to 255 are set to the pixel values.

In other words, a pixel value I of each pixel of the parallax image, a pre-normalization parallax value d of the pixel, the parallax minimum value Dmin and the parallax maximum value Dmax are represented by the following Equation (1).

$$\begin{matrix}[ Formula . 1 ] & \\ I = \frac{255 * ( d - {D}_{min} )}{{D}_{max} - {D}_{min}} & ( 1 )\end{matrix}$$

Therefore, in the decoding device described below, according to the following Equation (2), it is necessary to restore the pre-normalization parallax value d from the pixel values I of each pixel of the parallax image using the parallax minimum value Dmin and the parallax maximum value Dmax.

$$\begin{matrix}[ Formula . 2 ] & \\ d = \frac{I}{255} ( {D}_{max} - {D}_{min} ) + {D}_{min} & ( 2 )\end{matrix}$$

Accordingly, the parallax minimum value Dmin and the parallax maximum value Dmax are delivered to the decoding device.

FIG. 3 is a diagram that illustrates the parallax precision parameters of the viewpoint generation information.

As shown in the upper row of FIG. 3, when the pre-normalization parallax value is 0.5 for a post-normalization parallax value of 1, the parallax precision parameter indicates a parallax value precision of 0.5. In addition, as shown in the lower row of FIG. 3, when the pre-normalization parallax value is 1 for a post-normalization parallax value of 1, the parallax precision parameter indicates a parallax value precision of 1.0.

In the example of FIG. 3, the pre-normalization parallax value of a viewpoint #1, which is the first viewpoint, is 1.0, and the pre-normalization parallax value of a viewpoint #2, which is the second viewpoint, is 0.5. Therefore, the post-normalization parallax value of the viewpoint #1 is 1.0, whether the parallax value precision is 0.5 or 1.0. On the other hand, the parallax value of the viewpoint #2 is 0.5 when the parallax value precision is 0.5, and 0 when the parallax value precision is 1.0.

FIG. 4 is a diagram that illustrates the inter-camera distance of the viewpoint generation information.

As shown in FIG. 4, the inter-camera distance of the parallax image of the viewpoint #1 with the viewpoint #2 as the base point is the distance between the position indicated by the external parameter of the viewpoint #1 and the position indicated by external parameter of the viewpoint #2.

### [Configuration Example of Multi-View Image Encoding Unit]

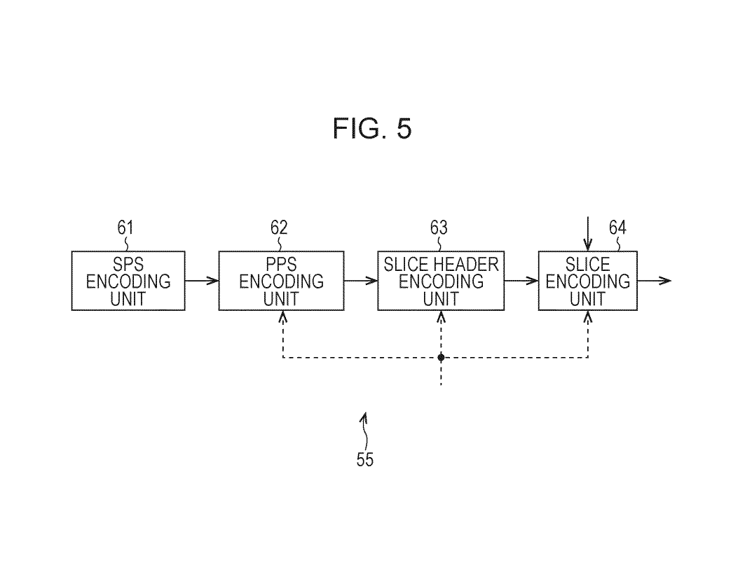

FIG. 5 is a block diagram that shows a configuration example of the multi-view image encoding unit 55 of FIG. 1.

The multi-view image encoding unit 55 of FIG. 5 is configured of an SPS encoding unit 61, a PPS encoding unit 62, a slice header encoding unit 63 and a slice encoding unit 64.

The SPS encoding unit 61 of the multi-view image encoding unit 55 generates an SPS in sequence units and supplies the SPS to the PPS encoding unit 62.

The PPS encoding unit 62 determines whether or not the parallax maximum value, the parallax minimum value and the inter-camera distance within the viewpoint generation information that is supplied from the viewpoint generation information generation unit 54 of FIG. 1 of all the slices that configure a unit to which the same PPS is added (hereinafter referred to as the same PPS unit), match the parallax maximum value, the parallax minimum value and the inter-camera distance of the slice that is one prior to the respective slice in the encoding order.

Furthermore, when it is determined that the parallax maximum value, the parallax minimum value and the inter-camera distance of all the slices that configure the same PPS unit match the parallax maximum value, the parallax minimum value and the inter-camera distance of the slice that is one prior in the encoding order, the PPS encoding unit 62 generates a delivery flag that indicates the absence of delivery of a delta encoding result of the parallax maximum value, the parallax minimum value and the inter-camera distance.

On the other hand, when it is determined that the parallax maximum value, the parallax minimum value and the inter-camera distance of at least one of the slices that configure the same PPS unit does not match the parallax maximum value, the parallax minimum value and the inter-camera distance of the slice that is one prior in the encoding order, the PPS encoding unit 62 generates a delivery flag that indicates the presence of delivery of the delta encoding result of the parallax maximum value, the parallax minimum value and the inter-camera distance.

The PPS encoding unit 62 generates a PPS that includes the delivery flag and the parallax precision parameter of the viewpoint generation information. The PPS encoding unit 62 adds the PPS to the SPS that is supplied from the SPS encoding unit 61 and supplies the SPS to the slice header encoding unit 63.

When the delivery flag that is included in the PPS that is supplied from the PPS encoding unit 62 indicates an absence of delivery, as the slice header of each slice that configures the same PPS unit of the PPS, the slice header encoding unit 63 generates information relating to the encoding other than the parallax maximum value, the parallax minimum value and the inter-camera distance of the slice.

Meanwhile, when the delivery flag that is included in the PPS that is supplied from the PPS encoding unit 62 indicates a presence of delivery, the slice header encoding unit 63 generates information relating to the encoding that includes the parallax maximum value, the parallax minimum value and the inter-camera distance of the slice as the slice header of an intra-type slice that configures the same PPS unit of the PPS.

In addition, in this case, in relation to the inter-type slices that configure the same PPS unit of the PPS, the slice header encoding unit 63 subjects the parallax maximum value, the parallax minimum value and the inter-camera distance of the slice to delta encoding. Specifically, from the parallax maximum value, the parallax minimum value and the inter-camera distance of the inter-type slice of the viewpoint generation information that is supplied from the viewpoint generation information generation unit 54, the slice header encoding unit 63 respectively subtracts the parallax maximum value, the parallax minimum value and the inter-camera distance of the slice that is one prior to the slice in the encoding order, and obtains the delta encoding results therefrom. Furthermore, the slice header encoding unit 63 generates the delta encoding results of the parallax maximum value, the parallax minimum value and the inter-camera distance as the slice header of the inter-type slice. The slice header encoding unit 63 further adds the slice header that is generated to the SPS, to which the PPS that is supplied from the PPS encoding unit 62 is added, and supplies the SPS to the slice encoding unit 64.

The slice encoding unit 64 performs encoding of slice units in relation to the multi-view corrected color image that is supplied from the multi-view color image correction unit 52 of FIG. 1 using the HEVC method. In addition, of the viewpoint generation information that is supplied from the viewpoint generation information generation unit 54, the slice encoding unit 64 uses the parallax maximum value, the parallax minimum value and the inter-camera distance as the information relating to the parallax, and performs encoding of slice units in relation to the multi-view parallax image from the multi-view parallax image generation unit 53 using a method that conforms to the HEVC method. The slice encoding unit 64 adds the encoded data and the like of slice units that is obtained as a result of the encoding to the SPS, to which the PPS and the slice header that are supplied from the slice header encoding unit 63 are added, and generates the bitstream. The slice encoding unit 64 functions as a delivery unit and delivers the bitstream as an encoded bitstream.

### [Configuration Example of Slice Encoding Unit]

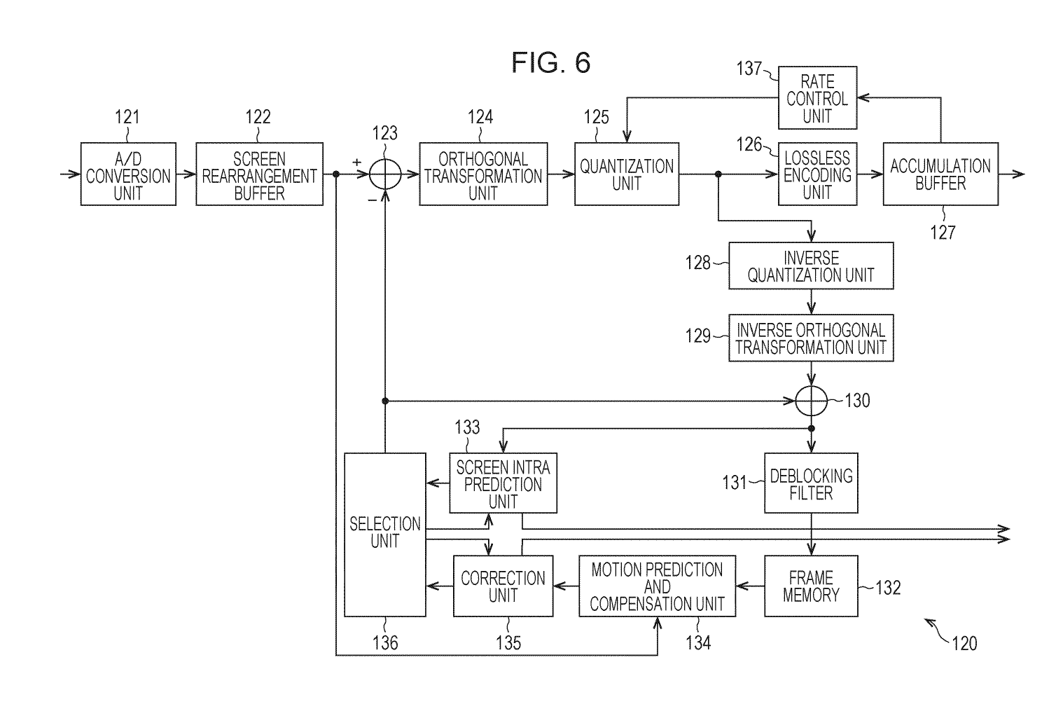

FIG. 6 is a block diagram that shows a configuration example of the encoding unit that encodes the parallax image of one arbitrary viewpoint within the slice encoding unit 64 of FIG. 5. In other words, the encoding unit that encodes the multi-view parallax image within the slice encoding unit 64 is configured of a number of encoding units 120 of FIG. 6 corresponding to the number of viewpoints.

The encoding unit 120 of FIG. 6 is configured of an A/D conversion unit 121, a screen rearrangement buffer 122, a calculation unit 123, an orthogonal transformation unit 124, a quantization unit 125, a lossless encoding unit 126, an accumulation buffer 127, an inverse quantization unit 128, an inverse orthogonal transformation unit 129, an addition unit 130, a deblocking filter 131, frame memory 132, a screen intra prediction unit 133, a motion prediction and compensation unit 134, a correction unit 135, a selection unit 136 and a rate control unit 137.

The A/D conversion unit 121 of the encoding unit 120 subjects a multiplexed image of frame units of a predetermined viewpoint that is supplied from the multi-view parallax image generation unit 53 of FIG. 1 to A/D conversion. The A/D conversion unit 121 outputs the multiplexed image and causes the screen rearrangement buffer 122 to store the multiplexed image. The screen rearrangement buffer 122 rearranges the parallax images of frame units that are in the stored order of display into an order for encoding according to a GOP (Group of Picture) structure. The screen rearrangement buffer 122 outputs the rearranged parallax images of frame units to the calculation unit 123, the screen intra prediction unit 133 and the motion prediction and compensation unit 134.

The calculation unit 123 functions as an encoding unit and encodes the encoding-target parallax images by calculating the delta of the prediction image that is supplied from the selection unit 136 and the encoding-target parallax image that is output from the screen rearrangement buffer 122. Specifically, the calculation unit 123 subtracts the prediction image that is supplied from the selection unit 136 from the encoding-target parallax image that is output from the screen rearrangement buffer 122. The calculation unit 123 outputs the image that is obtained as a result of the subtraction to the orthogonal transformation unit 124 as residual information. Furthermore, when the prediction image is not supplied from the selection unit 136, the calculation unit 123 outputs the parallax image that is read out from the screen rearrangement buffer 122 to the orthogonal transformation unit 124 in an unchanged manner as residual information.

The orthogonal transformation unit 124 subjects the residual information from the calculation unit 123 to an orthogonal transformation such as the Discrete Cosine Transform or the Karhunen-Loeve Transform, and supplies the coefficient that is obtained as a result to the quantization unit 125.

The quantization unit 125 quantizes the coefficient that is supplied from the orthogonal transformation unit 124. The quantized coefficient is input to the lossless encoding unit 126.

The lossless encoding unit 126 performs lossless encoding such as variable length encoding (for example, CAVLC (Context-Adaptive Variable Length Coding) or the like) or arithmetic encoding (for example, CABAC (Context-Adaptive Binary Arithmetic Coding) or the like) or the like in relation to the quantized coefficient that is supplied from the quantization unit 125. The lossless encoding unit 126 supplies the encoded data that is obtained as a result of the lossless encoding to the accumulation buffer 127 and causes the accumulation buffer 127 to accumulate the encoded data.

The accumulation buffer 127 temporarily stores the encoded data that is supplied from the lossless encoding unit 126 and outputs the encoded data in slice units. The encoded data of slice units that is output is added to the SPS, to which the PPS and the slice header that are supplied from the slice header encoding unit 63 are added, and the SPS is rendered as an encoded stream.

In addition, the quantized coefficient that is output by the quantization unit 125 is also input to the inverse quantization unit 128. After being subjected to inverse quantization, the coefficient is supplied to the inverse orthogonal transformation unit 129.

The inverse orthogonal transformation unit 129 subjects the coefficient that is supplied from the inverse quantization unit 128 to an inverse orthogonal transformation such as the inverse Discrete Cosine Transform or the inverse Karhunen-Loeve Transform, and supplies the residual information that is obtained as a result to the addition unit 130.

The addition unit 130 adds the residual information, which is the decoding-target parallax image that is supplied from the inverse orthogonal transformation unit 129, to the prediction image that is supplied from the selection unit 136 and obtains a parallax image that is locally decoded. Furthermore, when the prediction image is not supplied from the selection unit 136, the addition unit 130 treats the residual information that is supplied from the inverse orthogonal transformation unit 129 as the locally decoded parallax image. The addition unit 130 supplies the parallax image that is locally decoded to the deblocking filter 131 and also supplies the parallax image to the screen intra prediction unit 133 as a reference image.

The deblocking filter 131 removes block distortion by filtering the parallax image, which is supplied from the addition unit 130 and is locally decoded. The deblocking filter 131 supplies the parallax image that is obtained as a result to the frame memory 132 and causes the frame memory 132 to accumulate the parallax image. The parallax image that is accumulated in the frame memory 132 is output to the motion prediction and compensation unit 134 as a reference image.

The screen intra prediction unit 133 performs screen intra prediction of all intra prediction modes that are candidates using the reference image that is supplied from the addition unit 130 and generates the prediction image.

In addition, the screen intra prediction unit 133 calculates cost function values (described in detail hereinafter) in relation to all the intra prediction modes that are candidates. Furthermore, the screen intra prediction unit 133 determines the intra prediction mode with the smallest cost function value to be an optimal intra prediction mode. The screen intra prediction unit 133 supplies the prediction image that is generated using the optimal intra prediction mode and the corresponding cost function value to the selection unit 136. When the screen intra prediction unit 133 receives notification of the selection of the prediction image that is generated using the optimal intra prediction mode from the selection unit 136, the screen intra prediction unit 133 includes the screen intra prediction information that indicates the optimal intra prediction mode and the like in the slice header that is supplied from the slice header encoding unit 63 as information relating to encoding.

Furthermore, the cost function value is also referred to as an RD (Rate Distortion) cost. For example, the cost function value is calculated based on a method of one of a High Complexity mode and a Low Complexity mode, such as those defined in the JM (Joint Model), which is the reference software in the H.264/AVC method.

Specifically, when the High Complexity mode is adopted as the calculation method of the cost function value, up to the lossless encoding is temporarily performed in relation to all the prediction modes that are candidates, and the cost function value that is represented in the following Equation (3) is calculated in relation to each prediction mode.

Cost(Mode)=D+λ·R (3)

D is the delta (the distortion) of the original image and the decoded image, R is the generated code amount that includes up to the coefficient of the orthogonal transform, and λ is the Lagrange multiplier that is provided as a function of the quantization parameter QP.

On the other hand, when the Low Complexity mode is adopted as the calculation method of the cost function value, the generation of the decoded image, and, the calculation of a header bit such as the information indicating the prediction mode are performed in relation to all the prediction modes that are candidates, and the cost function that is represented by the following Equation (4) is calculated in relation to each prediction mode.

Cost(Mode)=D+QPtoQuant(QP)·Header_Bit (4)

D is the delta (the distortion) of the original image and the decoded image, Header_Bit is the header bit in relation to the prediction mode, QPtoQuant is a function that is provided as a function of the quantization parameter QP.

In the Low Complexity mode, it is sufficient to only generate the decoded image in relation to all the prediction modes, and since it is not necessary to perform lossless encoding, the required calculation amount is little. Furthermore, here, it is assumed that the High Complexity mode is adopted as the calculation mode of the cost function value.

The motion prediction and compensation unit 134 generates a motion vector by performing the motion prediction process of all the inter prediction modes that are candidates based on the parallax images that are supplied from the screen rearrangement buffer 122 and the reference image that is supplied from the frame memory 132. Specifically, the motion prediction and compensation unit 134 generates the motion vector by matching the reference image with the parallax image that is supplied from the screen rearrangement buffer 122 for each inter prediction mode.

Furthermore, the inter prediction mode is the information that indicates the size, the prediction direction and the reference index of the blocks that are the targets of inter prediction. The prediction directions include the prediction (L0 prediction) of a forward direction that uses a reference image with a display time that is sooner than that of the parallax image that is the target of the inter prediction, the prediction (L1 prediction) of a backward direction that uses a reference image with a display time that is later than that of the parallax image that is the target of the inter prediction, and the prediction (Bi-prediction) of both directions that uses a reference image with a display time that is sooner, and a reference image with a display time that is later, than that of the parallax image that is the target of the inter prediction. In addition, the reference index is a number for specifying the reference image. For example, the closer the reference index of the image is to the parallax image that is the target of the inter prediction, the smaller the number.

In addition, the motion prediction and compensation unit 134 functions as a prediction image generation unit and performs the motion compensation process by reading out the reference image from the frame memory 132 based on the generated motion vector for each inter prediction mode. The motion prediction and compensation unit 134 supplies the prediction image that is generated as a result to the correction unit 135.

The correction unit 135 uses the parallax maximum value, the parallax minimum value and the inter-camera distance within the viewpoint generation information that is supplied from the viewpoint generation information generation unit 54 of FIG. 1 as the information relating to the parallax image, and generates a correction coefficient that is used when correcting the prediction image. The correction unit 135 corrects each inter prediction mode prediction image that is supplied from the motion prediction and compensation unit 134 using the correction coefficient.

Here, a position Z_{c} in the depth direction of the object of the encoding-target parallax image and a position Zₚ in the depth direction of the object of the prediction image are represented by the following Equations (5).

$$\begin{matrix}[ Formula . 3 ] & \\ {Z}_{c} = \frac{{L}_{c} f}{{d}_{c}} {Z}_{p} = \frac{{L}_{p} f}{{d}_{p}} & ( 5 )\end{matrix}$$

Furthermore, in Equations (5), L_{c} and Lₚ are the inter-camera distance of the encoding-target parallax image and the inter-camera distance of the prediction image, respectively. Whereas f is the focal length that is shared by the encoding-target parallax image and the prediction image. In addition, d_{c} and dₚ are the absolute value of the pre-normalization parallax value of the encoding-target parallax image and the absolute value of the pre-normalization parallax value of the prediction image, respectively.

In addition, a parallax value I_{c} of the encoding-target parallax image and the parallax value Iₚ of the prediction image are represented by the following Equations (6) using the absolute values d_{c} and dₚ of the pre-normalization parallax value.

$$\begin{matrix}[ Formula . 4 ] & \\ {I}_{c} = \frac{255 * ( {d}_{c} - {D}_{min}^{c} )}{{D}_{max}^{c} - {D}_{min}^{c}} {I}_{p} = \frac{255 * ( {d}_{p} - {D}_{min}^{p} )}{{D}_{max}^{p} - {D}_{min}^{p}} & ( 6 )\end{matrix}$$

Furthermore, in Equations (6), D^{c}ₘᵢₙ and D^{p}ₘᵢₙ are respectively the parallax minimum value of the encoding-target parallax image and the parallax minimum value of the prediction image. Whereas D^{c}ₘₐₓ and D^{p}ₘₐₓ are respectively the parallax maximum value of the encoding-target parallax image and the parallax maximum value of the prediction image.

Therefore, even if the position Z_{c} in the depth direction of the object of the encoding-target parallax image and the position Zₚ in the depth direction of the object of the prediction image are the same, when at least one of the inter-camera distances L_{c} and Lₚ, the parallax minimum values D^{c}ₘᵢₙ and D^{p}ₘᵢₙ and the parallax maximum values D^{c}ₘₐₓ and D^{p}ₘₐₓ is different, the parallax value I_{c} and the parallax value Iₚ are different.

Therefore, the correction unit 135 generates the correction coefficient that corrects the prediction image such that the parallax value I_{c} and the parallax value Iₚ are the same when the position Z_{c} and the position Zₚ are the same.

Specifically, when the position Z_{c} and the position Zₚ are the same, according to Equations (5) described above, the following Equation (7) is satisfied.

$$\begin{matrix}[ Formula . 5 ] & \\ \frac{{L}_{c} f}{{d}_{c}} = \frac{{L}_{p} f}{{d}_{p}} & ( 7 )\end{matrix}$$

In addition, Equation (7) may be modified to obtain the following Equation (8).

$$\begin{matrix}[ Formula . 6 ] & \\ {d}_{c} = \frac{{L}_{c}}{{L}_{p}} {d}_{p} & ( 8 )\end{matrix}$$

Furthermore, using Equations (6) described above, when the absolute values d_{c} and dₚ of the pre-normalization parallax value of Equation (8) are substituted for the parallax value I_{c} and the parallax value Iₚ, the following Equation (9) is obtained.

$$\begin{matrix}[ Formula . 7 ] & \\ \frac{{I}_{c} ( {D}_{max}^{c} - {D}_{min}^{c} )}{255} + {D}_{min}^{c} = \frac{{L}_{c}}{{L}_{p}} ( \frac{{I}_{p} ( {D}_{max}^{p} - {D}_{min}^{p} )}{255} + {D}_{min}^{p} ) & ( 9 )\end{matrix}$$

Accordingly, the parallax value I_{c} is represented by the following Equations (10) using the parallax value Iₚ.

$$\begin{matrix}[ Formula . 8 ] & \\ \begin{matrix}{I}_{c} = \frac{\frac{{L}_{c}}{{L}_{p}} ( {D}_{max}^{p} - {D}_{min}^{p} )}{{D}_{max}^{c} - {D}_{min}^{c}} {I}_{p} + 255 \frac{\frac{{L}_{c}}{{L}_{p}} {D}_{min}^{p} - {D}_{min}^{c}}{{D}_{max}^{c} - {D}_{min}^{c}} \\ = {aI}_{p} + b\end{matrix} & ( 10 )\end{matrix}$$

Therefore, the correction unit 135 generates a and b of Equation (10) as the correction coefficients. Furthermore, the correction unit 135 obtains the parallax value I_{c} in Equation (10) as the parallax value of the post-correction prediction image using the correction coefficients a and b and the parallax value Iₚ.

In addition, using the post-correction prediction image, the correction unit 135 calculates the cost function value in relation to each inter prediction mode, and determines the inter prediction mode in which the cost function value is smallest to be the optimal inter measurement mode. Furthermore, the correction unit 135 supplies the prediction image and the cost function value that are generated using the optimal inter prediction mode to the selection unit 136.

Furthermore, when the correction unit 135 receives notification of the selection of the prediction image that is generated using the optimal inter prediction mode from the selection unit 136, the correction unit 135 includes the motion information in the slice header that is supplied from the slice header encoding unit 63 as the information relating to the encoding. The motion information is configured of the optimal inter prediction mode, a prediction vector index, a motion vector residual, which is a delta obtained by subtracting the motion vector indicated by the prediction vector index from the present motion vector, and the like. Furthermore, the prediction vector index is information for specifying one motion vector of the motion vectors that are candidates used in the generation of the prediction image of the decoded parallax image.

The selection unit 136 determines one of an optimal intra prediction mode and an optimal inter prediction mode to be the optimal prediction mode based on the cost function values that are supplied from the screen intra prediction unit 133 and the correction unit 135. Furthermore, the selection unit 136 supplies the prediction image of the optimal prediction mode to the calculation unit 123 and the addition unit 130. In addition, the selection unit 136 notifies the screen intra prediction unit 133 or the correction unit 135 of the selection of the prediction image of the optimal prediction mode.

The rate control unit 137 controls the rate of the quantization operation of the quantization unit 125 such that an overflow or an underflow does not occur based on the encoded data that is accumulated in the accumulation buffer 127.

### [Configuration Example of Encoded Bitstream]

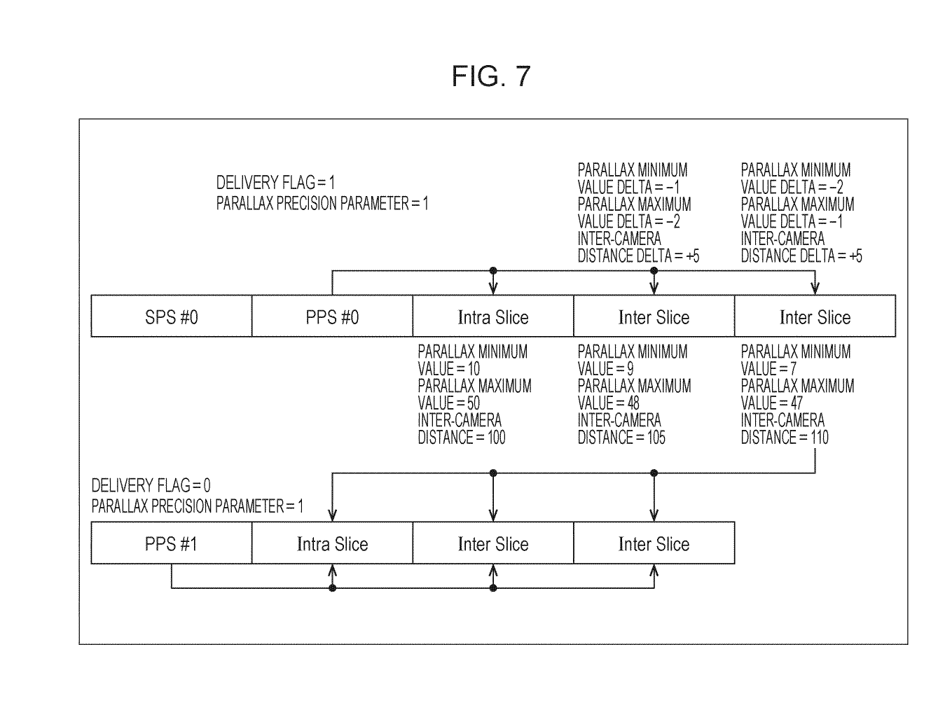

FIG. 7 is a diagram that shows a configuration example of an encoded bitstream.

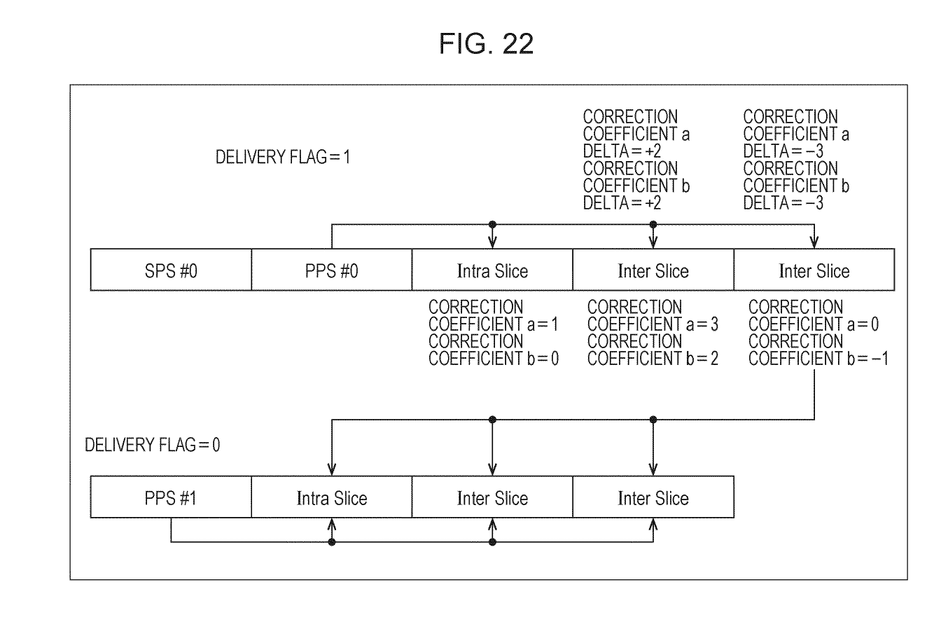

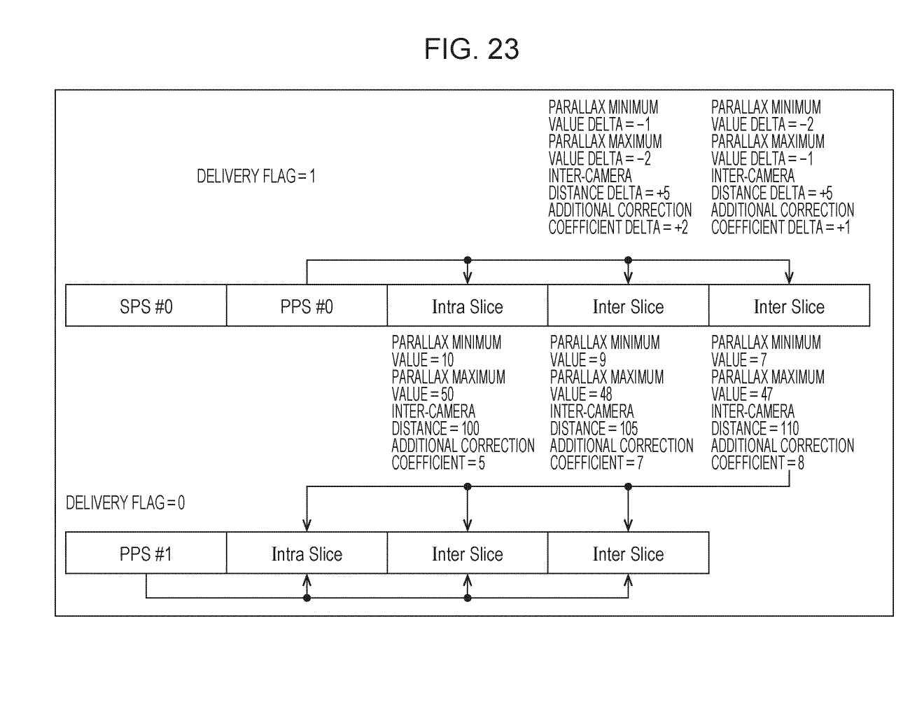

Furthermore, in FIG. 7, for convenience of description, only the encoded data of the slices of the multi-view parallax image is described; however, in reality, the encoded data of the slices of the multi-view color image is also disposed in the encoded bitstream. This also applied to FIGS. 22 and 23 described hereinafter.

In the example of FIG. 7, the parallax maximum values, the parallax minimum values and the inter-camera distances of the single intra-type slice and the two inter-type slices that configure the same PPS unit of PPS #0, which is the zero-th PPS, respectively do not match the parallax maximum value, the parallax minimum value and the inter-camera distance of the slice that is one prior in the encoding order. Therefore, the delivery flag “1” that indicates the presence of delivery is included in PPS #0. In addition, in the example of FIG. 7, the parallax precision of the slices that configure the same PPS unit of PPS #0 is 0.5, and a “1” that indicates that the parallax precision is 0.5 is included in PPS #0 as the parallax precision parameter.

Furthermore, in the example of FIG. 7, the parallax minimum value of the intra-type slice that configures the same PPS unit of PPS #0 is 10, the parallax maximum value is 50 and the inter-camera distance is 100. Therefore, the parallax minimum value “10”, the parallax maximum value “50” and the inter-camera distance “100” are included in the slice header of the slice.

In addition, in the example of FIG. 7, the parallax minimum value of the first inter-type slice that configures the same PPS unit of PPS #0 is 9, the parallax maximum value is 48 and the inter-camera distance is 105. Therefore, the parallax minimum value “10” of the intra-type slice that is one prior in the encoding order is subtracted from the parallax minimum value “9” of the slice. The delta “−1” is included in the slice header of the slice as the delta encoding result of the parallax minimum values. In the same manner, the delta “−2” of the parallax maximum values is included as the delta encoding result of the parallax maximum values, and the delta “5” of the inter-camera distances is included as the delta encoding result of the inter-camera distances.

Furthermore, in the example of FIG. 7, the parallax minimum value of the second inter-type slice that configures the same PPS unit of PPS #0 is 7, the parallax maximum value is 47 and the inter-camera distance is 110. Therefore, the parallax minimum value “9” of the first inter-type slice that is one prior in the encoding order is subtracted from the parallax minimum value “7” of the slice. The delta “−2” is included in the slice header of the slice as the delta encoding result of the parallax minimum values. In the same manner, the delta “−1” of the parallax maximum values is included as the delta encoding result of the parallax maximum values, and the delta “5” of the inter-camera distances is included as the delta encoding result of the inter-camera distances.

In addition, in the example of FIG. 7, the parallax maximum values, the parallax minimum values and the inter-camera distances of the single intra-type slice and the two inter-type slices that configure the same PPS unit of PPS #1, which is the first PPS, respectively match the parallax maximum value, the parallax minimum value and the inter-camera distance of the slice that is one prior in the encoding order. In other words, the parallax minimum values, the parallax maximum values and the inter-camera distances of the single intra-type slice and the two inter-type slices that configure the same PPS unit of PPS #1 are respectively the same “7”, “47” and “110” as the second inter-type slice that configures the same PPS unit of PPS #0. Therefore, the delivery flag “0” that indicates the absence of delivery is included in PPS #1. In addition, in the example of FIG. 7, the parallax precision of the slices that configure the same PPS unit of PPS #1 is 0.5, and a “1” that indicates that the parallax precision is 0.5 is included in PPS #1 as the parallax precision parameter.

### [PPS Syntax Example]

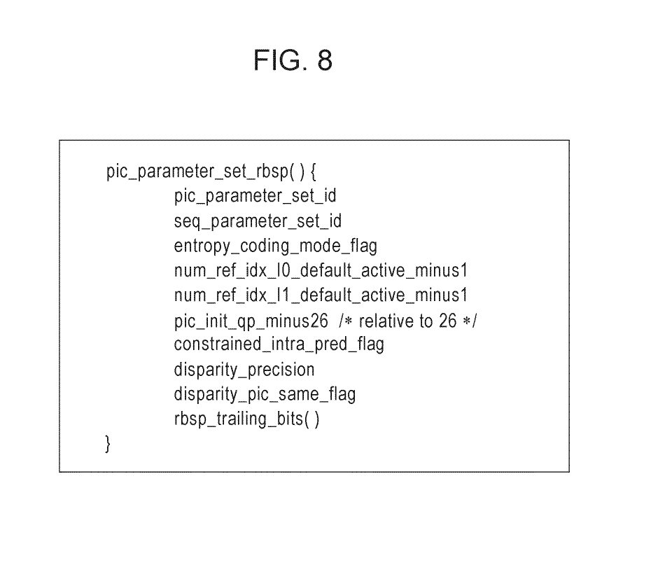

FIG. 8 is a diagram that shows an example of the syntax of the PPS of FIG. 7.

As shown in FIG. 8, the parallax precision parameter (disparity_precision) and the delivery flag (dsiparity_pic_same_flag) are included in the PPS. The parallax precision parameter is, for example, “0” when indicating a parallax precision of 1, and “2” when indicating a parallax precision of 0.25. In addition, as described above, the parallax precision parameter is “1” when indicating a parallax precision of 0.5. In addition, as described above, the delivery flag is “1” when indicating the presence of delivery, and “0” when indicating an absence of delivery.

### [Slice Header Syntax Example]

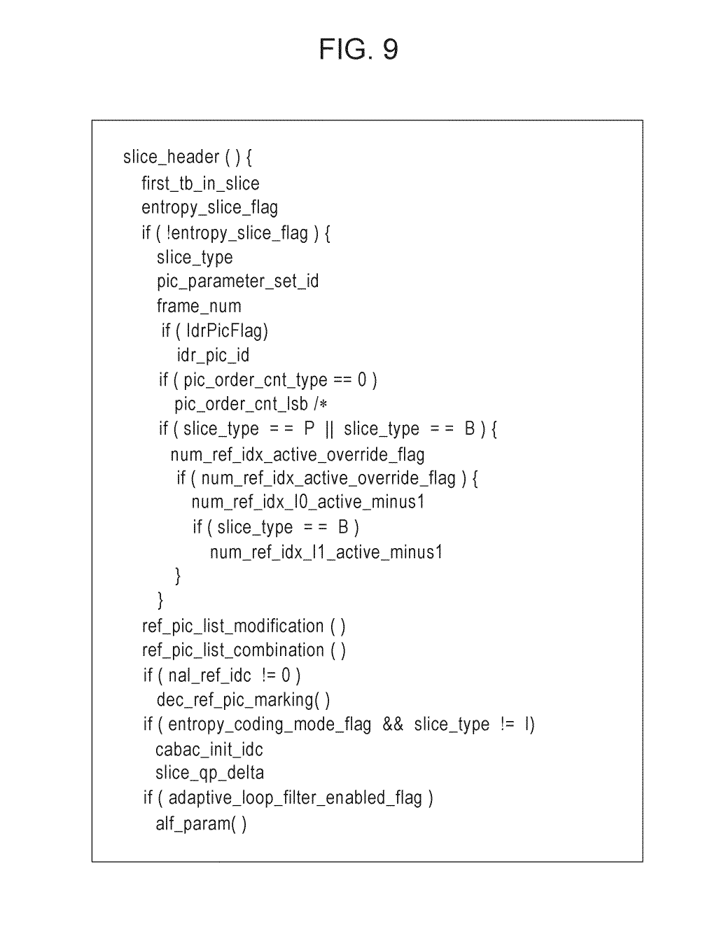

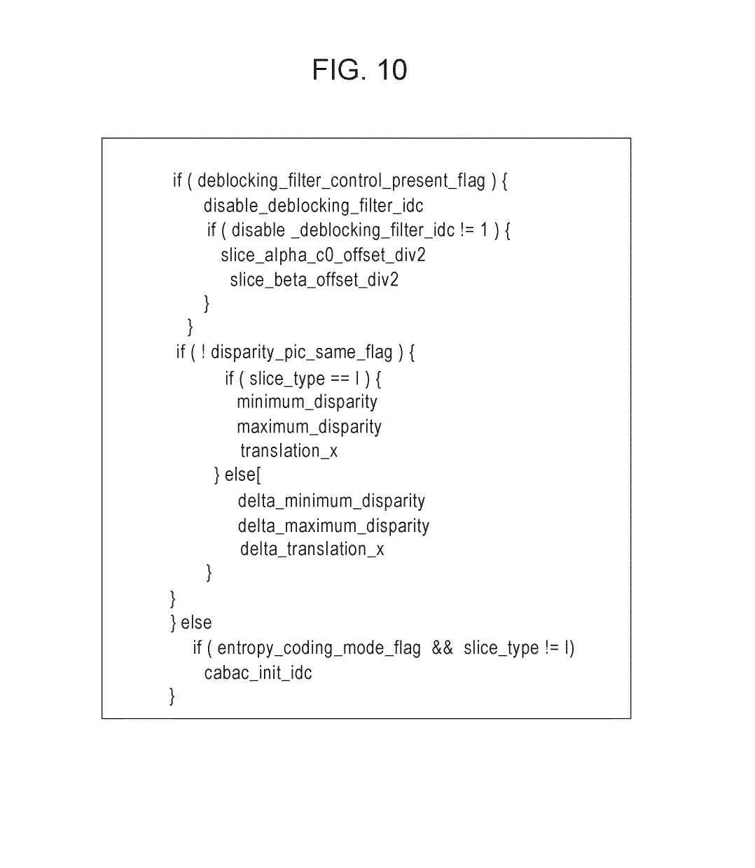

FIGS. 9 and 10 are diagrams that show an example of the syntax of the slice header.

As shown in FIG. 10, when the delivery flag is “1” and the slice type is the intra-type, the parallax minimum value (minimum_disparity), the parallax maximum value (maximum_disparity) and the inter-camera distance (translation_x) are included in the slice header.

On the other hand, when the delivery flag is 1 and the slice type is the inter-type, the delta encoding result of the parallax minimum values (delta_minimum_disparity), the delta encoding result of the parallax maximum values (delta_maximum_disparity) and the delta encoding result of the inter-camera distances (delta_translation_x) are included in the slice header.

### [Description of Processes of Encoding Device]

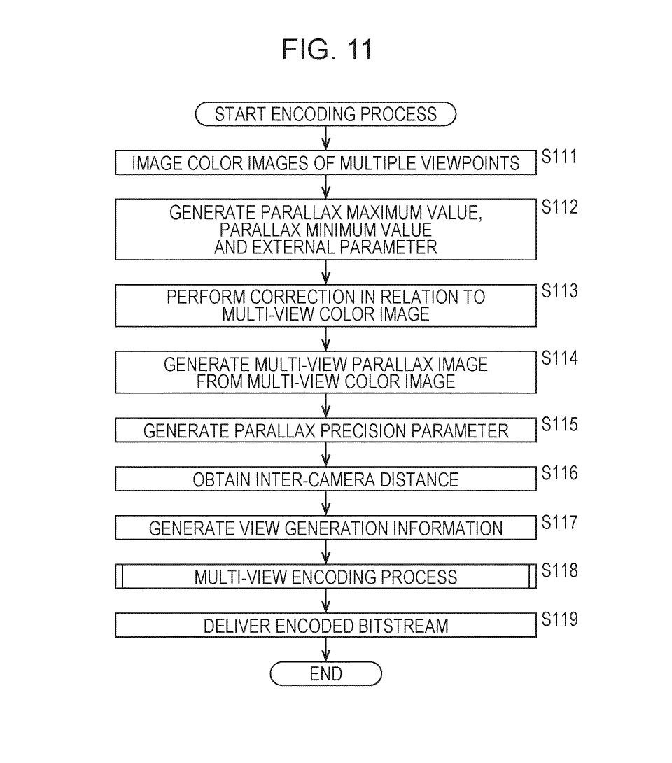

FIG. 11 is a flowchart that illustrates the encoding process of the encoding device 50 of FIG. 1.

Specifically, in step S111 of FIG. 11, the multi-view color image imaging unit 51 of the encoding device 50 images color images of multiple viewpoints and supplies the images to the multi-view color image correction unit 52 as a multi-view color image.

In step S112, the multi-view color image imaging unit 51 generates the parallax maximum value, the parallax minimum value and the external parameter. The multi-view color image imaging unit 51 supplies the parallax maximum value, the parallax minimum value and the external parameter to the viewpoint generation information generation unit 54, and supplies the parallax maximum value and the parallax minimum value to the multi-view parallax image generation unit 53.

In step S113, the multi-view color image correction unit 52 performs color correction, luminosity correction, distortion correction and the like in relation to the multi-view color image that is supplied from the multi-view color image imaging unit 51. Accordingly, the focal length in the horizontal direction (an X direction) of the multi-view color image imaging unit 51 in the post-correction multi-view color image is shared by all viewpoints. The multi-view color image correction unit 52 supplies the post-correction multi-view color image to the multi-view parallax image generation unit 53 and the multi-view image encoding unit 55 as a multi-view corrected color image.

In step S114, the multi-view parallax image generation unit 53 generates a multi-view parallax image from the multi-view corrected color image that is supplied from the multi-view color image correction unit 52 based on the parallax maximum value and the parallax minimum value that are supplied from the multi-view color image imaging unit 51. Furthermore, the multi-view parallax image generation unit 53 supplies the multi-view parallax image that is generated to the multi-view image encoding unit 55 as the multi-view parallax image.

In step S115, the multi-view parallax image generation unit 53 generates the parallax precision parameter, and supplies the parallax precision parameter to the viewpoint generation information generation unit 54.

In step S116, the viewpoint generation information generation unit 54 obtains the inter-camera distance based on the external parameter that is supplied from the multi-view color image imaging unit 51.

In step S117, the viewpoint generation information generation unit 54 generates the parallax maximum value, the parallax minimum value and the inter-camera distance from the multi-view color image imaging unit 51, and the parallax precision parameter from the multi-view parallax image generation unit 53 as the viewpoint generation information. The viewpoint generation information generation unit 54 supplies the viewpoint generation information that is generated to the multi-view image encoding unit 55.

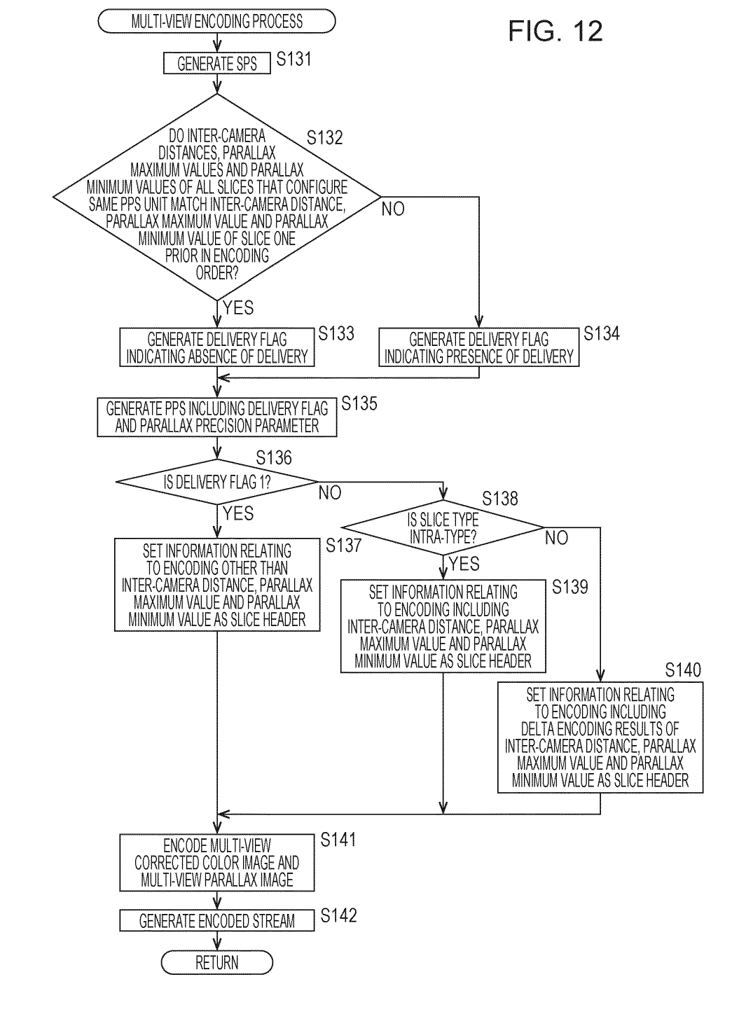

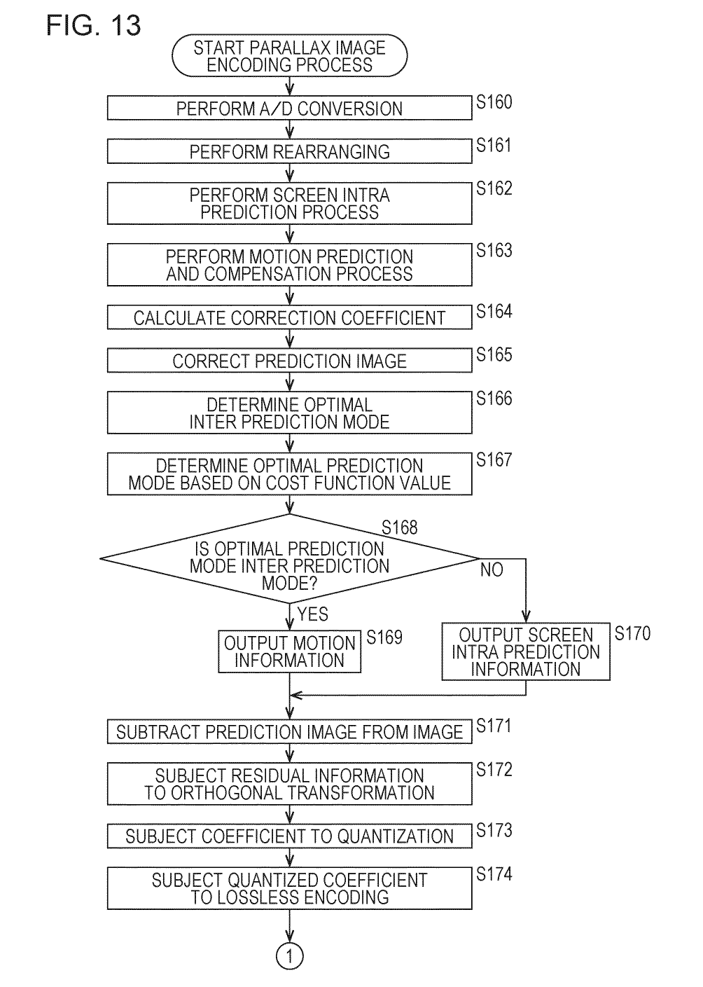

In step S118, the multi-view image encoding unit 55 performs a multi-view encoding process in which the multi-view corrected color image from the multi-view color image correction unit 52 and the multi-view parallax image from the multi-view parallax image generation unit 53 are encoded. Detailed description will be given of the multi-view encoding process with reference to FIG. 12 described hereinafter.

In step S119, the multi-view image encoding unit 55 delivers the encoded bitstream that is obtained as a result of the multi-view encoding process, and the process ends.

FIG. 12 is a flowchart that illustrates the multi-view encoding process of step S118 of FIG. 11.

In step S131 of FIG. 12, the SPS encoding unit 61 of the multi-view image encoding unit 55 generates an SPS in sequence units and supplies the SPS to the PPS encoding unit 62.

In step S132, of the viewpoint generation information that is supplied from the viewpoint generation information generation unit 54 of FIG. 1, the PPS encoding unit 62 determines whether or not the inter-camera distance, the parallax maximum value and the parallax minimum value of all the slices that configure the same PPS unit match the inter-camera distance, the parallax maximum value and the parallax minimum value of the slice that is one prior to the respective slice in the encoding order.

When it is determined that the inter-camera distances, the parallax maximum values and the parallax minimum values match in step S132, in step S133, the PPS encoding unit 62 generates a delivery flag that indicates the absence of delivery of the delta encoding results of the parallax maximum values, the parallax minimum values and the inter-camera distances. Subsequently, the process proceeds to step S135.

On the other hand, when it is determined that the inter-camera distances, the parallax maximum values and the parallax minimum values do not match in step S132, the process proceeds to step S134. In step S134, the PPS encoding unit 62 generates a delivery flag that indicates the presence of delivery of the delta encoding results of the parallax maximum values, the parallax minimum values and the inter-camera distances, and the process proceeds to step S135.

In step S135, the PPS encoding unit 62 generates a PPS that includes the delivery flag and the parallax precision parameter of the viewpoint generation information. The PPS encoding unit 62 adds the PPS to the SPS that is supplied from the SPS encoding unit 61 and supplies the SPS to the slice header encoding unit 63.

In step S136, the slice header encoding unit 63 determines whether or not the delivery flag included in the PPS that is supplied from the PPS encoding unit 62 is 1, which indicates the presence of delivery. When the delivery flag is determined to be 1 in step S136, the process proceeds to step S137.

In step S137, as the slice header of each slice that configures the same PPS unit, which is the processing target of step S132, the slice header encoding unit 63 generates information relating to encoding other than the inter-camera distance, the parallax maximum value and the parallax minimum value of the slice. The slice header encoding unit 63 further adds the slice header that is generated to the SPS, to which the PPS that is supplied from the PPS encoding unit 62 is added, and supplies the SPS to the slice encoding unit 64. The process proceeds to step S141.

On the other hand, in step S136, when the delivery flag is determined not to be 1, the process proceeds to step S138. Furthermore, the processes of steps S138 to S140 that are described hereinafter are performed for each slice that configures the same PPS unit, which is the processing target of step S132.

In step S138, the slice header encoding unit 63 determines whether or not the type of the slice that configures the same PPS unit, which is the processing target of step S133, is of an intra-type. In step S138, when the slice type is determined to be the intra-type, in step S139, the slice header encoding unit 63 generates the information relating to the encoding, including the inter-camera distance, the parallax maximum value and the parallax minimum value of the slice as the slice header of the slice. The slice header encoding unit 63 further adds the slice header that is generated to the SPS, to which the PPS that is supplied from the PPS encoding unit 62 is added, and supplies the SPS to the slice encoding unit 64. The process proceeds to step S141.

On the other hand, when the slice type is determined not to be the intra-type in step S138, that is, when the slice type is the inter-type, the process proceeds to step S140. In step S140, the slice header encoding unit 63 subjects the inter-camera distance, the parallax maximum value and the parallax minimum value of the slice to delta encoding, and generates the information relating to the encoding including the delta encoding results as the slice header of the slice. The slice header encoding unit 63 further adds the slice header that is generated to the SPS, to which the PPS that is supplied from the PPS encoding unit 62 is added, and supplies the SPS to the slice encoding unit 64. The process proceeds to step S141.

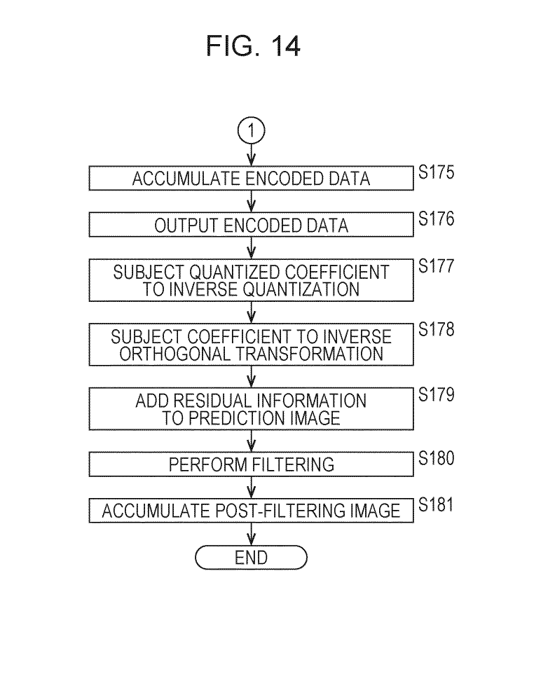

In step S141, the slice encoding unit 64 encodes the multi-view corrected color image from the multi-view color image correction unit 52 and the multi-view parallax image from the multi-view parallax image generation unit 53 in slice units. Specifically, the slice encoding unit 64 performs a color image encoding process in which the multi-view corrected color image is encoded, using the HEVC method, in slice units. In addition, of the viewpoint generation information that is supplied from the viewpoint generation information generation unit 54, the slice encoding unit 64 uses the parallax maximum value, the parallax minimum value and the inter-camera distance, and performs the parallax image encoding process in which to the multi-view parallax image is encoded, using a method that conforms to the HEVC method, in slice units. Detailed description will be given of the parallax image encoding process with reference to FIGS. 13 and 14 described hereinafter.

In step S142, the slice encoding unit 64 adds the encoding data of slice units that is obtained as a result of the encoding, including the information relating to the encoding of the screen intra prediction information or the motion information, to the slice header within the SPS, to which the PPS and the slice header that are supplied from the slice header encoding unit 63 are added, and generates the encoded stream. The slice encoding unit 64 delivers the encoded stream that is generated.

FIGS. 13 and 14 are a flowchart that illustrate the parallax image encoding process of the slice encoding unit 64 of FIG. 5 in detail. The parallax image encoding process is performed for each viewpoint.

In step S160 of FIG. 13, the A/D conversion unit 121 of the encoding unit 120 subjects the parallax image of frame units of a predetermined viewpoint that is input from the multi-view parallax image generation unit 53 to A/D conversion. The A/D conversion unit 121 outputs the parallax image to the screen rearrangement buffer 122 and causes the screen rearrangement buffer 122 to store the parallax image.

In step S161, the screen rearrangement buffer 122 rearranges the parallax images of the frames of the stored order of display into an order for encoding according to the GOP structure. The screen rearrangement buffer 122 supplies the post-rearrangement parallax images of frame units to the calculation unit 123, the screen intra prediction unit 133 and the motion prediction and compensation unit 134.

In step S162, the screen intra prediction unit 133 performs the screen intra prediction process of all intra prediction modes that are candidates using the reference image that is supplied from the addition unit 130. At this time, the screen intra prediction unit 133 calculates cost function values in relation to all the intra prediction modes that are candidates. Furthermore, the screen intra prediction unit 133 determines the intra prediction mode with the smallest cost function value to be an optimal intra prediction mode. The screen intra prediction unit 133 supplies the prediction image that is generated using the optimal intra prediction mode and the corresponding cost function value to the selection unit 136.

In step S163, the motion prediction and compensation unit 134 performs the motion prediction and compensation process based on the parallax images that are supplied from the screen rearrangement buffer 122 and the reference image that is supplied from the frame memory 132.

Specifically, the motion prediction and compensation unit 134 generates a motion vector by performing the motion prediction process of all the inter prediction modes that are candidates based on the parallax images that are supplied from the screen rearrangement buffer 122 and the reference image that is supplied from the frame memory 132. In addition, the motion prediction and compensation unit 134 performs the motion compensation process by reading out the reference image from the frame memory 132 based on the generated motion vector for each inter prediction mode. The motion prediction and compensation unit 134 supplies the prediction image that is generated as a result to the correction unit 135.

In step S164, the correction unit 135 calculates the correction coefficient based on the parallax maximum value, the parallax minimum value and the inter-camera distance within the viewpoint generation information that is supplied from the viewpoint generation information generation unit 54 of FIG. 1.

In step S165, the correction unit 135 corrects each inter prediction mode prediction image that is supplied from the motion prediction and compensation unit 134 using the correction coefficient.

In step S166, using the post-correction prediction image, the correction unit 135 calculates the cost function value in relation to each inter prediction mode, and determines the inter prediction mode in which the cost function value is smallest to be the optimal inter measurement mode. Furthermore, the correction unit 135 supplies the prediction image and the cost function value that are generated using the optimal inter prediction mode to the selection unit 136.

In step S167, the selection unit 136 determines, of an optimal intra prediction mode and an optimal inter prediction mode, the one in which the cost function value is lowest to be the optimal prediction mode based on the cost function values that are supplied from the screen intra prediction unit 133 and the correction unit 135. Furthermore, the selection unit 136 supplies the prediction image of the optimal prediction mode to the calculation unit 123 and the addition unit 130.

In step S168, the selection unit 136 determines whether or not the optimal prediction mode is the optimal inter prediction mode. When the optimal prediction mode is determined to be the optimal inter prediction mode in step S168, the selection unit 136 notifies the correction unit 135 of the selection of the prediction image that is generated using the optimal inter prediction mode.

Furthermore, in step S169, the correction unit 135 outputs the motion information and the process proceeds to step S171.

On the other hand, when the optimal prediction mode is determined not to be the optimal inter prediction mode in step S168, that is, when the optimal prediction mode is the optimal intra prediction mode, the selection unit 136 notifies the screen intra prediction unit 133 of the selection of the prediction image that is generated using the optimal intra prediction mode.

Furthermore, in step S170, the screen intra prediction unit 133 outputs the screen intra prediction information and the process proceeds to step S171.

In step S171, the calculation unit 123 subtracts the prediction images that are supplied from the selection unit 136 from the parallax images that are supplied from the screen rearrangement buffer 122. The calculation unit 123 outputs the images that are obtained as a result of the subtraction to the orthogonal transformation unit 124 as residual information.

In step S172, the orthogonal transformation unit 124 subjects the residual information from the calculation unit 123 to an orthogonal transformation, and supplies the coefficient that is obtained as a result to the quantization unit 125.

In step S173, the quantization unit 125 quantizes the coefficient that is supplied from the orthogonal transformation unit 124. The quantized coefficient is input to the lossless encoding unit 126 and the inverse quantization unit 128.

In step S174, the lossless encoding unit 126 subjects the quantized coefficient that is supplied from the quantization unit 125 to lossless encoding.

In step S175 of FIG. 14, the lossless encoding unit 126 supplies the encoded data that is obtained as a result of the lossless encoding process to the accumulation buffer 127 and causes the accumulation buffer 127 to accumulate the encoded data.

In step S176, the accumulation buffer 127 outputs the encoded data that is accumulated.

In step S177, the inverse quantization unit 128 subjects the quantized coefficient that is supplied from the quantization unit 125 to inverse quantization.

In step S178, the inverse orthogonal transformation unit 129 subjects the coefficient that is supplied from the inverse quantization unit 128 to inverse orthogonal transformation, and supplies the residual information that is obtained as a result to the addition unit 130.

In step S179, the addition unit 130 adds the residual information that is supplied from the inverse orthogonal transformation unit 129 to the prediction image that is supplied from the selection unit 136 and obtains a parallax image that is locally decoded. The addition unit 130 supplies the parallax image that is obtained to the deblocking filter 131 and also supplies the parallax image to the screen intra prediction unit 133 as a reference image.

In step S180, the deblocking filter 131 removes block distortion by performing filtering on the parallax image, which is supplied from the addition unit 130 and is locally decoded.

In step S181, the deblocking filter 131 supplies the post-filtering parallax image to the frame memory 132 and causes the frame memory 132 to accumulate the parallax image. The parallax image that is accumulated in the frame memory 132 is output to the motion prediction and compensation unit 134 as a reference image. Subsequently, the process ends.

Furthermore, the processes of steps S162 to S181 of FIGS. 13 and 14 are performed in coding units, for example. In addition, in the parallax image encoding process of FIGS. 13 and 14, in order to facilitate description, the screen intra prediction process and the motion compensation process were always performed; however, there is also a case in which only one is performed, depending on the picture type or the like.

As described above, the encoding device 50 corrects the prediction image using the information relating to the parallax image and encodes the parallax image using the post-correction prediction image. More specifically, using the inter-camera distance, the parallax maximum value and the parallax minimum value as the information relating to the parallax image, the encoding device 50 corrects the prediction image so that the parallax values are the same when the positions of the object in the depth direction between the prediction image and the parallax image are the same, and encodes the parallax image using the post-correction prediction image. Therefore, the delta that occurs between the prediction image and the parallax image due to the information relating to the parallax image is reduced and the encoding efficiency is improved. In particular, when the information relating to the parallax image changes for each picture, the encoding efficiency is improved.

In addition, the encoding device 50 delivers, not the correction coefficient itself, but the inter-camera distance, the parallax maximum value and the parallax minimum value that are used in the calculation of the correction coefficient as the information used in the correction of the prediction image. Here, the inter-camera distance, the parallax maximum value and the parallax minimum value are a portion of the viewpoint generation information. Therefore, it is possible to share the inter-camera distance, the parallax maximum value and the parallax minimum value as the information that is used in the correction of the prediction image and a portion of the viewpoint generation information. As a result, it is possible to reduce the information amount of the encoded bitstream.

### [Configuration Example of One Embodiment of Decoding Device]

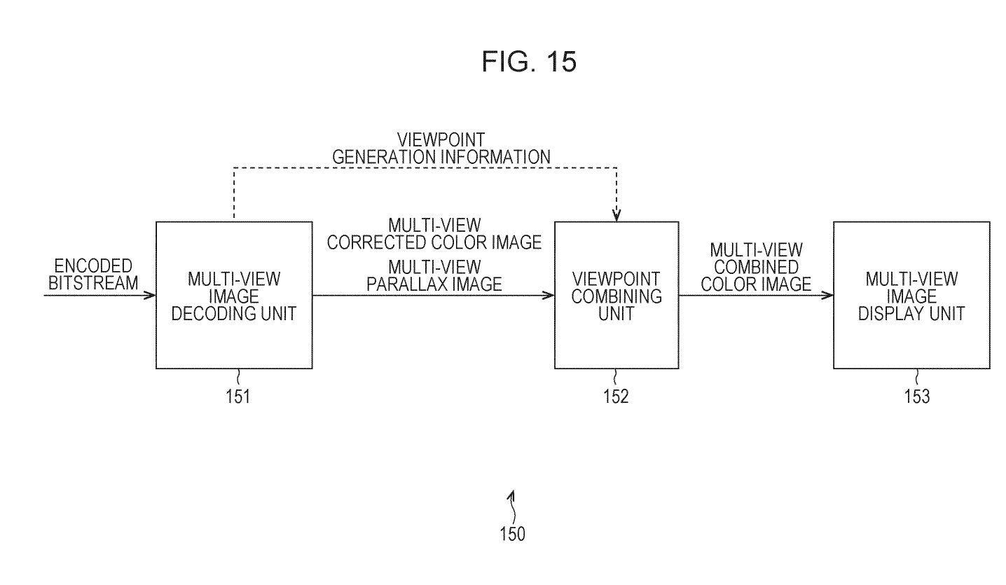

FIG. 15 is a block diagram that shows a configuration example of one embodiment of a decoding device to which the present technology is applied, in which the encoded bitstream that is delivered from the encoding device 50 of FIG. 1 is decoded.

The decoding device 150 of FIG. 15 is configured of a multi-view image decoding unit 151, a viewpoint combining unit 152 and a multi-view image display unit 153. The decoding device 150 decodes the encoded bitstream that is delivered from the encoding device 50 and generates and displays a color image of the display viewpoint using the multi-view color image, the multi-view parallax image and the viewpoint generation information that are obtained as a result.

Specifically, the multi-view image decoding unit 151 of the decoding device 150 receives the encoded bitstream that is delivered from the encoding device 50 of FIG. 1. The multi-view image decoding unit 151 extracts the parallax precision parameter and the delivery flag from the PPS that is included in the encoded bitstream which is received. In addition, the multi-view image decoding unit 151 extracts the inter-camera distance, the parallax maximum value and the parallax minimum value from the slice header of the encoded bitstream according to the delivery flag. The multi-view image decoding unit 151 generates the viewpoint generation information that is formed of the parallax precision parameter, the inter-camera distance, the parallax maximum value and the parallax minimum value, and supplies the viewpoint generation information to the viewpoint combining unit 152.

In addition, the multi-view image decoding unit 151 decodes the encoded data of the multi-view corrected color image of slice units that is included in the encoded bitstream using a method that corresponds to the encoding method of the multi-view image encoding unit 55 of FIG. 1, and generates the multi-view corrected color image. In addition, the multi-view image decoding unit 151 functions as the decoding unit. Using the inter-camera distance, the parallax maximum value and the parallax minimum value, the multi-view image decoding unit 151 decodes the encoded data of the multi-view parallax image that is included in the encoded bitstream using a method that corresponds to the encoding method of the multi-view image encoding unit 55, and generates the multi-view parallax image. The multi-view image decoding unit 151 supplies the multi-view corrected color image and the multi-view parallax image that are generated to the viewpoint combining unit 152.

The viewpoint combining unit 152 performs a warping process to the display viewpoint of a number of viewpoints corresponding to the multi-view image display unit 153 in relation to the multi-view parallax image from the multi-view image decoding unit 151 using the viewpoint generation information from the multi-view image decoding unit 151. Specifically, the viewpoint combining unit 152 performs the warping process to the display viewpoint in relation to the multi-view parallax image with a precision corresponding to the parallax precision parameter based on the inter-camera distance, the parallax maximum value and the parallax minimum value that are included in the viewpoint generation information. Furthermore, the warping process is a process of geometrically transforming from an image of a viewpoint to an image of another viewpoint. In addition, a viewpoint other than the viewpoint that corresponds to the multi-view color image is included in the display viewpoint.

In addition, the viewpoint combining unit 152 performs the warping process to the display viewpoint in relation to the multi-view corrected color image that is supplied from the multi-view image decoding unit 151 using the parallax image of the display viewpoint that is obtained as a result of the warping process. The viewpoint combining unit 152 supplies the color image of the display viewpoint that is obtained as a result to the multi-view image display unit 153 as a multi-view combined color image.

The multi-view image display unit 153 displays the multi-view combined color image that is supplied from the viewpoint combining unit 152 such that the visible angle is different for each viewpoint. The viewer can view a 3D image from a plurality of viewpoints without wearing eyeglasses by viewing each image of two arbitrary viewpoints with each eye of left and right.

As described above, the viewpoint combining unit 152 performs the warping process to the display viewpoint in relation to the multi-view parallax image with a precision that corresponds to the viewpoint precision parameter based on the parallax precision parameter; thus, it is not necessary for the viewpoint combining unit 152 to perform the warping process at a wastefully high precision.

In addition, since the viewpoint combining unit 152 performs the warping process to the display viewpoint in relation to the multi-view parallax image based on the inter-camera distance, when the parallax that corresponds to the parallax value of the post-warping process multi-view parallax image does not fall within an appropriate range, it is possible to alter the parallax value to be a value corresponding to parallax of an appropriate range, based on the inter-camera distance.

### [Configuration Example of Multi-View Image Decoding Unit]

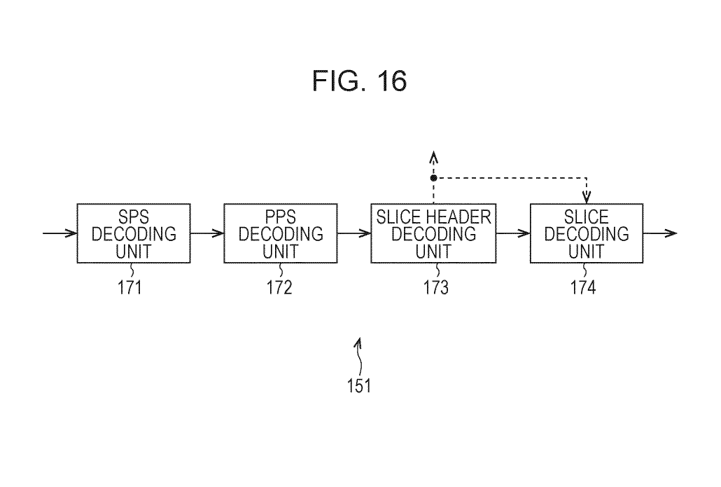

FIG. 16 is a block diagram that shows a configuration example of the multi-view image decoding unit 151 of FIG. 15.

The multi-view image decoding unit 151 of FIG. 16 is configured of an SPS decoding unit 171, a PPS decoding unit 172, a slice header decoding unit 173 and a slice decoding unit 174.

The SPS decoding unit 171 of the multi-view image decoding unit 151 functions as a reception unit, receives the encoded bitstream that is delivered from the encoding device 50 of FIG. 1, and extracts the SPS from the encoded bitstream. The SPS decoding unit 171 supplies the extracted SPS and the encoded bitstream other than the SPS to the PPS decoding unit 172.

The PPS decoding unit 172 extracts the PPS from the encoded bitstream other than the SPS that is supplied from the SPS decoding unit 171. The PPS decoding unit 172 supplies the extracted PPS, the SPS and the encoded bitstream other than the SPS and the PPS to the slice header decoding unit 173.

The slice header decoding unit 173 extracts the slice header from the encoded bitstream other than the SPS and the PPS that are supplied from the PPS decoding unit 172. When the delivery flag that is included in the PPS from the PPS decoding unit 172 is “1”, indicating the presence of delivery, the slice header decoding unit 173 holds the inter-camera distance, the parallax maximum value and the parallax minimum value that are included in the slice header, or, updates the inter-camera distance, the parallax maximum value and the parallax minimum value that are held based on the delta encoding results of the inter-camera distances, the parallax maximum values and the parallax minimum values. The slice header decoding unit 173 generates the viewpoint generation information from the inter-camera distance, the parallax maximum value and the parallax minimum value that are held and the parallax precision parameter that is included in the PPS, and supplies the viewpoint generation information to the viewpoint combining unit 152.

Furthermore, the slice header decoding unit 173 supplies other than the information relating to the inter-camera distance, the parallax maximum value and the parallax minimum value of the slice header of the SPS, the PPS and the slice header, and, encoded data of slice units that are the encoded bitstream other than the SPS, the PPS and the slice header to the slice decoding unit 174. In addition, the slice header decoding unit 173 supplies the inter-camera distance, the parallax maximum value and the parallax minimum value to the slice decoding unit 174.

The slice decoding unit 174 decodes the encoded data of a multiplexed color image of slice units using a method that corresponds to the encoding method in the slice encoding unit 64 (FIG. 5) based on other than the information relating to the inter-camera distance, the parallax maximum value and the parallax minimum value of the SPS, the PPS and the slice header that are supplied from the slice header decoding unit 173. In addition, the slice decoding unit 174 decodes the encoded data of a multiplexed parallax image of slice units using a method that corresponds to the encoding method in the slice encoding unit 64 based on other than the information relating to the inter-camera distance, the parallax maximum value and the parallax minimum value of the SPS, the PPS and the slice header, and based on the inter-camera distance, the parallax maximum value and the parallax minimum value. The slice header decoding unit 173 supplies the multi-view corrected color image and the multi-view parallax image that are obtained as a result of the decoding to the viewpoint combining unit 152 of FIG. 15.

### [Configuration Example of Slice Decoding Unit]

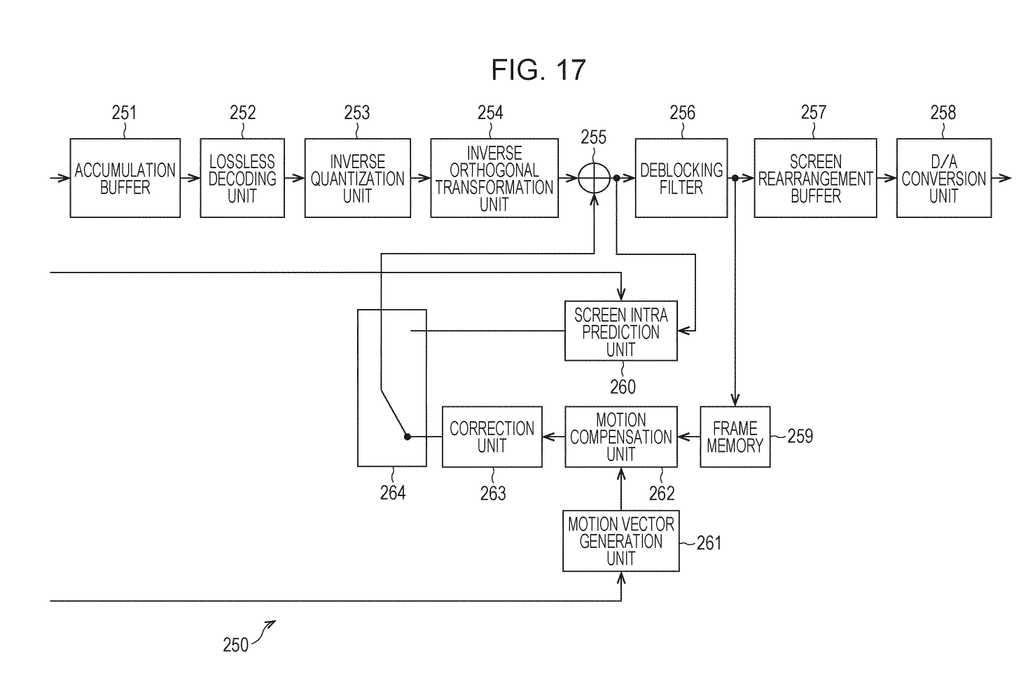

FIG. 17 is a block diagram that shows a configuration example of the decoding unit that decodes the parallax image of one arbitrary viewpoint within the slice decoding unit 174 of FIG. 16. In other words, the decoding unit that decodes the multi-view parallax image within the slice decoding unit 174 is configured of a number of decoding units 250 of FIG. 17 corresponding to the number of viewpoints.

The decoding unit 250 of FIG. 17 is configured of an accumulation buffer 251, a lossless decoding unit 252, an inverse quantization unit 253, an inverse orthogonal transformation unit 254, an addition unit 255, a deblocking filter 256, a screen rearrangement buffer 257, a D/A conversion unit 258, frame memory 259, a screen intra prediction unit 260, a motion vector generation unit 261, a motion compensation unit 262, a correction unit 263 and a switch 264.

The accumulation buffer 251 of the decoding unit 250 receives the encoded data of the parallax image of a predetermined viewpoint of slice units from the slice header decoding unit 173 of FIG. 16 and accumulates the encoded data. The accumulation buffer 251 supplies the encoded data that is accumulated to the lossless decoding unit 252.

The lossless decoding unit 252 obtains the quantized coefficient by subjecting the encoded data from the accumulation buffer 251 to lossless decoding such as variable length decoding or arithmetic decoding. The lossless decoding unit 252 supplies the quantized coefficient to the inverse quantization unit 253.

The inverse quantization unit 253, the inverse orthogonal transformation unit 254, the addition unit 255, the deblocking filter 256, the frame memory 259, the screen intra prediction unit 260, the motion compensation unit 262 and the correction unit 263 respectively perform processes similar to those of the inverse quantization unit 128, the inverse orthogonal transformation unit 129, the addition unit 130, the deblocking filter 131, the frame memory 132, the screen intra prediction unit 133, the motion prediction and compensation unit 134 and the correction unit 135 of FIG. 6. Accordingly, the parallax image of a predetermined viewpoint is decoded.

Specifically, the inverse quantization unit 253 subjects the quantized coefficient from the lossless decoding unit 252 to inverse quantization, and supplies the coefficient that is obtained as a result to the inverse orthogonal transformation unit 254.

The inverse orthogonal transformation unit 254 subjects the coefficient from the inverse quantization unit 253 to an inverse orthogonal transformation such as the inverse Discrete Cosine Transform or the inverse Karhunen-Loeve Transform, and supplies the residual information that is obtained as a result to the addition unit 255.

The addition unit 255 functions as the decoding unit and decodes the decoding-target parallax image by adding the residual information, which is the decoding-target parallax image that is supplied from the inverse orthogonal transformation unit 254, to the prediction image that is supplied from the switch 264. The addition unit 255 supplies the parallax image that is obtained as a result to the deblocking filter 256 and also supplies the parallax image to the screen intra prediction unit 260 as a reference image. Furthermore, when the prediction image is not supplied from the switch 264, the addition unit 255 supplies the parallax image, which is the residual information that is supplied from the inverse orthogonal transformation unit 254, to the deblocking filter 256 and also supplies the parallax image to the screen intra prediction unit 260 as a reference image.

The deblocking filter 256 removes block distortion by filtering the parallax image that is supplied from the addition unit 255. The deblocking filter 256 supplies the parallax image that is obtained as a result to the frame memory 259, causes the frame memory 259 to accumulate the parallax image and supplies the parallax image to the screen rearrangement buffer 257. The parallax image that is accumulated in the frame memory 259 is supplied to the motion compensation unit 262 as a reference image.

The screen rearrangement buffer 257 stores the parallax image, which is supplied from the deblocking filter 256, in frame units. The screen rearrangement buffer 257 rearranges the parallax image of frame units in stored order for encoding into the original order of display, and supplies the parallax image to the D/A conversion unit 258.

The D/A conversion unit 258 subjects the parallax image of frame units that is supplied from the screen rearrangement buffer 257 to D/A conversion, and supplies the parallax image to the viewpoint combining unit 152 (FIG. 15) as the parallax image of a predetermined viewpoint.

The screen intra prediction unit 260 performs screen intra prediction of the optimal intra prediction mode that is indicated by the screen intra prediction information, which is supplied from the slice header decoding unit 173 (FIG. 16) using the reference image that is supplied from the addition unit 255, and generates the prediction image. Furthermore, the screen intra prediction unit 260 supplies the prediction image to the switch 264.

Of the motion vectors that are held, the motion vector generation unit 261 adds the motion vector and the motion vector residual, which are indicated by the prediction vector index included in the motion information that is supplied from the slice header decoding unit 173, to one another and restores the motion vector. The motion vector generation unit 261 holds the restored motion vector. In addition, the motion vector generation unit 261 supplies the restored motion vector, the optimal inter prediction mode that is included in the motion information and the like to the motion compensation unit 262.

The motion compensation unit 262 functions as a prediction image generation unit and performs the motion compensation process by reading out the reference image from the frame memory 259 based on the motion vector and the optimal inter prediction mode that are supplied from the motion vector generation unit 261. The motion compensation unit 262 supplies the prediction image that is generated as a result to the correction unit 263.

In the same manner as the correction unit 135 of FIG. 6, the correction unit 263 generates the correction coefficient that is used when correcting the prediction image based on the parallax maximum value, the parallax minimum value and the inter-camera distance that are supplied from the slice header decoding unit 173 of the FIG. 16. In addition, in the same manner to the correction unit 135, the correction unit 263 corrects the prediction image of the optimal inter prediction mode that is supplied from the motion compensation unit 262 using the correction coefficient. The correction unit 263 supplies the post-correction prediction image to the switch 264.

When the prediction image is supplied from the screen intra prediction unit 260, the switch 264 supplies the prediction image to the addition unit 255, and when the prediction image is supplied from the motion compensation unit 262, the switch 264 supplies the prediction image to the addition unit 255.

### [Description of Processes of Decoding Device]

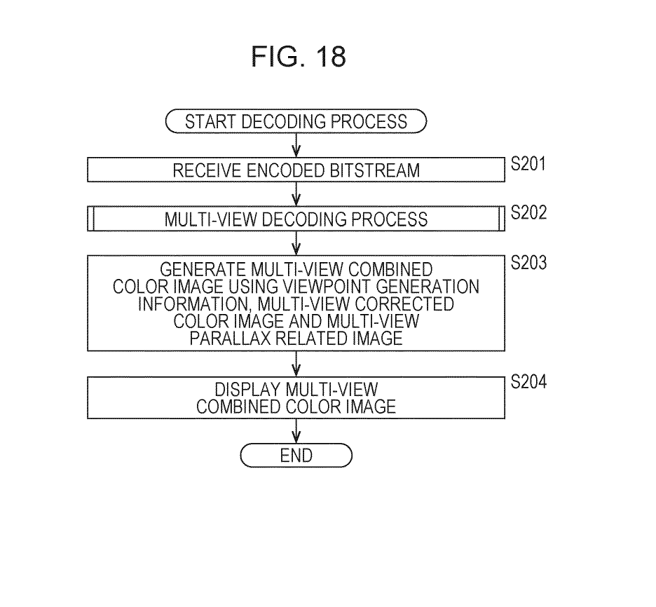

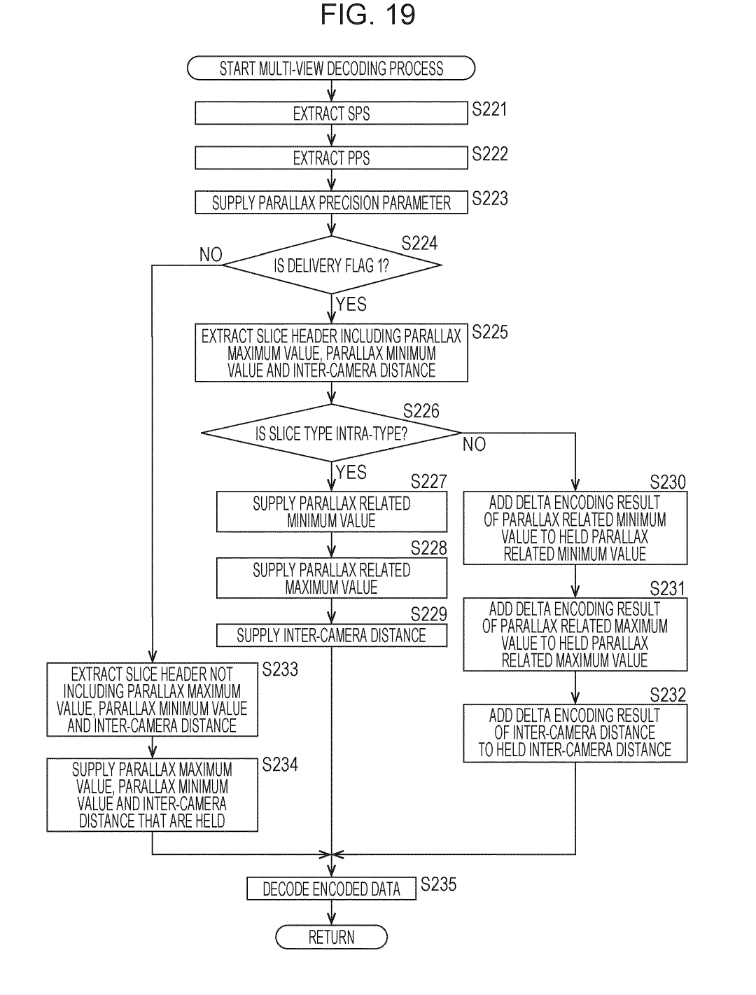

FIG. 18 is a flowchart that illustrates a decoding process of the decoding device 150 of FIG. 15. When the encoded bitstream is delivered from the encoding device 50 of FIG. 1, for example, the decoding process is started.

In step S201 of FIG. 18, the multi-view image decoding unit 151 of the decoding device 150 receives the encoded bitstream that is delivered from the encoding device 50 of FIG. 1.

In step S202, the multi-view image decoding unit 151 performs the multi-view image decoding process in which the encoded bitstream that is received is decoded. Detailed description will be given of the multi-view decoding process with reference to FIG. 19 described hereinafter.

In step S203, the viewpoint combining unit 152 functions as a color image generation unit and generates the multi-view combined color image using the viewpoint generation information, the multi-view corrected color image and the multi-view parallax image that are supplied from the multi-view image decoding unit 151.

In step S204, the multi-view image display unit 153 displays the multi-view combined color image that is supplied from the viewpoint combining unit 152 such that the visible angle is different for each viewpoint, and the process ends.

FIG. 19 is a flowchart that illustrates the multi-view decoding process of step S202 of FIG. 18 in detail.

In step S221 of FIG. 19, the SPS decoding unit 171 (FIG. 16) of the multi-view image decoding unit 151 extracts the SPS within the encoded bitstream that is received. The SPS decoding unit 171 supplies the extracted SPS and the encoded bitstream other than the SPS to the PPS decoding unit 172.

In step S222, the PPS decoding unit 172 extracts the PPS from the encoded bitstream other than the SPS that is supplied from the SPS decoding unit 171. The PPS decoding unit 172 supplies the extracted PPS, the SPS and the encoded bitstream other than the SPS and the PPS to the slice header decoding unit 173.

In step S223, the slice header decoding unit 173 supplies the parallax precision parameter that is included in the PPS that is supplied from the PPS decoding unit 172 to the viewpoint combining unit 152 as a portion of the viewpoint generation information.

In step S224, the slice header decoding unit 173 determines whether or not the delivery flag that is included in the PPS from the PPS decoding unit 172 is “1”, which indicates the presence of delivery. Furthermore, the processes of the following steps S225 to S234 are performed in slice units.

When the delivery flag is determined to be 1, which indicates the presence of delivery, in step S224, the process proceeds to step S225. In step S225, the slice header decoding unit 173 extracts the slice header that includes the parallax maximum value, the parallax minimum value and the inter-camera distance or the delta encoding result of the parallax maximum values, the parallax minimum values and the inter-camera distances from the encoded bitstream other than the SPS and the PPS that is supplied from the PPS decoding unit 172.

In step S226, the slice header decoding unit 173 determines whether or not the slice type is the intra-type. When the slice type is determined to be the intra-type in step S226, the process proceeds to step S227.

In step S227, the slice header decoding unit 173 holds the parallax minimum value that is included in the slice header that is extracted in step S225, and supplies the parallax minimum value to the viewpoint combining unit 152 as a portion of the viewpoint generation information.

In step S228, the slice header decoding unit 173 holds the parallax maximum value that is included in the slice header that is extracted in step S225, and supplies the parallax maximum value to the viewpoint combining unit 152 as a portion of the viewpoint generation information.

In step S229, the slice header decoding unit 173 holds the inter-camera distance that is included in the slice header that is extracted in step S225, and supplies the inter-camera distance to the viewpoint combining unit 152 as a portion of the viewpoint generation information. Subsequently, the process proceeds to step S235.

On the other hand, when the slice type is determined not to be the intra-type in step S226, that is, when the slice type is the inter-type, the process proceeds to step S230.

In step S230, the slice header decoding unit 173 adds the delta encoding result of the parallax minimum values included in the slice header that is extracted in step S225 to the parallax minimum value that is held. The slice header decoding unit 173 supplies the parallax minimum value that is restored by the addition to the viewpoint combining unit 152 as a portion of the viewpoint generation information.

In step S231, the slice header decoding unit 173 adds the delta encoding result of the parallax maximum values included in the slice header that is extracted in step S225 to the parallax maximum value that is held. The slice header decoding unit 173 supplies the parallax maximum value that is restored by the addition to the viewpoint combining unit 152 as a portion of the viewpoint generation information.

In step S232, the slice header decoding unit 173 adds the delta encoding result of the inter-camera distances included in the slice header that is extracted in step S225 to the inter-camera distance that is held. The slice header decoding unit 173 supplies the inter-camera distance that is restored by the addition to the viewpoint combining unit 152 as a portion of the viewpoint generation information. Subsequently, the process proceeds to step S235.

On the other hand, in step S224, when the delivery flag is determined not to be 1, which indicates the presence of delivery, that is, when the delivery flag is “0”, which indicates the absence of delivery, the process proceeds to step S233.

In step S233, the slice header decoding unit 173 extracts the slice header that does not include the parallax maximum value, the parallax minimum value and the inter-camera distance or the delta encoding result of the parallax maximum values, the parallax minimum values and the inter-camera distances from the encoded bitstream other than the SPS and the PPS that is supplied from the PPS decoding unit 172.

In step S234, by setting the parallax maximum value, the parallax minimum value and the inter-camera distance that are held, that is, the parallax maximum value, the parallax minimum value and the inter-camera distance of the slice one prior in the encoding order to the parallax maximum value, the parallax minimum value and the inter-camera distance of the processing-target slice, the slice header decoding unit 173 restores the parallax maximum value, the parallax minimum value and the inter-camera distance of the processing-target slice. Furthermore, the slice header decoding unit 173 supplies the parallax maximum value, the parallax minimum value and the inter-camera distance that are restored to the viewpoint combining unit 152 as a portion of the viewpoint generation information, and the process proceeds to step S235.

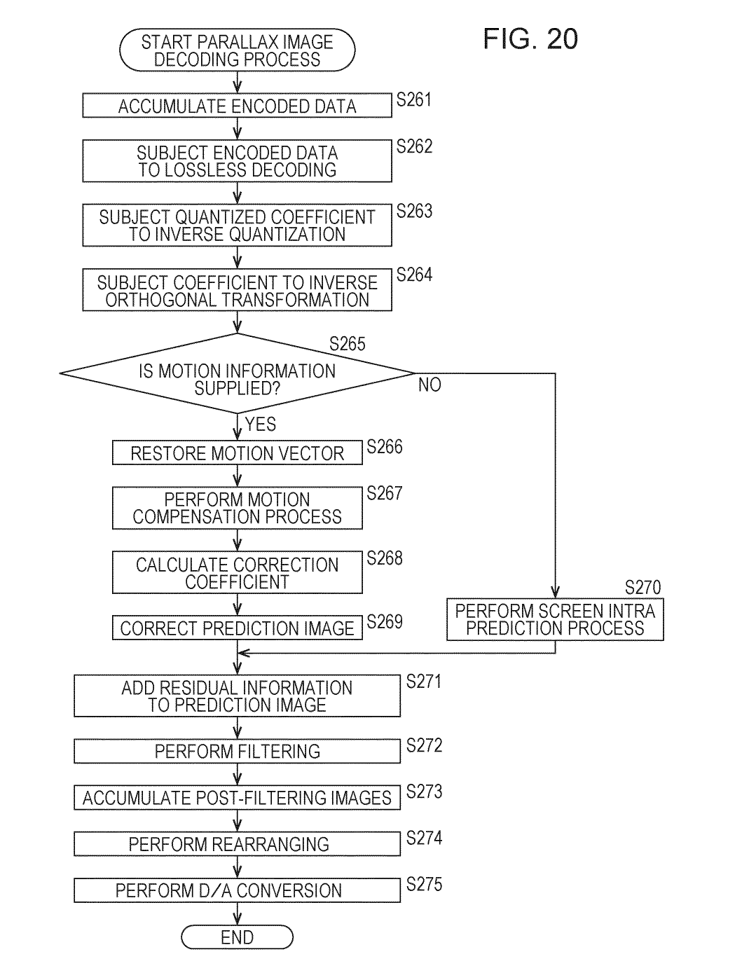

In step S235, the slice decoding unit 174 decodes the encoded data of slice units using a method that corresponds to the encoding method in the slice encoding unit 64 (FIG. 5). Specifically, the slice decoding unit 174 decodes the encoded data of a multi-view color image of slice units using a method that corresponds to the encoding method in the slice encoding unit 64 based on the SPS, the PPS and the slice header other than the information relating to the inter-camera distance, the parallax maximum value and the parallax minimum value that are from the slice header decoding unit 173. In addition, the slice decoding unit 174 performs the parallax image decoding process that decodes the encoded data of a multi-view corrected image of slice units using a method that corresponds to the encoding method in the slice encoding unit 64 based on the slice header other than the information relating to the SPS, the PPS, the inter-camera distance, the parallax maximum value and the parallax minimum value, and, the inter-camera distance, the parallax maximum value and the parallax minimum value that are from the slice header decoding unit 173. Detailed description will be given of the parallax image decoding process with reference to FIG. 20 described hereinafter. The slice header decoding unit 173 supplies the multi-view corrected color image and the multi-view parallax image that are obtained as a result of the decoding to the viewpoint combining unit 152 of FIG. 15.

FIG. 20 is a flowchart that illustrates the parallax image decoding process of the slice decoding unit 174 of FIG. 16 in detail. The parallax image decoding process is performed for each viewpoint.

In step S261 of FIG. 20, the accumulation buffer 251 of the decoding unit 250 receives the encoded data of slice units of the parallax image of a predetermined viewpoint from the slice header decoding unit 173 of FIG. 16 and accumulates the encoded data. The accumulation buffer 251 supplies the encoded data that is accumulated to the lossless decoding unit 252.

In step S262, the lossless decoding unit 252 subjects the encoded data that is supplied from the accumulation buffer 251 to lossless decoding, and supplies the quantized coefficient that is obtained as a result to the inverse quantization unit 253.

In step S263, the inverse quantization unit 253 subjects the quantized coefficient from the lossless decoding unit 252 to inverse quantization, and supplies the coefficient that is obtained as a result to the inverse orthogonal transformation unit 254.

In step S264, the inverse orthogonal transformation unit 254 subjects the coefficient from the inverse quantization unit 253 to inverse orthogonal transformation, and supplies the residual information that is obtained as a result to the addition unit 255.

In step S265, the motion vector generation unit 261 determines whether or not the motion information is supplied from the slice header decoding unit 173 of FIG. 16. When the motion information is determined to be supplied in step S265, the process proceeds to step S266.

In step S266, the motion vector generation unit 261 restores and holds the motion vector based on the motion information and the motion vector that is held. The motion vector generation unit 261 supplies the restored motion vector, the optimal inter prediction mode that is included in the motion information and the like to the motion compensation unit 262.

In step S267, the motion compensation unit 262 performs the motion compensation process by reading out the reference image from the frame memory 259 based on the motion vector and the optimal inter prediction mode that are supplied from the motion vector generation unit 261. The motion compensation unit 262 supplies the prediction image that is generated as a result of the motion compensation process to the correction unit 263.

In step S268, in the same manner as the correction unit 135 of FIG. 6, the correction unit 263 calculates the correction coefficient based on the parallax maximum value, the parallax minimum value and the inter-camera distance that are supplied from the slice header decoding unit 173 of the FIG. 16.

In step S269, in the same manner to the correction unit 135, the correction unit 263 corrects the prediction image of the optimal inter prediction mode that is supplied from the motion compensation unit 262 using the correction coefficient. The correction unit 263 supplies the post-correction prediction image to the addition unit 255 via the switch 264, and the process proceeds to step S271.

On the other hand, when it is determined that the motion information is not supplied in step S265, that is, when the screen intra prediction information is supplied from the slice header decoding unit 173 to the screen intra prediction unit 260, the process proceeds to step S270.

In step S270, the screen intra prediction unit 260 performs the screen intra prediction process of the optimal intra prediction mode that is indicated by the screen intra prediction information, which is supplied from the slice header decoding unit 173 using the reference image that is supplied from the addition unit 255. The screen intra prediction unit 260 supplies the prediction image that is generated as a result to the addition unit 255 via the switch 264, and the process proceeds to step S271.

In step S271, the addition unit 255 adds the residual information that is supplied from the inverse orthogonal transformation unit 254 to the prediction image that is supplied from the switch 264. The addition unit 255 supplies the parallax image that is obtained as a result to the deblocking filter 256 and also supplies the parallax image to the screen intra prediction unit 260 as a reference image.

In step S272, the deblocking filter 256 removes block distortion by performing filtering on the parallax image that is supplied from the addition unit 255.

In step S273, the deblocking filter 256 supplies the post-filtering parallax image to the frame memory 259, causes the frame memory 259 to accumulate the parallax image and supplies the parallax image to the screen rearrangement buffer 257. The parallax image that is accumulated in the frame memory 259 is supplied to the motion compensation unit 262 as a reference image.

In step S274, the screen rearrangement buffer 257 stores the parallax image that is supplied from the deblocking filter 256 in frame units, rearranges the parallax image of frame units in stored order for encoding into the original order of display, and supplies the parallax image to the D/A conversion unit 258.

In step S275, the D/A conversion unit 258 subjects the parallax image of frame units that is supplied from the screen rearrangement buffer 257 to D/A conversion, and supplies the parallax image to the viewpoint combining unit 152 of FIG. 15 as the parallax image of a predetermined viewpoint.

As described above, the decoding device 150 receives an encoded bitstream that includes the encoded data of the parallax image, in which the encoding efficiency is improved by encoding using the prediction image that is corrected using the information relating to the parallax image, and the information relating to the parallax image. Furthermore, the decoding device 150 corrects the prediction image using the information relating to the parallax image and decodes the encoded data of the parallax image using the post-correction prediction image.

More specifically, the decoding device 150 receives the encoded data, which is encoded using the prediction image that is corrected using the inter-camera distance, the parallax maximum value and the parallax minimum value as the information relating to the parallax image, and the inter-camera distance, the parallax maximum value and the parallax minimum value. Furthermore, the decoding device 150 corrects the prediction image using the inter-camera distance, the parallax maximum value and the parallax minimum value, and decodes the encoded data of the parallax image using the post-correction prediction image. Accordingly, the decoding device 150 can decode the encoded data of the parallax image, in which the encoding efficiency is improved by encoding using the prediction image that is corrected using the information relating to the parallax image.

Note that, the encoding device 50 includes the parallax maximum value, the parallax minimum value and the inter-camera distance in the slice header as the information used in the correction of the prediction image and delivers the slice header; however, the delivery method is not limited thereto.

### [Description of Delivery Method of Information Used in Correction of Prediction Image]

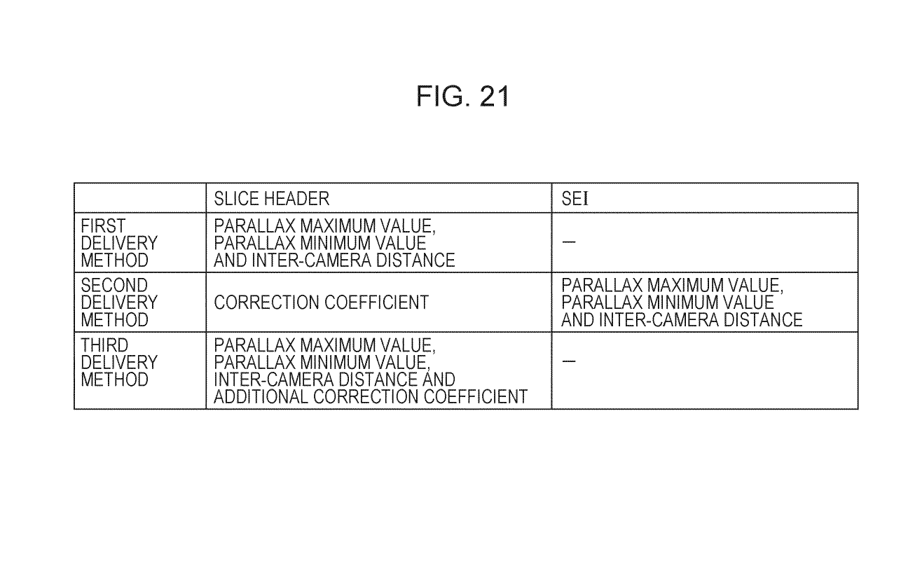

FIG. 21 is a diagram that illustrates the delivery method of the information that is used in the correction of the prediction image.

As described above, the first delivery method of FIG. 21 is a method in which the parallax maximum value, the parallax minimum value and the inter-camera distance are included in the slice header as the information used in the correction of the prediction image, and the slice header is delivered. In this case, it is possible to cause the information that is used in the correction of the prediction image and the viewpoint generation information to be shared, and to reduce the information amount of the encoded bitstream. However, in the decoding device 150, it is necessary to calculate the correction coefficient using the parallax maximum value, the parallax minimum value and the inter-camera distance, and the processing load of the decoding device 150 is great in comparison to that of the second delivery method described hereinafter.

On the other hand, the second delivery method of FIG. 21 is a method in which the correction coefficient itself is included in the slice header as the information that is used in the correction of the prediction image and the slice header is delivered. In this case, the parallax maximum value, the parallax minimum value and the inter-camera distance are not used in the correction of the prediction image. Therefore, the parallax maximum value, the parallax minimum value and the inter-camera distance are included as a portion of the viewpoint generation information in, for example, the SEI (Supplemental Enhancement Information) that need not be referred to during the decoding and the SEI is delivered. In the second delivery method, since the correction coefficient is delivered, it is not necessary to calculate the correction coefficient in the decoding device 150, and the processing load of the decoding device 150 is small in comparison to that of the first delivery method. However, since the correction coefficient is newly delivered, the information amount of the encoded bitstream becomes greater.

Furthermore, in the description given above, the prediction image is corrected using the parallax maximum value, the parallax minimum value and the inter-camera distance; however, it is possible for the prediction image to be corrected also using other information relating to the parallax (for example, imaging position information that indicates the imaging position in the depth direction of the multi-view color image imaging unit 51, or the like).

In this case, according to the third delivery method of FIG. 21, an additional correction coefficient, which is the correction coefficient that is generated using the parallax maximum value, the parallax minimum value, the inter-camera distance and the other information relating to the parallax as the information used in the correction of the prediction image, is included in the slice header, and the slice header is delivered. In this manner, when the prediction image is corrected also using information relating to the parallax other than the parallax maximum value, the parallax minimum value and the inter-camera distance, it is possible to further reduce the delta of the prediction image according to the information relating to the parallax and the parallax image, and to improve the encoding efficiency. However, since the additional correction coefficient is newly delivered, the information amount of the encoded bitstream is great in comparison with that of the first delivery method. In addition, since it is necessary to calculate the correction coefficient using the parallax maximum value, the parallax minimum value and the inter-camera distance, the processing load of the decoding device 150 is great in comparison with the second delivery method.

FIG. 22 is a diagram that shows a configuration example of the encoded bitstream when delivering the information that is used in the correction of the prediction image in the second delivery method.

In the example of FIG. 22, the correction coefficients of a single intra-type slice and the two inter-type slices that configure the same PPS unit of PPS #0, respectively do not match the correction coefficients of the slice that is one prior in the encoding order. Therefore, the delivery flag “1” that indicates the presence of delivery is included in PPS #0. Note that, here, the delivery flag is a flag that indicates the presence or absence of delivery of the correction coefficient.

In addition, in the example of FIG. 22, a correction coefficient a of the slice of the intra-type that configures the same PPS unit of PPS #0 is 1, and a correction coefficient b is 0. Therefore, the correction coefficient a “1” and the correction coefficient b “0” are included in the slice header of the slice.

Furthermore, in the example of FIG. 22, the correction coefficient a of the first inter-type slice that configures the same PPS unit of PPS #0 is 3, and the correction coefficient b is 2. Therefore, the correction coefficient a “1” of the intra-type slice that is one prior in the encoding order is subtracted from the correction coefficient a “3” of the slice. The delta “+2” is included in the slice header of the slice as the delta encoding result of the correction coefficients. In the same manner, the delta “+2” of the correction coefficients b is included as the delta encoding result of the correction coefficients b.

In addition, in the example of FIG. 22, the correction coefficient a of the second inter-type slice that configures the same PPS unit of PPS #0 is 0, and the correction coefficient b is −1. Therefore, the correction coefficient a “3” of the first inter-type slice that is one prior in the encoding order is subtracted from the correction coefficient a “0” of the slice. The delta “−3” is included in the slice header of the slice as the delta encoding result of the correction coefficients. In the same manner, the delta “−3” of the correction coefficients b is included as the delta encoding result of the correction coefficients b.

In addition, in the example of FIG. 22, the correction coefficients of a single intra-type slice and the two inter-type slices that configure the same PPS unit of PPS #1, respectively match the correction coefficients of the slice that is one prior in the encoding order. Therefore, the delivery flag “0” that indicates the absence of delivery is included in PPS #1.

FIG. 23 is a diagram that shows a configuration example of the encoded bitstream when delivering the information that is used in the correction of the prediction image in the third delivery method.

In the example of FIG. 23, the parallax minimum values, the parallax maximum values, the inter-camera distances and the additional correction coefficients of the single intra-type slice and the two inter-type slices that configure the same PPS unit of PPS #0, respectively do not match the parallax minimum value, the parallax maximum value, the inter-camera distance and the additional correction coefficient of the slice that is one prior in the encoding order. Therefore, the delivery flag “1” that indicates the presence of delivery is included in PPS #0. Note that, here, the delivery flag is a flag that indicates the presence or absence of delivery of the parallax minimum value, the parallax maximum value, the inter-camera distance and the additional correction coefficient.

In addition, in the example of FIG. 23, the parallax minimum value, the parallax maximum value and the inter-camera distance of the slices that configure the same PPS unit of PPS #0 are the same as in the case of FIG. 7, and the information relating to the parallax minimum value, the parallax maximum value and the inter-camera distance that are included in the slice header of each slice are the same as FIG. 7; thus, description will be omitted.

In addition, in the example of FIG. 23, the additional correction coefficient of the intra-type slice that configures the same PPS unit of PPS #0 is 5. Therefore, the additional correction coefficient “5” is included in the slice header of the slice.

Furthermore, in the example of FIG. 23, the additional correction coefficient of the first inter-type slice that configures the same PPS unit of PPS #0 is 7. Therefore, the additional correction coefficient “5” of the intra-type slice that is one prior in the encoding order is subtracted from the additional correction coefficient “7” of the slice. The delta “+2” is included in the slice header of the slice as the delta encoding result of the additional correction coefficients.

Furthermore, in the example of FIG. 23, the additional correction coefficient of the second inter-type slice that configures the same PPS unit of PPS #0 is 8. Therefore, the additional correction coefficient “7” of the first inter-type slice that is one prior in the encoding order is subtracted from the additional correction coefficient “8” of the slice. The delta “+1” is included in the slice header of the slice as the delta encoding result of the additional correction coefficients.

In the example of FIG. 23, the parallax minimum values, the parallax maximum values, the inter-camera distances and the additional correction coefficients of the single intra-type slice and the two inter-type slices that configure the same PPS unit of PPS #1, respectively match the parallax minimum value, the parallax maximum value, the inter-camera distance and the additional correction coefficient of the slice that is one prior in the encoding order. Therefore, the delivery flag “0” that indicates the absence of delivery is included in PPS #1.

The encoding device 50 may deliver the information that is used in the correction of the prediction image using one of the first to third methods of FIG. 21. In addition, the encoding device 50 may include identification information (for example, a flag, an ID or the like) that identifies one of the delivery methods of the first to third delivery methods, which is adopted as the delivery method, in the encoded bitstream, and deliver the encoded bitstream. Furthermore, the first to third delivery methods of FIG. 21 can be appropriately selected according to the application in which the encoded bitstream is to be used, in consideration of the balance between the data amount of the encoded bitstream and the processing load of decoding.

In addition, in the present embodiment, the information that is used in the correction of the prediction image is disposed in the slice header as the information relating to the encoding; however, as long as the region in which the information that is used in the correction of the prediction image is disposed is a region that is referenced during the encoding, the region is not limited to the slice header. For example, the information that is used in the correction of the prediction image may be disposed in an existing NAL (Network Abstraction Layer) unit such as the NAL unit of PPS, or in a new NAL unit such as the NAL unit of APS (Adaptation Parameter Set) as proposed in the HEVC standard.

For example, when the correction coefficient or the additional correction coefficient are shared between a plurality of pictures, it is possible to improve the delivery efficiency by disposing the shared values in the NAL unit (for example, the NAL unit of PPS or the like) that is applicable to the plurality of pictures. In other words, in this case, since the correction coefficient or the additional correction coefficient that is shared between the plurality of pictures may be delivered, it is not necessary to deliver the correction coefficient or the additional correction coefficient for each slice, as is the case when disposing the correction coefficient or the additional correction coefficient in the slice header.

Therefore, for example, when the color image is a color image that includes a flash or a fading effect, since the parameters such as the parallax minimum value, the parallax maximum value and the inter-camera distance tend not to change, the correction coefficient or the additional correction coefficient is caused to be disposed in the NAL unit or the like of the PPS and the delivery efficiency is improved.

When the correction coefficient or the additional correction coefficient is different for each picture, for example, the correction coefficient or the additional correction coefficient may be disposed in the slice header. When the correction coefficient or the additional correction coefficient is shared between a plurality of pictures, the correction coefficient or the additional correction coefficient may be disposed in a layer that is higher than the slice header (for example, the NAL unit of the PPS or the like).

Furthermore, the parallax image may be an image (a depth image) formed of depth values that indicate the positions in the depth direction of the object of each pixel of a color image of a viewpoint corresponding to the parallax image. In this case, the parallax maximum value and the parallax minimum value are the maximum value and the minimum value of the global coordinate values of positions in the depth direction that can be assumed in the multi-view parallax image, respectively.

In addition, the present technology may also be applied to an encoding method other than the HEVC method, such as AVC or MVC (Multiview Video Coding).

### <Other Configurations of Slice Encoding Unit>

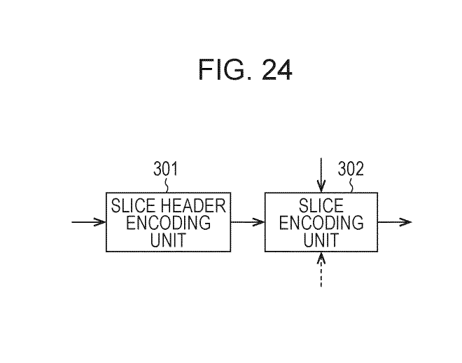

FIG. 24 is a diagram in which the slice header encoding unit 63 (FIG. 5) and the slice encoding unit 64 that configure the multi-view image encoding unit 55 (FIG. 1) have been extracted. In FIG. 24, in order to distinguish the slice header encoding unit 63 and the slice encoding unit 64 that are shown in FIG. 5, description is given with different numerals assigned thereto; however, since the general processes are the same as the slice header encoding unit 63 and the slice encoding unit 64 shown in FIG. 5, description thereof will be omitted as appropriate.

Furthermore, when depth images, which are formed from depth values that indicate the position (the distance) in the depth direction, are used as the parallax images, the parallax maximum value and the parallax minimum value described above are respectively the maximum value and the minimum value of the global coordinate values of a position in the depth direction that can be assumed in the multi-view parallax image. Here, even when the parallax maximum value and the parallax minimum value are disclosed, when the depth images, which are formed of depth values that indicate the position in the depth direction, are used as the parallax images, the values are interpreted as the maximum value and the minimum value of the global coordinate values of the position in the depth direction, as appropriate.

A slice header encoding unit 301 is configured in the same manner as the slice header encoding unit 63 described above, and generates the slice header based on the delivery flag that is included in the PPS that is supplied from the PPS encoding unit 62 and each slice type. The slice header encoding unit 301 further adds the slice header that is generated to the SPS, to which the PPS that is supplied from the PPS encoding unit 62 is added, and supplies the SPS to the slice encoding unit 64.

A slice encoding unit 302 performs the same encoding as the slice encoding unit 64 described above. In other words, the slice encoding unit 302 performs encoding of slice units in relation to the multi-view corrected color image that is supplied from the multi-view color image correction unit 52 (FIG. 1) using the HEVC method.

In addition, of the viewpoint generation information that is supplied from the viewpoint generation information generation unit 54 of FIG. 1, the slice encoding unit 302 uses the parallax maximum value, the parallax minimum value and the inter-camera distance as the information relating to the parallax, and performs the encoding of slice units in relation to the multi-view parallax image from the multi-view parallax image generation unit 53 using a method that conforms to the HEVC method. The slice encoding unit 302 adds the encoded data and the like of slice units that is obtained as a result of the encoding to the SPS, to which the PPS and the slice header that are supplied from the slice header encoding unit 301 are added, and generates the bitstream. The slice encoding unit 302 functions as a delivery unit and delivers the bitstream as an encoded bitstream.

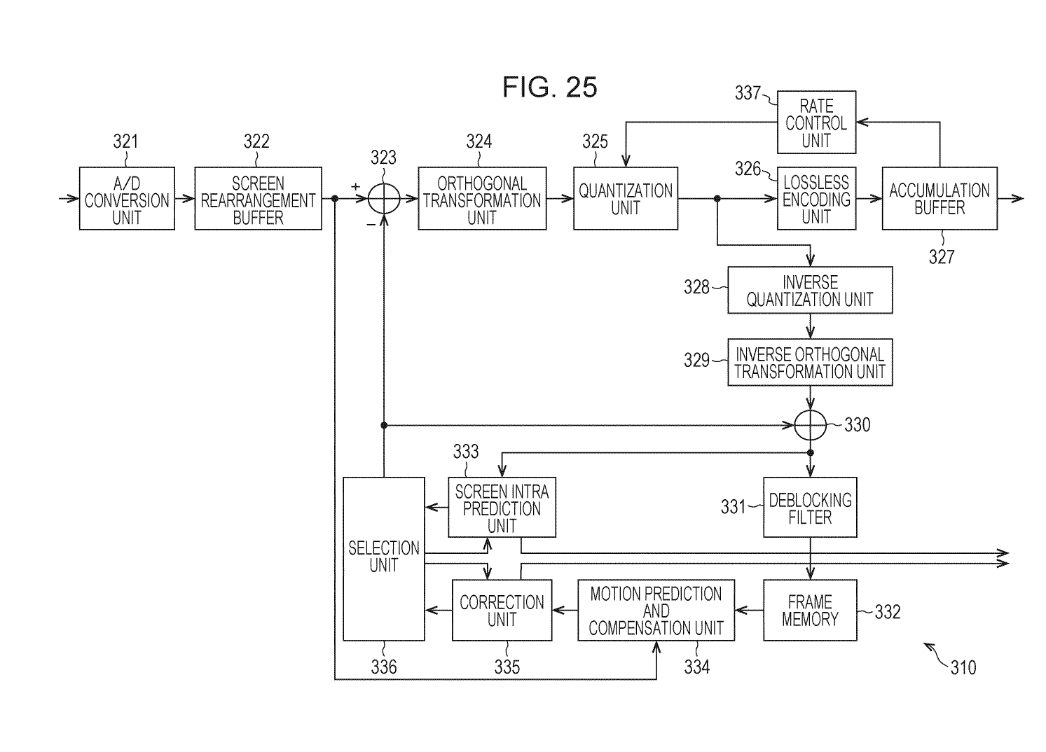

FIG. 25 is a diagram that shows an internal configuration example of the encoding unit that encodes the parallax image of one arbitrary viewpoint within the slice encoding unit 302 of FIG. 24. The encoding unit 310 shown in FIG. 25 is configured of an A/D conversion unit 321, a screen rearrangement buffer 322, a calculation unit 323, an orthogonal transformation unit 324, a quantization unit 325, a lossless encoding unit 326, an accumulation buffer 327, an inverse quantization unit 328, an inverse orthogonal transformation unit 329, an addition unit 330, a deblocking filter 331, frame memory 332, a screen intra prediction unit 333, a motion prediction and compensation unit 334, a correction unit 335, a selection unit 336 and a rate control unit 337.

The encoding unit 310 shown in FIG. 25 has the same configuration as the encoding unit 120 shown in FIG. 6. In other words, the A/D conversion unit 321 to the rate control unit 337 of the encoding unit 310 shown in FIG. 25 respectively have the same functions as the A/D conversion unit 121 to the rate control unit 137 of the encoding unit 120 shown in FIG. 6. Therefore, detailed description thereof will be omitted here.

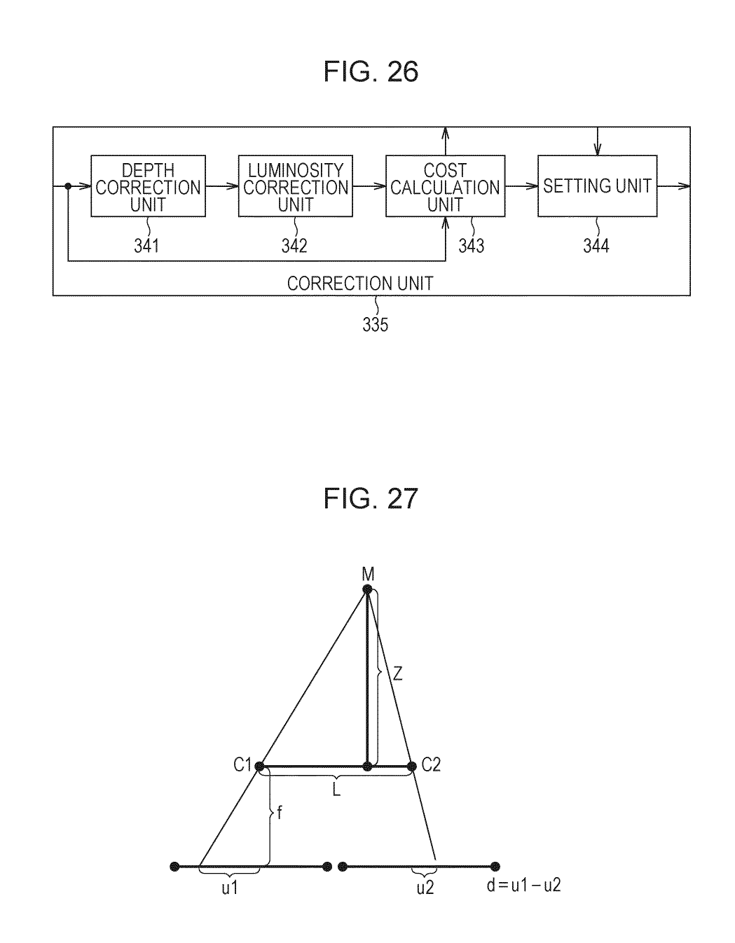

The encoding unit 310 shown in FIG. 25 has the same configuration as the encoding unit 120 shown in FIG. 6; however, the internal configuration of the correction unit 335 is different from that of the correction unit 135 of the encoding unit 120 shown in FIG. 6. The configuration of the correction unit 335 is shown in FIG. 26.

The correction unit 335 shown in FIG. 26 is configured of a depth correction unit 341, a luminosity correction unit 342, a cost calculation unit 343 and a setting unit 344. The processes performed by each of these parts will be described hereinafter with reference to flow charts.

FIG. 27 is a diagram for illustrating the parallax and the depth. In FIG. 27, C1 indicates a position in which a camera C1 is located, and C2 shows the position in which a camera C2 is located. A configuration is adopted in which it is possible to photograph color images (color images) of different viewpoints using the camera C1 and the camera C2. In addition, the camera C1 and the camera C2 are located separated by a distance L. M is the object that serves as the imaging target, and is described as an object M. Whereas f indicates the focal length of the camera C1.

When there is such a relationship, the following equation is satisfied.

Z=(L/D)×f

In this equation, Z is the position in the depth direction of the object (the distance in the depth direction between the object M and the camera C1 (the camera C2)) of the parallax image (the depth image). D indicates (the x component of) the photographic parallax vector, and indicates the parallax value. In other words, D is the parallax that occurs between the two cameras. Specifically, D (d) is a value obtained by subtracting a distance u2 from a distance u1. The distance u1 is the distance in the horizontal direction of the position of the object M on the color image that is imaged by the camera C1 from the center of the color image. The distance u2 is the distance in the horizontal direction of the position of the object M on the color image that is imaged by the camera C2 from the center of the color image. As shown by the equation described above, it is possible to uniquely convert between the parallax value D and the position Z. Therefore, hereinafter, the parallax image and the depth image will be collectively referred to as the depth image. Further description will be continued of the relationship of the equation described above being satisfied, particularly of the relationship between the parallax value D and the position Z in the depth direction.

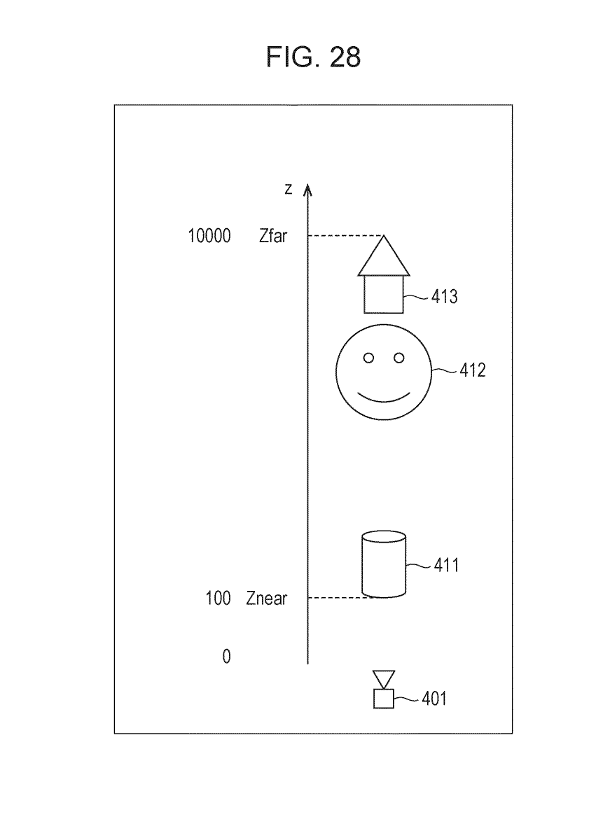

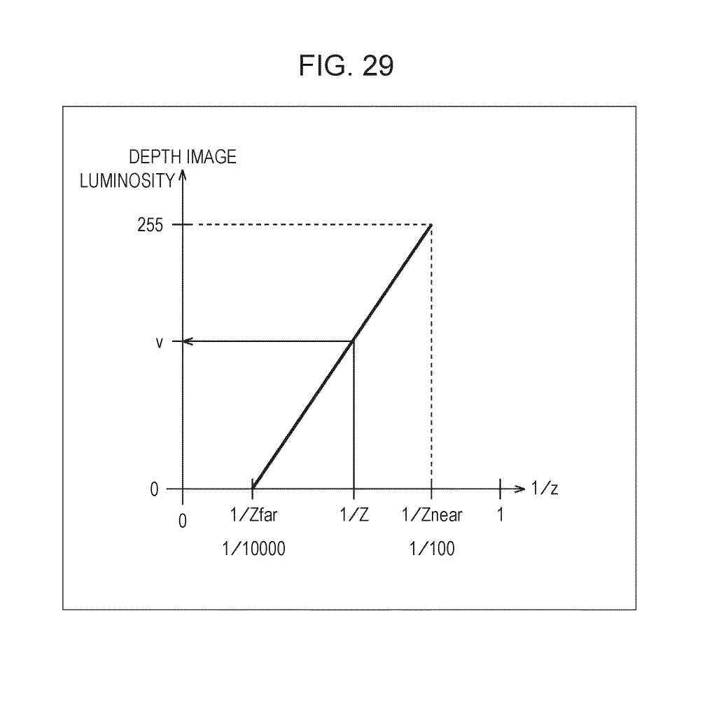

FIGS. 28 and 29 are diagrams for illustrating the relationship between the image that is imaged by the camera, the depth and the depth value. A camera 401 images a cylinder 411, a face 412 and a house 413. The cylinder 411, the face 412 and the house 413 are disposed in order from the side that is close to the camera 401. At this time, the position in the depth direction of the cylinder 411, which is disposed in the position closest to the camera 401, is set to the minimum value Znear of the global coordinate values of the position in the depth direction, and the position of the house 413, which is disposed in the position furthest from the camera 401, is set to the maximum value Zfar of the global coordinate values of the position in the depth direction.

FIG. 29 is a diagram that illustrates the relationship between the minimum value Znear and the maximum value Zfar of the position in the depth direction of the viewpoint generation information. In FIG. 29, the horizontal axis is the reciprocal of the pre-normalization position in the depth direction, and the vertical axis is the pixel value of the depth image. As shown in FIG. 29, the depth value for the pixel value of each pixel is normalized to a value of 0 to 255, for example, by using the reciprocal of the maximum value Zfar and the reciprocal of the minimum value Znear. Furthermore, the depth image is generated using the post-normalization depth value of each pixel as the pixel value, which is a value of 0 to 255.

The graph shown in FIG. 29 corresponds to the graph shown in FIG. 2. The graph shown in FIG. 29 is a flag that indicates the relationship between the minimum value and the maximum value of the position in the depth direction of the viewpoint generation information; whereas, the graph shown in FIG. 2 is a graph showing the relationship between the parallax maximum value and the parallax minimum value of the viewpoint generation information.

As described with reference to FIG. 2, the pixel value I of each pixel of the parallax image is represented by Equation (1) using the pre-normalization parallax value d of the pixel, the parallax minimum value Dmin and the parallax maximum value Dmax. Here, Equation (1) is shown again as Equation (11) below.

$$\begin{matrix}[ Formula . 9 ] & \\ I = \frac{255 * ( d - {D}_{min} )}{{D}_{max} - {D}_{min}} & ( 11 )\end{matrix}$$

In addition, a pixel value y of each pixel of the depth image is represented by Equation (13) below using the pre-normalization depth value 1/Z of the pixel, the minimum value Znear and the maximum value Zfar. Note that, here, the reciprocal of the position Z is used as the depth value; however, the position Z itself may also be used as the depth value.

$$\begin{matrix}[ Formula . 10 ] & \\ y = 255 \cdot \frac{\frac{1}{Z} - \frac{1}{{Z}_{far}}}{\frac{1}{{Z}_{near}} - \frac{1}{{Z}_{far}}} & ( 13 )\end{matrix}$$

As can be understood from Equation (13), the pixel value y of the depth image is a value that is calculated from the maximum value Zfar and the minimum value Znear. As described with reference to FIG. 28, the maximum value Zfar and the minimum value Znear are values that are determined dependent on the positional relationship of the imaged objects. Therefore, when the positional relationship of the objects within the image that is imaged changes, the maximum value Zfar and the minimum value Znear also change, respectively, corresponding to the change.

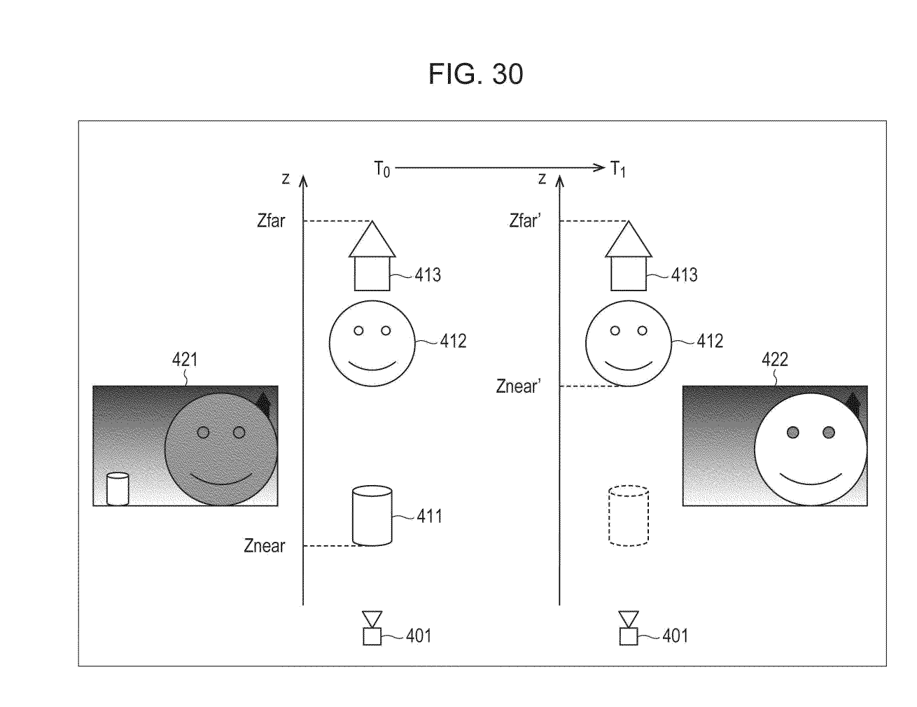

Here, description will be given of when the positional relationship of the objects changes with reference to FIG. 30. The left side of FIG. 30 shows the positional relationship of the image that is imaged by the camera 401 at the time T₀, and shows the same positional relationship as the positional relationship shown in FIG. 28. A case is anticipated in which, when time T₀ changes to time T₁, the cylinder 411 that had been positioned near the camera 401 vanishes, and there is no change in the positional relationship between the face 412 and the house 413.

In this case, when time T₀ changes to time T₁, the minimum value Znear changes to a minimum value Znear′. In other words, at time T₀, the position Z in the depth direction of the cylinder 411 is the minimum value Znear; conversely, at time T₁, the object of the position that is closest from the camera 401 changes to the face 412 due to the cylinder 411 vanishing, and the position of the minimum value Znear (Znear′) changes to the position Z of the face 412 together with this change.

At time T₀, the delta (the range) of the minimum value Znear and the maximum value Zfar is set to a depth range A, which indicates the range of the position in the depth direction, and at time T₁, the delta (the range) of the minimum value Znear′ and the maximum value Zfar is set to a depth range B. In this case, the depth range A has changed to the depth range B. Here, as described above, with reference to Equation (13) once more, since the pixel value y of the depth image is a value that is calculated from the maximum value Zfar and the minimum value Znear, when the depth range A changes to the depth range B in this manner, the pixel value that is calculated using such a value also changes.

For example, a depth image 421 of time T₀ is shown on the left side of FIG. 30; however, since the cylinder 411 is at the front, the pixel values of the cylinder 411 are great (bright), and since the pixel values of the face 412 and the house 413 are positioned further than the cylinder 411, they are smaller (darker) than those of the cylinder 411. In the same manner, a depth image 422 of time T₁ is shown on the right side of FIG. 30; however, since the cylinder 411 has vanished, the depth range becomes smaller and the pixel values of the face 412 are great (bright) in comparison with those of the depth image 421. As described above, this is because, since the depth range changes, the pixel value y obtained using Equation (13) using the maximum value Zfar and the minimum value Znear changes, even with the same position Z.

However, at time T₀ and time T₁, since the position of the face 412 does not change, it is preferable that there not be a sudden change in the pixel values of the depth image of the face 412 at time T₀ and time T₁. In other words, in this manner, when the range of the maximum value and the minimum value of the position (the distance) in the depth direction changes suddenly, the pixel values (the luminosity values) of the depth image change greatly even if the position in the depth direction is the same, and there is a likelihood that prediction will be inaccurate. Therefore, description will be given of a case in which control is performed to avoid this.

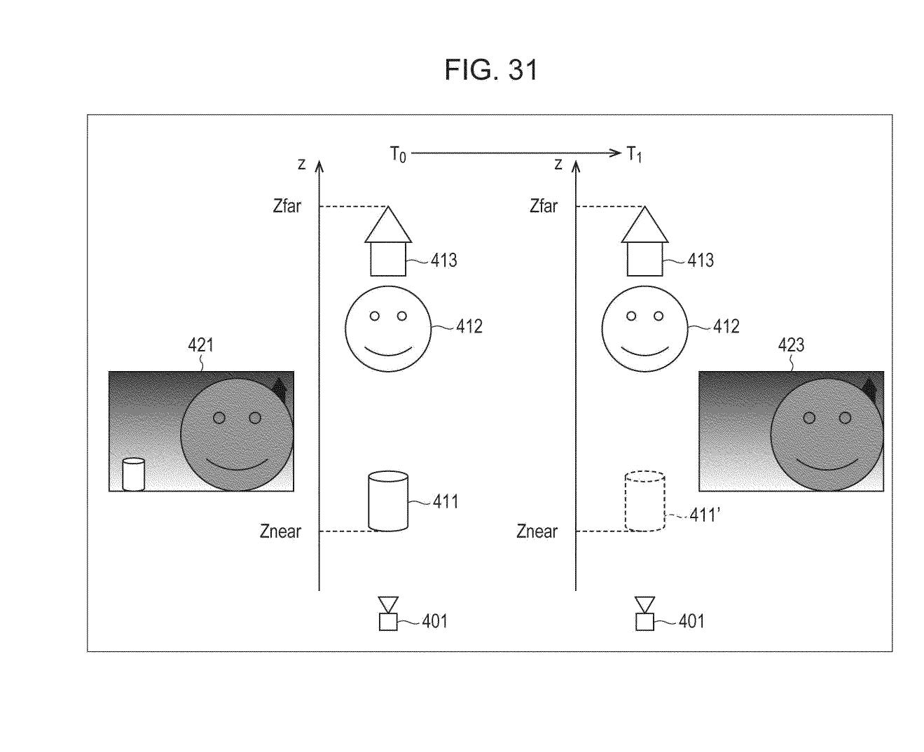

FIG. 31 is the same as the view shown in FIG. 30. However, in the positional relationship of the objects at time T₁, shown on the right side shown in FIG. 31, it is anticipated that a cylinder 411′ is positioned in front of the camera 401 and processing is performed such that there is no change in the minimum value Znear. By performing such a process, it is possible to perform the process without the depth range A and the depth range B changing as described above. Accordingly, the range of the maximum value and the minimum value of the distance in the depth direction is prevented from changing suddenly, the pixel values (the luminosity values) of the depth image do not change greatly even if the position in the depth direction is the same, and it is possible to reduce the likelihood that prediction will be inaccurate.

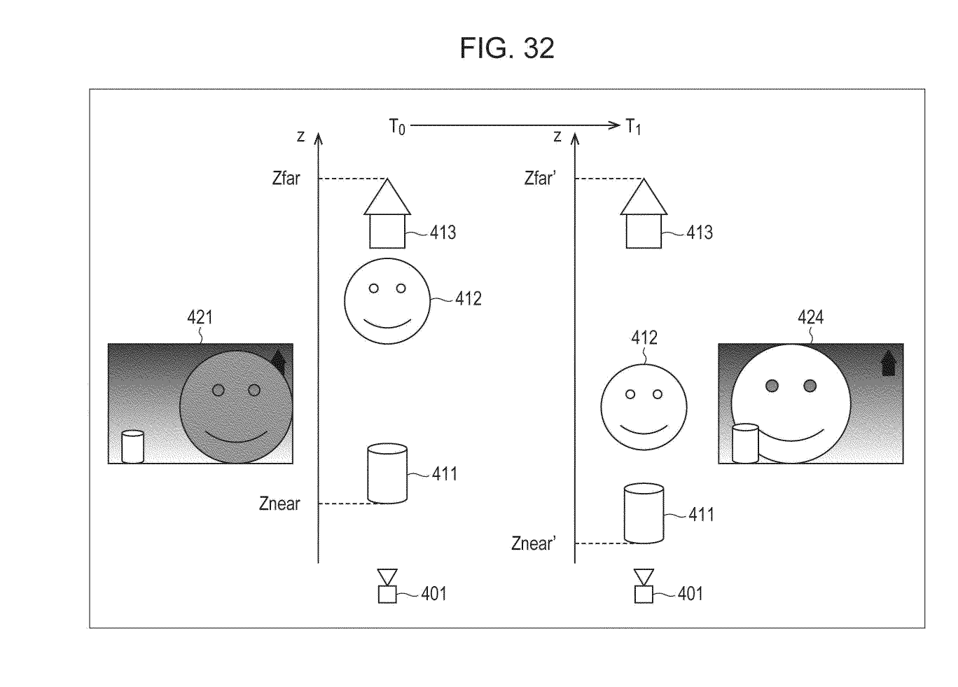

In addition, as shown in FIG. 32, a case in which the positional relationship of the objects changes is also anticipated. In the positional relationship of the objects shown in FIG. 32, the positional relationship at time T₀ shown on the left side of FIG. 32 is the same as that shown in FIG. 30 or 31, and is a case in which the cylinder 411, the face 412 and the house 413 are positioned in order from a position that is closest to the camera 401.

From this state, at time T₁, when the face 412 moves toward the camera 401 and the cylinder 411 also moves toward the camera 401, first, as shown in FIG. 32, since the minimum value Znear becomes the minimum value Znear′, the delta of the minimum value Znear and the maximum value Zfar changes and the depth range changes. As described with reference to FIG. 31, such a sudden change in the range of the maximum value and the minimum value of the position in the depth direction is processed such that the position of the cylinder 411 does not change; thereby, it is possible to prevent the pixel values (the luminosity values) of the depth image from changing greatly when the positions in the depth direction are the same.

In the case shown in FIG. 32, since the face 412 is also moving in the direction of the camera 401, the position in the depth direction of the face 412 is smaller (the pixel value (the luminosity value) of the depth image is greater) than the position in the depth direction of the face 412 at time T₀. However, when a process that prevents the pixel values (the luminosity values) of the depth image from changing greatly when the positions in the depth direction are the same, is performed as described above, there is a likelihood that the pixel values of the depth image of the face 412 are not set to appropriate pixel values (luminosity values) corresponding to the position in the depth direction. Therefore, after performing the processes that are described with reference to FIG. 31, a process is executed in which the pixel values (the luminosity values) of the face 412 and the like are appropriate pixel values (luminosity values). The process that prevents the pixel values of the depth image from changing greatly when the positions in the depth direction are the same, is performed, and a process is performed such that the pixel values are the appropriate pixel values (luminosity values).

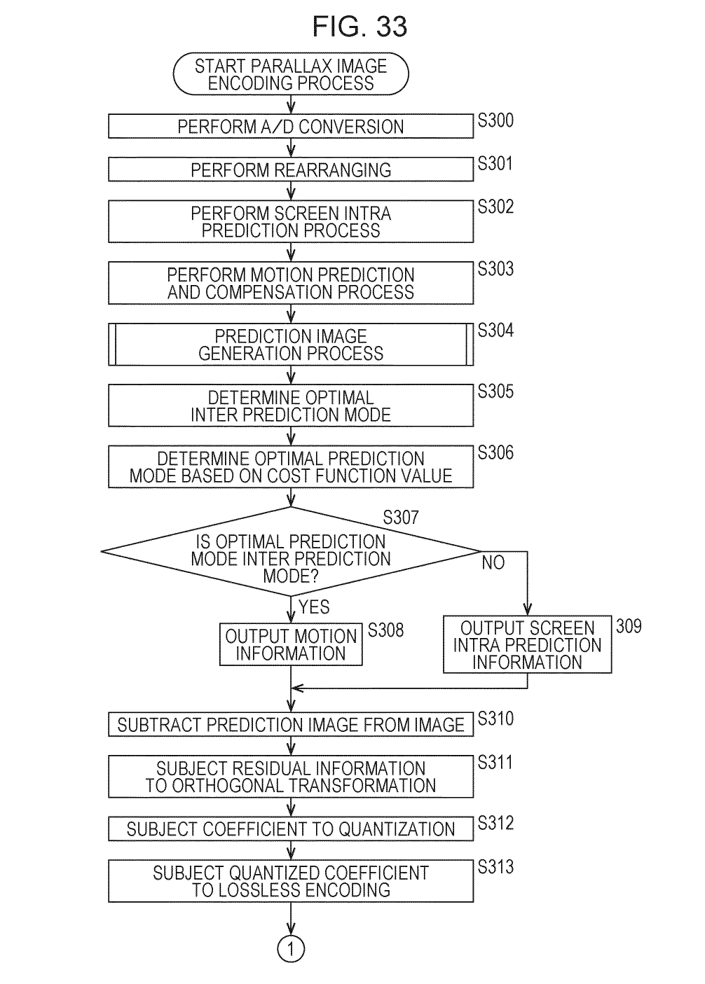

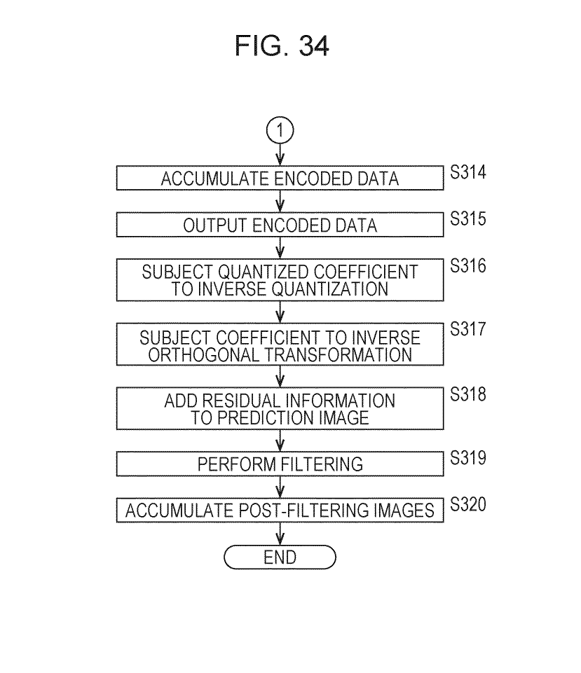

Description will be given of the processes relating to the encoding of the depth image when the above processes are performed with reference to the flow chart of FIGS. 33 and 34. FIGS. 33 and 34 are a flowchart that illustrates the parallax image encoding process of the slice encoding unit 302 shown in FIGS. 24 to 26 in detail. The parallax image encoding process is performed for each viewpoint.

The slice encoding unit 302 shown in FIGS. 24 to 26 has the same general configuration as the slice encoding unit 64 shown in FIGS. 5 and 6; however, it was explained that the internal configuration of the correction unit 335 is different. Accordingly, the processes other than the processes that the correction unit 335 performs are, generally, the same processes as those of the slice encoding unit 64 shown in FIGS. 5 and 6, that is, are performed as the same processes as the processes of the flow chart shown in FIGS. 13 and 14. Here, description relating to parts that overlap the parts illustrated by the flowchart shown in FIGS. 13 and 14 will be omitted.

The processes of steps S300 to S303 and steps S305 to S313 of FIG. 33 are performed in the same manner as the processes of steps S160 to S163 and steps S166 to S174 of FIG. 13. However, the process of step S305 is performed by the cost calculation unit 343 of FIG. 26, and the process of step S308 is performed by the setting unit 344. In addition, the processes of steps S314 to S320 of FIG. 34 are performed in the same manner as the processes of steps S175 to S181 of FIG. 14. In other words, in the prediction image generation process that is executed in step S304, other than differing from the processes of the flowchart shown in FIG. 13, generally the same processes are executed.

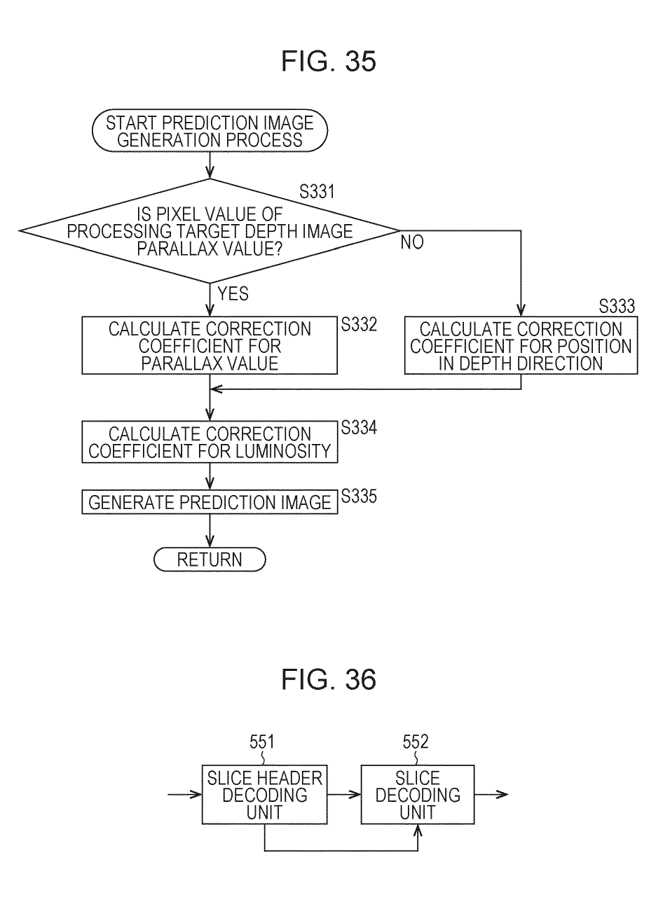

Here, description will be given of the prediction image generation process that is executed in step S304 with reference to the flowchart of FIG. 35. In step S331, the depth correction unit 341 (FIG. 26) determines whether or not the pixel values of the processing-target depth image are parallax values (disparity).

In step S331, when it is determined that the pixel values of the processing-target depth image are parallax values, the process proceeds to step S332. In step S332, a correction coefficient for the parallax value is calculated. The correction coefficient for the parallax value is obtained using the following Equation (14).

$$\begin{matrix}[ Formula . 11 ] & \\ \begin{matrix}{V}_{ref}^{′} = \frac{{L}_{cur} {F}_{cur}}{{L}_{ref} {F}_{ref}} \cdot \frac{{Dref}_{max} - {Dref}_{min}}{{Dcur}_{max} - {Dcur}_{min}} \cdot {v}_{ref} + 255 \cdot \frac{{L}_{cur} {F}_{cur}}{{L}_{ref} {F}_{ref}} \cdot \\ \frac{{Dref}_{max} - {Dcur}_{min}}{{Dcur}_{max} - {Dcur}_{min}} \\ = a {v}_{ref} + b\end{matrix} & ( 14 )\end{matrix}$$

In Equation (14), Vref′ and Vref are respectively the parallax value of the prediction image of the post-correction parallax image and the parallax value of the prediction image of the pre-correction parallax image. In addition, Lcur and Lref are respectively the inter-camera distance of the encoding-target parallax image and the inter-camera distance of the prediction image of the parallax image. F_{cur} and F_{ref} are respectively the focal length of the encoding-target parallax image and the focal length of the prediction image of the parallax image. Dcurₘᵢₙ and Drefₘᵢₙ are respectively the parallax minimum value of the encoding-target parallax image and the parallax minimum value of the prediction image of the parallax image. Dcurₘₐₓ and Drefₘₐₓ are respectively the parallax maximum value of the encoding-target parallax image and the parallax maximum value of the prediction image of the parallax image.

As the correction coefficients for the parallax values, the depth correction unit 341 generates a and b of Equation (14) as the correction coefficients. The correction coefficient a is a weighting coefficient of the disparity (a disparity weighting coefficient), and the correction coefficient b is an offset of the disparity (a disparity offset). The depth correction unit 341 calculates the pixel values of the prediction image of the post-correction depth image from the disparity weighting coefficient and the disparity offset based on Equation (14) described above.

The process here is the weighting prediction process, which uses the parallax image that is the depth image as a target and is used when normalizing the disparity that is the pixel value of the parallax image. The weighting prediction process uses the disparity weighting coefficient that is the depth weighting coefficient and the disparity offset that is the depth offset based on a disparity range that indicates the range of the disparity. Here, denoted as the depth weighting prediction process, as appropriate.

On the other hand, in step S331, when it is determined that the pixel values of the processing-target depth image are not parallax values, the process proceeds to step S333. In step S333, a correction coefficient for the position (the distance) in the depth direction is calculated. The correction coefficient for the position (the distance) in the depth direction is obtained using the following Equation (15).

$$\begin{matrix}[ Formula . 12 ] & \\ \begin{matrix}{V}_{ref}^{′} = \frac{\frac{1}{{Zref}_{near}} - \frac{1}{{Zref}_{far}}}{\frac{1}{{Zcur}_{near}} - \frac{1}{{Zcur}_{far}}} \cdot {v}_{ref} + 255 \cdot \frac{\frac{1}{{Zref}_{far}} - \frac{1}{{Zref}_{far}}}{\frac{1}{{Zcur}_{near}} - \frac{1}{{Zcur}_{far}}} \\ = a {v}_{ref} + b\end{matrix} & ( 15 )\end{matrix}$$

In Equation (15), Vref′ and Vref are respectively the pixel value of the prediction image of the post-correction depth image and the pixel value of the prediction image of the pre-correction depth image. In addition, the Zcurₙₑₐᵣ and the Zrefₙₑₐᵣ are respectively a position (minimum value Znear) in the depth direction of the object that is closest to the encoding-target depth image, and the position (minimum value Znear) in the depth direction of the object that is closest to the prediction image of the depth image. Zcur_{far} and the Zref_{far} are respectively a position (maximum value Zfar) in the depth direction of the object that is furthest from the encoding-target depth image, and the position (maximum value Zfar) in the depth direction of the object that is furthest from the prediction image of the depth image.

As the correction coefficients for the positions in the depth direction, the depth correction unit 341 generates a and b of Equation (15) as the correction coefficients. The correction coefficient a is a weighting coefficient of the depth value (a depth weighting coefficient), and the correction coefficient b is an offset of the depth value (a depth offset). The depth correction unit 341 calculates the pixel values of the prediction image of the post-correction depth image from the depth weighting coefficient and the depth offset based on Equation (15) described above.

The process here is the weighting prediction process, which uses the depth image that is the depth image as a target and is used when normalizing the depth value that is the pixel value of the depth image. The weighting prediction process uses the depth weighting coefficient that is the depth weighting coefficient and the depth offset that is the depth offset based on a depth range. Here, denoted as the depth weighting prediction process, as appropriate.

In this manner, depending on whether the pixel values of the processing-target depth image are the parallax values (D) or the depth value 1/Z that indicates the position in the depth direction (the distance) (Z), the correction coefficient is calculated using a different equation. In addition, the correction coefficient is used, and the post-correction prediction image is temporarily calculated. Here, the term “temporarily” is used because, at a later stage, correction of the luminosity values is performed. Once the correction coefficient is calculated in this manner, the process proceeds to step S334.

When the correction coefficient is calculated in this manner, the setting unit 344 generates information that indicates whether the correction coefficient for the parallax value is calculated or the correction coefficient for the position in the depth direction (the distance), includes the information in the slice header, and delivers the slice header to the decoding side.

In other words, the setting unit 344 determines whether to perform the depth weighting prediction process based on the depth range that is used when normalizing the depth value that indicates the position in the depth direction (the distance), or, to perform the depth weighting prediction process based on the disparity range that is used when normalizing the parallax value. Based on the determination, the depth identification data that identifies which prediction process is performed is set, and the depth identification data is delivered to the decoding side.

The depth identification data can be set by the setting unit 344, included in the slice header and transmitted. When the encoding side and the decoding side can share the depth identification data, by referring to the depth identification in the decoding side, it is possible to determine whether to perform the depth weighting prediction process based on the depth range that is used when normalizing the depth value that indicates the position in the depth direction (the distance), or, to perform the depth weighting prediction process based on the disparity range that is used when normalizing the parallax value that indicates the parallax.

In addition, it may be determined whether or not to calculate the correction coefficient depending on the type of the slice, and the correction coefficient may not be calculated depending on the type of the slice. Specifically, when the type of the slice is a P slice, an SP slice or a B slice, the correction coefficient is calculated (the depth weighting prediction process is performed), and when the slice is another slice, the correction coefficient may not be calculated.

Furthermore, since one picture is configured from a plurality of slices, the configuration that determines whether or not to calculate the correction coefficient depending on the type of the slice may also be a configuration in which it is determined whether or not to calculate the correction coefficient depending on the type of the picture (the picture type). For example, when the picture type is a B picture, the correction coefficient may not be calculated. Here, description will be continued with the assumption that whether or not to calculate the correction coefficient is determined depending on the type of the slice.

In the cases of the P slice or the SP slice, when the depth weighting prediction process is performed, the setting unit 344, for example, sets the depth_weighted_pred_flag to 1, and when the depth weighting prediction process is not performed, the setting unit 344 sets the depth_weighted_pred_flag to 0, and the depth_weighted_pred_flag may be, for example, included in the slice header and transmitted.

In the case of the B slice, when the depth weighting prediction process is performed, the setting unit 344, for example, sets the depth_weighted_bipred_flag to 1, and when the depth weighting prediction process is not performed (the depth weighting prediction process is skipped), the setting unit 344 sets the depth_weighted_bipred_flag to 0, and the depth_weighted_bipred_flag may be, for example, included in the slice header and transmitted.

According to the above, in the decoding side, it is possible to determine whether or not it is necessary to calculate the correction coefficient by referencing the depth_weighted_pred_flag and the depth_weighted_bipred_flag. In other words, it is possible to perform a process on the decoding side such as performing control so that whether or not to calculate the correction coefficient is determined depending on the type of the slice, and so that the correction coefficient is not calculated depending on the type of the slice.

In step S334, the correction coefficient for the luminosity is calculated by the luminosity correction unit 342. It is possible to calculate the correction coefficient for the luminosity by, for example, applying the luminosity correction in the AVC method. The luminosity correction in the AVC method, in the same manner as the depth weighting prediction process described above, is corrected by a weighting prediction process that uses a weighting coefficient and an offset being performed.

In other words, the prediction image that is corrected by the depth weighting prediction process described above is generated, the weighting prediction process for correcting the luminosity values is performed in relation to the corrected prediction image, and the prediction image (the depth prediction image) that is used when encoding the depth image is generated.

Also in the case of the correction coefficient for the luminosity, data that identifies a case in which the correction coefficient is calculated and a case in which the correction coefficient is not calculated may be set and delivered to the decoding side. For example, in the cases of the P slice or the SP slice, when the correction coefficient of the luminosity value is calculated, for example, the weighted_pred_flag is set to 1, when the correction coefficient of the luminosity value is not calculated, the weighted_pred_flag is set to 0, and the weighted_pred_flag may be, for example, included in the slice header and transmitted.

In addition, in the case of the B slice, when the correction coefficient of the luminosity value is calculated, for example, the weighted_bipred_flag is set to 1, when the correction coefficient of the luminosity value is not calculated, the weighted_bipred_flag is set to 0, and the weighted_bipred_flag may be, for example, included in the slice header and transmitted.

In this manner, first, in step S332 or step S333, after normalization shifting is fixed and the effect of converting to the same coordinate system is obtained, in step S334, a process of fixing luminosity shifting is executed. Hypothetically, when the process of fixing the normalization shifting is to be executed after first fixing the luminosity, the relationship between the minimum value Znear and the maximum value Zfar is destroyed and there is a likelihood that the normalization shifting may not be appropriately fixed. Accordingly, the normalization shifting may be fixed first, and the luminosity shifting may be fixed subsequently.

Furthermore, here, description is given in which the depth weighting prediction process that fixes the normalization shifting and the weighting prediction process that corrects the luminosity values are performed; however, a configuration in which only one of the prediction processes is performed is also possible.

In this manner, when the correction coefficient is calculated, the process proceeds to step S335. In step S335, the prediction image is generated by the luminosity correction unit 342. Since the generation of the prediction image has already been described, description thereof will be omitted. In addition, the depth image is encoded using the depth prediction image that is generated, and the encoded data (the depth stream) is generated and delivered to the decoding side.

Description will be given of a decoding device that receives the images that are generated in this manner and processes them.

### <Configuration of Slice Decoding Unit>

FIG. 36 is a diagram in which the slice header decoding unit 173 and the slice decoding unit 174 (FIG. 16) that configure the multi-view image decoding unit 151 (FIG. 15) have been extracted. In FIG. 36, in order to distinguish the slice header decoding unit 173 and the slice decoding unit 174 that are shown in FIG. 16, description is given with different numerals assigned thereto; however, since the general processes are the same as the slice header decoding unit 173 and the slice decoding unit 174 shown in FIG. 5, description thereof will be omitted as appropriate.

A slice decoding unit 552 decodes the encoded data of a multiplexed color image of slice units using a method that corresponds to the encoding method in the slice encoding unit 302 (FIG. 24) based on other than the information relating to the inter-camera distance, the parallax maximum value and the parallax minimum value of the SPS, the PPS and the slice header that are supplied from a slice header decoding unit 551.

In addition, the slice decoding unit 552 decodes the encoded data of a multiplexed parallax image (a multiplexed depth image) of slice units using a method that corresponds to the encoding method in the slice encoding unit 302 (FIG. 24) based on other than the information relating to the inter-camera distance, the parallax maximum value and the parallax minimum value of the SPS, the PPS and the slice header, and based on the inter-camera distance, the parallax maximum value and the parallax minimum value. The slice decoding unit 552 supplies the multi-view corrected color image and the multi-view parallax image that are obtained as a result of the decoding to the viewpoint combining unit 152 of FIG. 15.

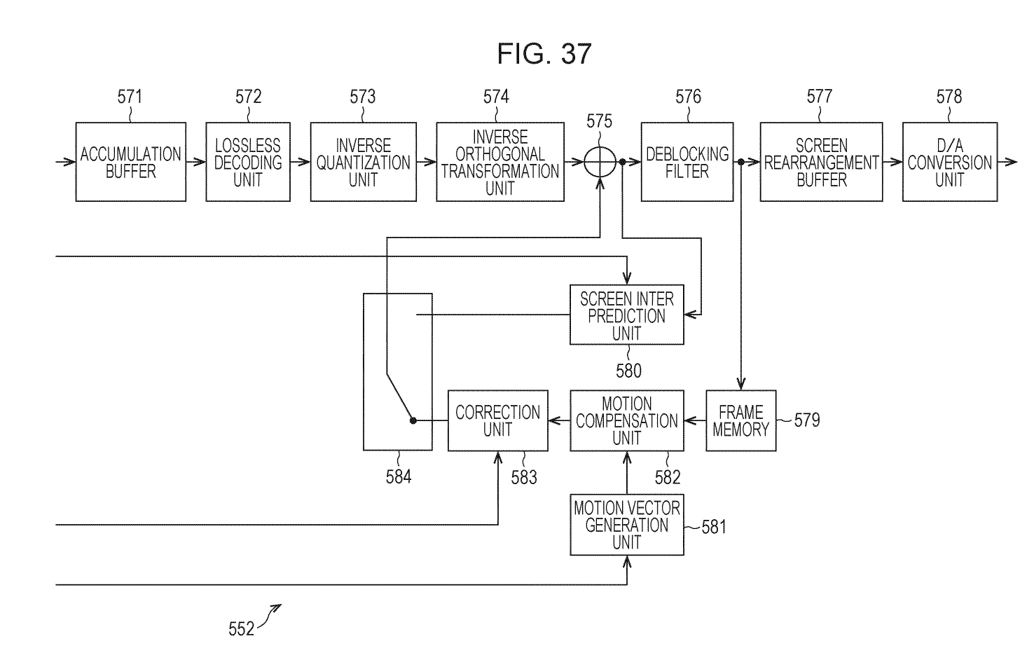

FIG. 37 is a block diagram that shows a configuration example of the decoding unit that decodes the depth image of one arbitrary viewpoint within the slice decoding unit 552 of FIG. 35. In other words, the decoding unit that decodes the multi-view parallax image within the slice decoding unit 552 is configured of a number of slice decoding units 552 of FIG. 37 corresponding to the number of viewpoints.

The slice decoding unit 552 of FIG. 37 is configured of an accumulation buffer 571, a lossless decoding unit 572, an inverse quantization unit 573, an inverse orthogonal transformation unit 574, an addition unit 575, a deblocking filter 576, a screen rearrangement buffer 577, a D/A conversion unit 578, frame memory 579, a screen intra prediction unit 580, a motion vector generation unit 581, a motion compensation unit 582, a correction unit 583 and a switch 584.

The slice decoding unit 552 shown in FIG. 37 has the same configuration as the decoding unit 250 shown in FIG. 17. In other words, the accumulation buffer 571 to the switch 584 of the slice decoding unit 552, which are shown in FIG. 37, have respectively the same functions as the accumulation buffer 251 to the switch 264 shown in FIG. 17. Therefore, detailed description thereof will be omitted here.

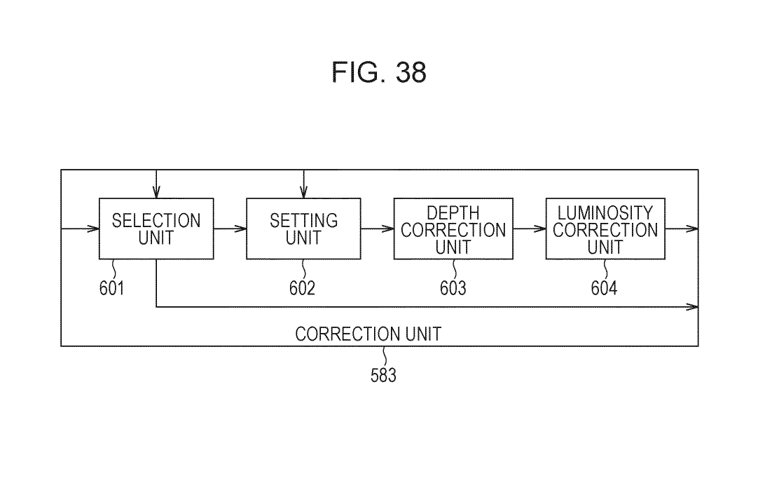

The slice decoding unit 552 shown in FIG. 37 and the decoding unit 250 shown in FIG. 17 have the same configuration; however, the internal configuration of the correction unit 583 is different from that of the correction unit 263 shown in FIG. 17. The configuration of the correction unit 583 is shown in FIG. 38.

The correction unit 583 shown in FIG. 38 is configured of a selection unit 601, a setting unit 602, a depth correction unit 603 and a luminosity correction unit 604. The processes performed by each of these parts will be described hereinafter with reference to flow charts.

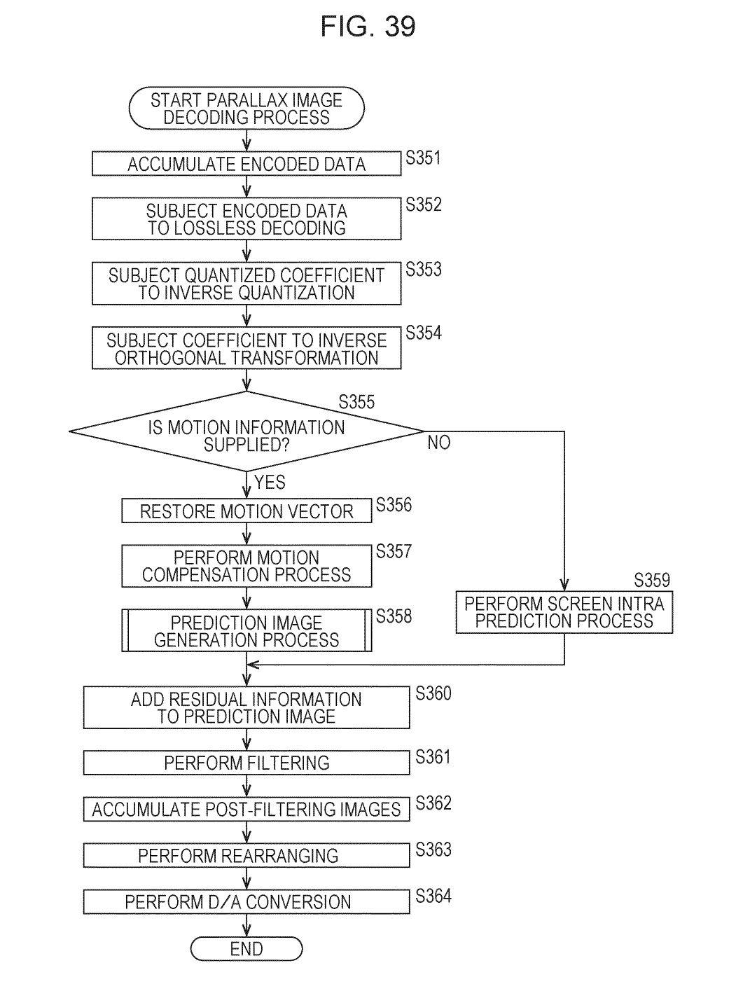

FIG. 39 is a flowchart for illustrating the processes relating to the decoding process of the depth image. In other words, description will be given of the processes that are executed on the side that receives the depth stream of the depth image of a predetermined viewpoint, which is encoded using the depth prediction image of a depth image of a predetermined viewpoint that is corrected using the information relating to the depth image of a predetermined viewpoint in the processes of the encoding side described above, and the information relating to the depth image of a predetermined viewpoint.

FIG. 39 is a flowchart that illustrates the parallax image decoding process of the slice decoding unit 552 shown in FIGS. 36 to 38 in detail. The parallax image decoding process is performed for each viewpoint.

The slice decoding unit 552 shown in FIG. 39 has the same general configuration as the slice decoding unit 174 shown in FIGS. 16 and 17; however, it was explained that the internal configuration of the correction unit 583 is different. Accordingly, the processes other than the processes that the correction unit 583 performs are, generally, the same processes as those of the slice decoding unit 552 shown in FIGS. 16 and 17, that is, are performed as the same processes as the processes of the flow chart shown in FIG. 20. Here, description relating to parts that overlap the parts illustrated by the flowchart shown in FIG. 20 will be omitted.

The processes of steps S351 to S357 and steps S359 to S364 of FIG. 39 are performed in the same manner as the processes of steps S261 to S267 and steps S270 to S275 of FIG. 20. In other words, in the prediction image generation process that is executed in step S358, other than differing from the processes of the flowchart shown in FIG. 20, generally the same processes are executed.

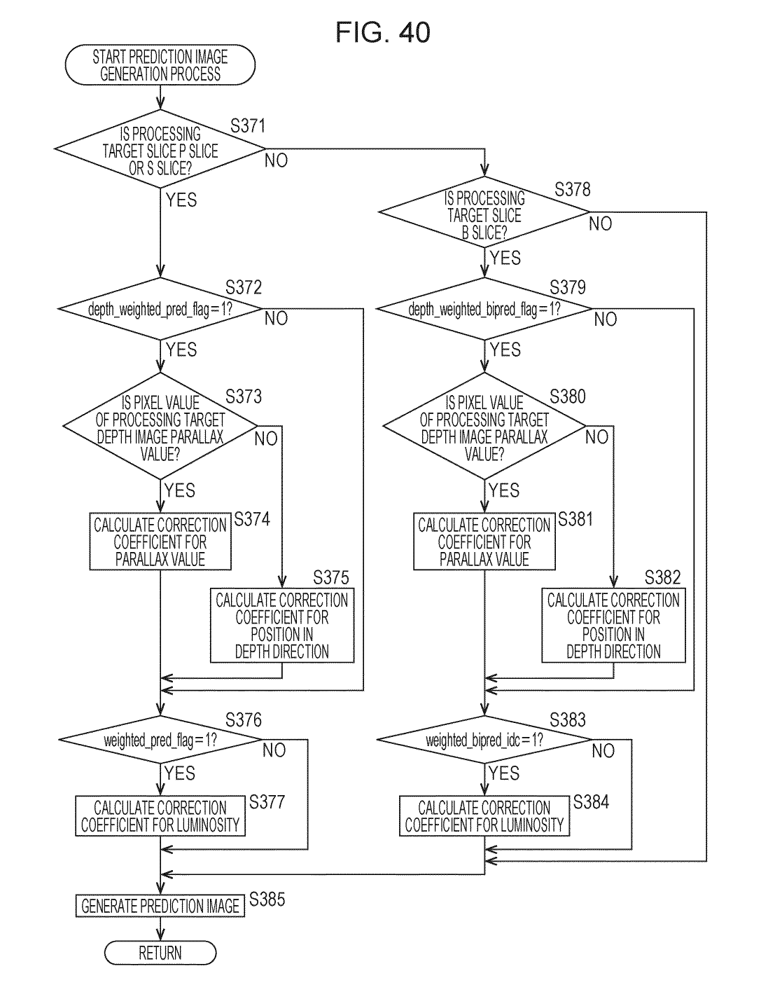

Here, description will be given of the prediction image generation process that is executed in step S358 with reference to the flowchart of FIG. 40.

In step S371, it is determined whether the processing-target slice is a P slice or an SP slice. In step S371, when it is determined that the processing-target slice is a P slice or an SP slice, the process proceeds to step S372. In step S372, it is determined whether or not depth_weighted_pred_flag=1.

When it is determined that depth_weighted_pred_flag=1 in step S372, the process proceeds to step S373, and when it is determined that depth_weighted_pred_flag=1 is not true in step S372, the processes of steps S373 to S375 are skipped, and the process proceeds to step S376.

In step S373, it is determined whether or not the pixel values of the processing-target depth image are parallax values. In step S373, when it is determined that the pixel values of the processing-target depth image are parallax values, the process proceeds to step S374.

In step S374, the correction coefficient for the parallax value is calculated by the depth correction unit 603. In the same manner as the depth correction unit 341 of FIG. 26, the depth correction unit 603 calculates the correction coefficients (the disparity weighting coefficient and the disparity offset) based on the parallax maximum value, the parallax minimum value and the inter-camera distance. When the correction coefficient is calculated, the post-correction prediction image is temporarily calculated. Here, the term “temporarily” is used because, in the same manner as the encoding side, since correction of the luminosity values is performed at a later stage, the post-correction prediction image is not the final prediction image that is used in the decoding.

On the other hand, in step S373, when it is determined that the pixel values of the processing-target depth image are not parallax values, the process proceeds to step S375. In this case, since the pixel values of the processing-target depth image are depth values that indicate the position (the distance) in the depth direction, in step S375, in the same manner as the depth correction unit 341 of FIG. 26, the depth correction unit 603 calculates the correction coefficients (the depth weighting coefficient and the depth offset) based on the maximum value and the minimum value of the position (the distance) in the depth direction. When the correction coefficient is calculated, the post-correction prediction image is temporarily calculated. Here, the term “temporarily” is used because, in the same manner as the encoding side, since correction of the luminosity values is performed at a later stage, the post-correction prediction image is not the final prediction image that is used in the decoding.

When the correction coefficient is calculated in step S374 or step S375, or, when it is determined that depth_weighted_pred_flag=1 is not true in step S372, the process proceeds to step S376.

In step S376, it is determined whether or not weighted_pred_flag=1. When it is determined that weighted_pred_flag=1 in step S376, the process proceeds to step S377. In step S377, the correction coefficient for the luminosity is calculated by the luminosity correction unit 604. In the same manner as the luminosity correction unit 342 of FIG. 26, the luminosity correction unit 604 calculates the correction coefficient for the luminosity that is calculated based on a predetermined method. The correction coefficient that is calculated is used, and the prediction image in which the luminosity is corrected is calculated.

When the correction coefficient for the luminosity is calculated in this manner, or, when it is determined that weighted_pred_flag=1 is not true in step S376, the process proceeds to step S385. In step S385, the correction coefficient and the like that are calculated are used, and the prediction image is generated.

On the other hand, in step S371, when it is determined that the processing-target slice is not a P slice or an SP slice, the process proceeds to step S378, and it is determined whether or not the processing-target slice is a B slice. In step S378, when it is determined that the processing-target slice is a B slice, the process proceeds to step S379, and when it is determined not to be a B slice, the process proceeds to step S385.

In step S379, it is determined whether or not depth_weighted_bipred_flag=1. When it is determined that depth_weighted_bipred_flag=1 in step S379, the process proceeds to step S380, and when it is determined that depth_weighted_bipred_flag=1 is not true, the processes of steps S380 to S382 are skipped, and the process proceeds to step S383.

In step S380, it is determined whether or not the pixel values of the processing-target depth image are parallax values. In step S380, when it is determined that the pixel values of the processing-target depth image are parallax values, the process proceeds to step S381, and the correction coefficient for the parallax value is calculated by the depth correction unit 603. In the same manner as the depth correction unit 341 of FIG. 26, the depth correction unit 603 calculates the correction coefficients based on the parallax maximum value, the parallax minimum value and the inter-camera distance. The correction coefficient that is calculated is used, and the prediction image that is corrected is calculated.

On the other hand, in step S380, when it is determined that the pixel values of the processing-target depth image are not parallax values, the process proceeds to step S382. In this case, since the pixel values of the processing-target depth image are depth values that indicate the position (the distance) in the depth direction, in step S382, in the same manner as the depth correction unit 341 of FIG. 26, the depth correction unit 603 calculates the correction coefficients based on the maximum value and the minimum value of the position (the distance) in the depth direction. The correction coefficient that is calculated is used, and the prediction image that is corrected is calculated.

When the correction coefficient is calculated in step S381 or step S382, or, when it is determined that depth_weighted_bipred_flag=1 is not true in step S379, the processes proceeds to step S383.

In step S383, it is determined whether or not weighted_bipred_idc=1. In step S383, when it is determined that weighted_bipred_idc=1, the process proceeds to step S384. In step S384, the correction coefficient for the luminosity is calculated by the luminosity correction unit 604. In the same manner as the luminosity correction unit 342 of FIG. 26, the luminosity correction unit 604 calculates the correction coefficient for the luminosity that is calculated based on a predetermined method, for example, the AVC method. The correction coefficient that is calculated is used, and the prediction image in which the luminosity is corrected is calculated.

When the correction coefficient for the luminosity is calculated in this manner, when it is determined that weighted_bipred_idc=1 is not true in step S383, or, when the processing-target slice is determined not to be a B slice in step S378, the processes proceeds to step S385. In step S385, the correction coefficient and the like that are calculated are used, and the prediction image is generated.

When the prediction image generation process in step S358 (FIG. 39) is executed in this manner, the process proceeds to step S360. The processes that follow step S360 are performed in the same manner as the processes that follow step S271 of FIG. 20, and since description thereof has already been given, description is omitted here.

The correction coefficients for the parallax values and the correction coefficients for the positions (the distances) in the depth direction are calculated for a case in which the pixel values of the processing-target depth image are parallax values, and a case in which the pixel values are not parallax values, respectively. Therefore, it is possible to appropriately support a case in which the prediction image is generated from the parallax values, and a case in which the prediction image is generated from the depth values that indicate the positions in the depth direction, and it is possible to calculate appropriate correction coefficients. In addition, by also calculating the correction coefficients for luminosity, it is also possible to appropriately perform the luminosity correction.

Furthermore, here, description is given with the assumption that the correction coefficients for the parallax values and the correction coefficients for the positions (the distances) in the depth direction are calculated for a case in which the pixel values of the processing-target depth image are parallax values, and a case in which the pixel values are not parallax values (a case in which the pixel values are depth values), respectively. However, one of the correction coefficients may be calculated. For example, at the encoding side and the decoding side, when parallax values are used as the pixel values of the processing-target depth image, and the correction coefficients for the parallax values are set to be calculated, only the correction coefficients for the parallax values may be calculated. In addition, for example, at the encoding side and the decoding side, when depth values that indicate positions (distances) in the depth direction are used as the pixel values of the processing-target depth image, and the correction coefficients for the positions (the distances) in the depth direction are set to be calculated, only the correction coefficients for the positions (the distances) in the depth direction may be calculated.

### <About Calculation Precision 1>

As described above, the encoding side, for example, calculates the correction coefficient for the position in the depth direction in step S333 (FIG. 35), and the decoding side, for example, calculates the correction coefficient for the position in the depth direction in step S375 (FIG. 40). In this manner, the encoding side and the decoding side calculate the correction coefficient for the position in the depth direction, respectively; however, since if the correction coefficients that are calculated are not the same, different prediction images are generated, it is necessary that the same correction coefficient be calculated at the encoding side and the decoding side. In other words, it is necessary that the calculation precision be the same at the encoding side and the decoding side.

Furthermore, here, description is continued giving the correction coefficient for the position (the distance) in the depth direction as an example; however, the correction coefficient for the parallax value is the same.

Here, Equation (15) that is used when calculating the correction coefficient for the position in the depth direction is shown again below as Equation (16).

$$\begin{matrix}[ Formula . 13 ] & \\ \begin{matrix}{V}_{ref}^{′} = \frac{\frac{1}{{Zref}_{near}} - \frac{1}{{Zref}_{far}}}{\frac{1}{{Zcur}_{near}} - \frac{1}{{Zcur}_{far}}} \cdot {v}_{ref} + 255 \cdot \frac{\frac{1}{{Zref}_{far}} - \frac{1}{{Zcur}_{far}}}{\frac{1}{{Zcur}_{near}} - \frac{1}{{Zcur}_{far}}} \\ = a {v}_{ref} + b\end{matrix} & ( 16 )\end{matrix}$$

The portion of the correction coefficient a within Equation (16) is represented by the following Equation (17).

$$\begin{matrix}[ Formula . 14 ] & \\ a = \frac{\frac{1}{{Zref}_{near}} - \frac{1}{{Zref}_{far}}}{\frac{1}{{Zcur}_{near}} - \frac{1}{{Zcur}_{far}}} = \frac{A - B}{C - D} & ( 17 )\end{matrix}$$

In order to set A, B, C and D in Equation (17) to be fixed point number values, each is calculated from the following Equation (18).

A=INT({1<<shift}/Zrefₙₑₐᵣ)

B=INT({1<<shift}/Zref_{far})

C=INT({1<<shift}/Zcurₙₑₐᵣ)

D=INT({1<<shift}/Zcur_{far}) (18)

In Equation (17), A is (1/Zrefₙₑₐᵣ); however, there is a likelihood that (1/Zrefₙₑₐᵣ) will become a value including a numerical value beyond the radix point. Hypothetically, in a case in which a process such as discarding numbers beyond the radix point is performed when a value beyond the radix point is included, there is a likelihood that a difference will emerge in the calculation precision at the encoding side and the decoding side due to the numerical value beyond the radix point that is discarded.

For example, when the integer portion is a large value, hypothetically, even if the numerical value beyond the radix point is discarded, since the proportion that the numerical value beyond the radix point constitutes of the entire numerical value is small, a significant error will not emerge in the calculation precision; however, when the integer portion is a small value, for example, when the integer portion is 0, the numerical value beyond the radix point is important, and there is a likelihood that an error will emerge in the calculation precision when the numerical value beyond the radix point is discarded in such a case.

Therefore, as described above, when the numerical value beyond the radix point is important, it is possible to perform control such that the numerical value beyond the radix point is not discarded by setting A, B, C and D to be fixed point numbers. In addition, A, B, C and D described above are set to be fixed point numbers; however, the correction coefficient a that is calculated from these values is also a value that satisfies the following Equation (19).

a={(A−B)<<denom}/(C−D) (19)

In Equation (19), it is possible to use luma_log2_weight_denom that is defined by AVC as denom.

For example, when the value of 1/Z is 0.12345, and when the value is Mbit shifted, subsequently rounded to an INT and treated as an integer, this results in the following.

0.12345→×1000 INT(123.45)=123

In this case, due to the INT of 123.45, which is obtained by multiplying the value by 1000, being calculated, the integer value 123 is used as the value of 1/Z. In addition, in this case, if the information×1000 is shared by the encoding side and the decoding side, it is possible to cause the calculation precisions to match.

In this manner, when a floating point number is attained, the floating point number is converted into a fixed point number, and is further converted from a fixed point number to an integer. The fixed point number is, for example, represented by an integer Mbit and a fraction Nbit, and M and N are set according to a standard. In addition, the integer is, for example, set to an N digit integer portion and an M digit fraction portion, which are set to an integer value a and a fraction value b. For example, in the case of 12.25, N=4, M=2, a=1100 and b=0.01. In addition, in this case, (a<<M+b)=110001.

In this manner, the portion of the correction coefficient a may be calculated based on Equation (18) and Equation (19). Furthermore, if the values of shift and denom are configured to be shared by the encoding side and the decoding side, it is possible to cause the calculation precision of the encoding side and the decoding side to match. The sharing method can be realized by supplying the values of shift and denom from the encoding side to the decoding side. In addition, the sharing method can be realized by setting the encoding side and the decoding side to use the same values of shift and denom, that is, set to use fixed values.

Here, description is given with the portion of the correction coefficient a as an example; however, the portion of the correction coefficient b may be calculated in the same manner. In addition, the fraction precision according to the shift described above may be set to be the fraction precision of the position Z or more. In other words, the shift may be set such that the value that is multiplied in the shift is greater than the value that is multiplied by the position Z. Furthermore, in other words, the fraction precision of the position Z may be set to the fraction precision according to the shift or less.

In addition, when delivering shift and denom, these may be delivered together with depth_weighted_pred_flag. Here, the correction coefficient a and the correction coefficient b, that is, the weighting coefficient and the offset of position Z, are described as being shared by the encoding side and the decoding side; however, the calculation order may also be set and shared.

It is possible to adopt a configuration in which the depth correction unit 341 (FIG. 26) is provided with the setting unit that sets such a calculation precision. In this case, when the depth correction unit 341 performs the depth weighting prediction process that uses the depth weighting coefficient and the depth offset with the depth image as the target, it is possible to adopt a configuration in which the calculation precision used in the calculation is set. In addition, as described above, the depth correction unit 341 performs the depth weighting prediction process on the depth image according to the calculation precision that is set, and it is possible to adopt a configuration in which the depth stream is generated by encoding the depth image using the depth prediction image that is obtained as a result. In the same manner, the depth correction unit 603 (FIG. 38) can also be configured to be provided with the setting unit that sets the calculation precision.

When the order of calculation is different, since there is a likelihood that the same correction coefficient will not be calculated, the calculation order may also be shared by the encoding side and the decoding side. In addition, the sharing method thereof, in the same manner as the case described above, may be shared by being delivered, and may be shared by being set as a fixed value.

In addition, the shift parameter that indicates the shift amount of the shift calculation is set, and the shift parameter that is set may be set to be delivered and received together with the depth stream that is generated. The shift parameter may be set to be fixed in sequence units, and variable in GOP, Picture (picture) and Slice (slice) units.

### <About Calculation Precision 2>

When the portion of the correction coefficient a in Equation (16) described above may be modified to be represented by the following Equation (20).

$$\begin{matrix}[ Formula . 15 ] & \\ a = \frac{( {Zref}_{far} - {Zref}_{near} ) ( {Zcur}_{near} * {Zcur}_{far} )}{( {Zcur}_{far} - {Zcur}_{near} ) ( {Zref}_{near} * {Zref}_{far} )} & ( 20 )\end{matrix}$$

In Equation (20), since in the numerator (Zcurₙₑₐᵣ×Zcur_{far}) and the denominator (Zrefₙₑₐᵣ×Zref_{far}), the Zs are multiplied by one another, there is a likelihood that overflowing will occur. For example, when the upper limit is 32 bit and denom=5, 27 bits remain; thus, when set in this manner, 13 bit×13 bit is the limit. Accordingly, in this case, only ±4096 can be used as the value of Z; however, it is anticipated that a value that is greater than 4096, such as 10,000, will be used as the value of Z, for example.

Accordingly, in order to perform control such that the portion of Z×Z does not overflow and the range of values of Z is widened, when the correction coefficient a is calculated using Equation (20), the correction coefficient a is calculated by setting Z to a value that satisfies the following Equation (21).

Znear=Znear<<x

Zfar=Zfar<<y (21)

Control is performed to satisfy Equation (21) by lowering the precision of Znear and Zfar by shifting such that overflowing does not occur.

The shift amounts such as x and y are the same as the case described above, and may be shared by being delivered from the encoding side to the decoding side, and may be shared by the encoding side and the decoding side as fixed values.

The information used in the correction coefficients a and b and the information relating to the precision (the shift amount) may be included in the slice header, and may be included in the NAL (Network Abstraction Layer) of the SPS, the PPS or the like.

### Second Embodiment

[Description of Computer to which Present Technology is Applied]

Next, the series of processes described above may be performed using hardware, and may be performed using software. When the series of processes is performed using software, the program that configures the software is installed on a general use computer or the like.

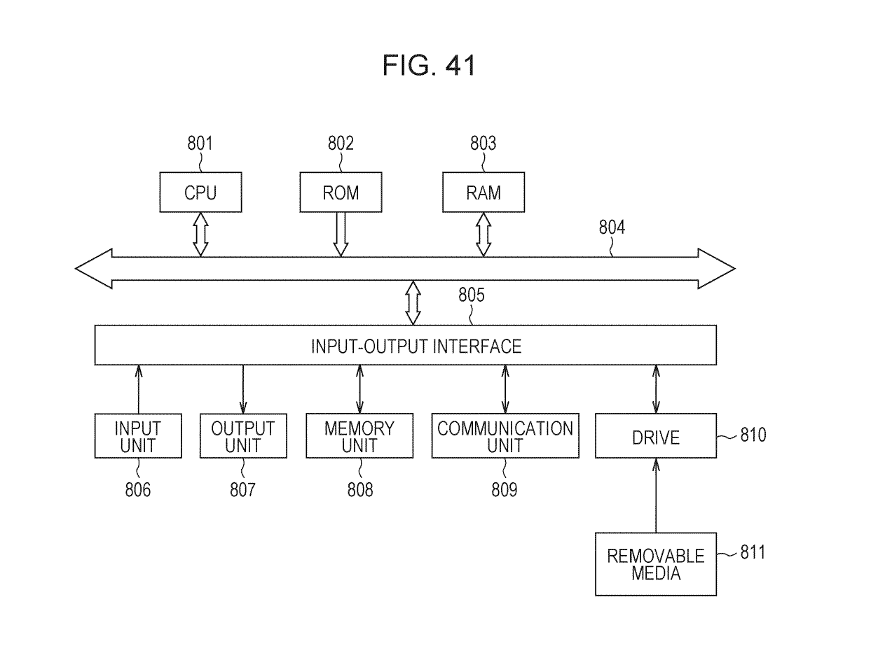

Therefore, FIG. 41 shows a configuration example of an embodiment of the computer on which the program, which executes the series of processes described above, is installed.

The program can be recorded in advance on a memory unit 808 or ROM (Read Only Memory) 802 that serves as a recording medium that is built into the computer.

Alternatively, the program can be stored (recorded) on removable media 811. The removable media 811 can be provided as so-called packaged software. Here, examples of the removable media 811 include, a flexible disk, a CD-ROM (Compact Disc Read Only Memory), an MO (Magneto Optical) disk, a DVD (Digital Versatile Disc), a magnetic disk, semiconductor memory and the like.

Furthermore, in addition to being installed on the computer via a drive 810 from the removable media 811 such as that described above, it is possible to download the program onto the computer via a communication network or a broadcast network and to install the program on the memory unit 808 that is built in. In other words, the program can be transferred to the computer in a wireless manner via a satellite for digital satellite broadcasting from a download site, for example, and can be transferred to the computer in a wired manner via a network such as a LAN (Local Area Network) or the Internet.

A CPU (Central Processing Unit) 801 is built into the computer, and an input-output interface 805 is connected to the CPU 801 via a bus 804.

When a command is input by a user operating an input unit 806 or the like via the input-output interface 805, the CPU 801 executes the program that is stored in the ROM 802 according to the command. Alternatively, the CPU 801 loads the program that is stored in the memory unit 808 into the RAM (Random Access Memory) 803 and executes the program.

Accordingly, the CPU 801 performs the processes according to the flowchart described above, or, performs the processes that are performed according to the configuration of the block diagrams described above. Furthermore, as necessary, the CPU 801 outputs the results of the processes from an output unit 807 via the input-output interface 805, for example, or, transmits the results from the communication unit 809 and further causes the memory unit 808 to record the results or the like.

Furthermore, the input unit 806 is configured of a keyboard, a mouse, a microphone or the like. In addition, the output unit 807 is configured of an LCD (Liquid Crystal Display), a speaker or the like.

Here, in the present specification, the processes that the computer performs according to the program need not necessarily be performed in time series order in the order denoted by the flowcharts. In other words, the processes that the computer performs according to the program include processes that are executed in parallel, or, individually (for example, parallel processing or object-based processing).

In addition, the program may be processed by one computer (processor), and may also be processed in a distributed manner by a plurality of computers. Furthermore, the program may be transferred to a distant computer and executed.

The present technology can be applied to an encoding device and a decoding device that are used when performing communication via network media such as satellite broadcast, cable TV (television), the Internet, mobile telephones and the like, or, when processing on recording media such as optical or magnetic disks and flash memory.

In addition, the encoding device and the decoding device described above can be applied to arbitrary electronic devices. Description will be given of examples thereof hereinafter.

### Third Embodiment

### [Configuration Example of Television Device]

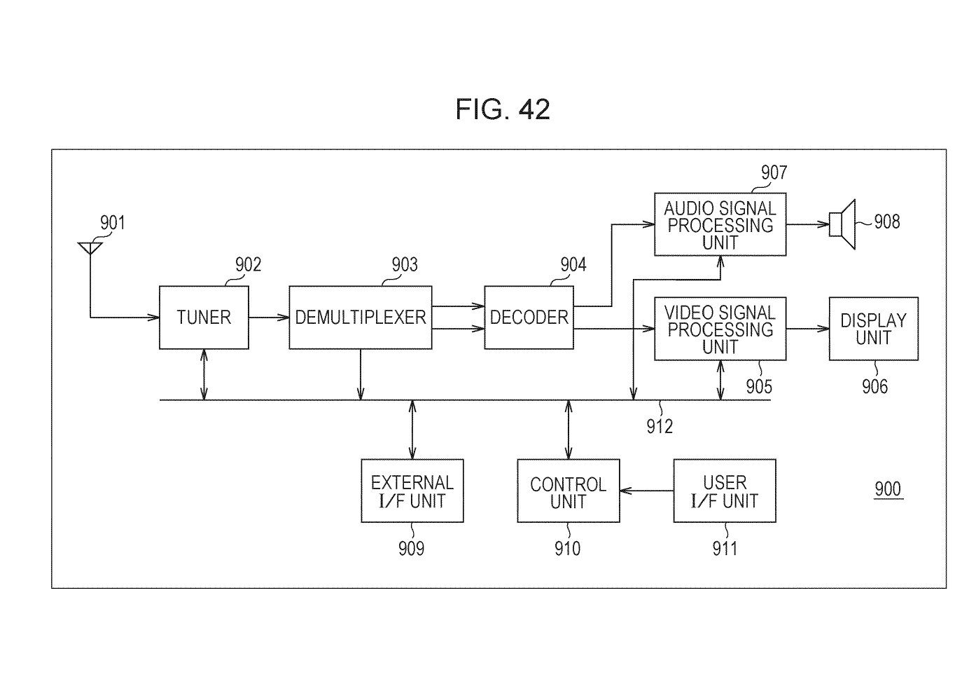

FIG. 42 shows an example of the schematic configuration of a television device to which the present technology is applied. A television device 900 includes an antenna 901, a tuner 902, a demultiplexer 903, a decoder 904, a video signal processing unit 905, a display unit 906, an audio signal processing unit 907, a speaker 908 and an external interface unit 909. Furthermore, the television device 900 includes a control unit 910, a user interface unit 911 and the like.

The tuner 902 selects a desired channel from a broadcast signal that is received by the antenna 901, performs demodulation, and outputs the encoded bitstream that is obtained to the demultiplexer 903.

The demultiplexer 903 extracts the video and the audio packets of the show, which is the viewing target, from the encoded bitstream, and outputs the packet data that is extracted to the decoder 904. In addition, the demultiplexer 903 supplies packets of data such as an EPG (Electronic Program Guide) to the control unit 910. Furthermore, when scrambling has been performed, removal of the scrambling is performed by the demultiplexer or the like.

The decoder 904 performs the decoding process of the packets, the video data that is generated by the decoding process is output to the video signal processing unit 905, and the audio data is output to the audio signal processing unit 907.

The video signal processing unit 905 performs noise removal, video processing and the like corresponding to user settings in relation to the video data. The video signal processing unit 905 generates the video data of a show to be displayed on the display unit 906, image data according to a process based on an application that is supplied via the network, and the like. In addition, the video signal processing unit 905 generates the video data for displaying a menu screen or the like such as the item selection, and superimposes the video data onto the video data of the show. The video signal processing unit 905 generates a drive signal based on the video data that is generated in this manner, and drives the display unit 906.

The display unit 906 drives display devices (for example, liquid crystal display devices or the like) based on the drive signal from the video signal processing unit 905, and causes the display devices to display the video of the show and the like.

The audio signal processing unit 907 subjects the audio data to a predetermined process such as noise removal, performs audio output by subjecting the post-processing audio data to a D/A conversion process and an amplification process and supplying the result to the speaker 908.

The external interface unit 909 is an interface for connecting to external devices or to a network, and performs data transmission and reception of the video data, the audio data and the like.

The user interface unit 911 is connected to the control unit 910. The user interface unit 911 is configured of an operation switch, a remote control signal reception unit and the like, and supplies an operation signal corresponding to a user operation to the control unit 910.

The control unit 910 is configured using a CPU (Central Processing Unit), memory and the like. The memory stores the program that is executed by the CPU, the various data that is necessary for the CPU to perform the processes, the EPG data, data that is acquired via the network and the like. The program that is stored in the memory is read out and executed by the CPU at a predetermined timing such as when the television device 900 starts up. By executing the program, the CPU controls each part such that the television device 900 performs an operation that corresponds to the user operation.

Furthermore, the television device 900 is provided with the tuner 902, the demultiplexer 903, the video signal processing unit 905, the audio signal processing unit 907, an external interface unit 909 and the like and a bus 912 for connecting the control unit 910.

In a television device that is configured in this manner, the decoder 904 is provided with the function of the decoding device (the decoding method) of the present application. Therefore, it is possible to decode the encoded data of the parallax image in which the encoding efficiency is improved by performing encoding using the information relating to the parallax image.

### Fourth Embodiment

### [Configuration Example of Mobile Telephone]

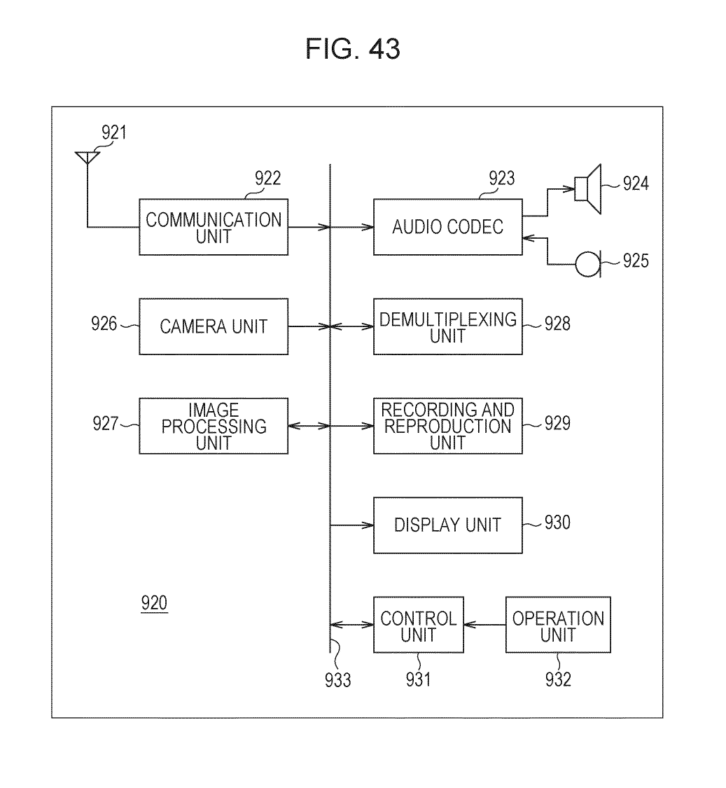

FIG. 43 shows an example of a schematic configuration of a mobile telephone to which the present technology is applied. A mobile telephone 920 includes a communication unit 922, an audio codec 923, a camera unit 926, an image processing unit 927, a demultiplexing unit 928, a recording and reproduction unit 929, a display unit 930 and a control unit 931. These are connected to one another via a bus 933.

In addition, an antenna 921 is connected to the communication unit 922, and a speaker 924 and a microphone 925 are connected to the audio codec 923. Furthermore, the operation unit 932 is connected to the control unit 931.

The mobile telephone 920 performs various operations such as transmission and reception of audio signals, transmission and reception of electronic mail and image data, image photography and data recording in various modes such as an audio call mode and a data communication mode.

In the audio call mode, the audio signal, which is generated by the microphone 925, is converted into audio data and data compression is performed thereon by the audio codec 923, and the result is supplied to the communication unit 922. The communication unit 922 performs a modulation process of the audio data, a frequency conversion process or the like and generates the transmission signal. In addition, the communication unit 922 supplies the transmission signal to the antenna 921 and transmits the transmission signal to a base station (not shown). In addition, the communication unit 922 performs the amplification, the frequency conversion process, the demodulation process and the like of the received signal that is received by the antenna 921, and supplies the obtained audio data to the audio codec 923. The audio codec 923 subjects the audio data to data expansion and conversion to an analogue signal, and outputs the result to the speaker 924.

In addition, in the data communication mode, when performing mail transmission, the control unit 931 receives the character data that is input by the operation of the operation unit 932, and displays the characters that are input on the display unit 930. In addition, the control unit 931 generates the mail data based on the user commands and the like in the operation unit 932, and supplies the mail data to the communication unit 922. The communication unit 922 performs the modulation process, the frequency conversion process and the like of the mail data, and transmits the transmission signal that is obtained from the antenna 921. In addition, the communication unit 922 performs the amplification, the frequency conversion process, the demodulation process and the like of the received signal that is received by the antenna 921, and restores the mail data. The mail data is supplied to the display unit 930, and the display of the mail content is performed.

Furthermore, the mobile telephone 920 can also cause the recording and reproduction unit 929 to store the mail data that is received on a storage medium. The storage medium is an arbitrary re-writable storage medium. Examples of the storage medium include semiconductor memory such as RAM and built-in flash memory, a hard disk, removable media such as a magnetic disk, a magneto optical disk, an optical disk, USB memory or a memory card.

When transmitting image data in the data communication mode, the image data that is generated by the camera unit 926 is supplied to the image processing unit 927. The image processing unit 927 performs the encoding processes of the image data and generates the encoded data.

The demultiplexing unit 928 multiplexes the encoded data that is generated by the image processing unit 927 and the audio data that is supplied from the audio codec 923 using a predetermined method and supplies the multiplexed data to the communication unit 922. The communication unit 922 performs the modulation process, the frequency conversion process and the like of the multiplexed data, and transmits the transmission signal that is obtained from the antenna 921. In addition, the communication unit 922 performs the amplification, the frequency conversion process, the demodulation process and the like of the received signal that is received by the antenna 921, and restores the multiplexed data. The multiplexed data is supplied to the demultiplexing unit 928. The demultiplexing unit 928 performs the demultiplexing of the multiplexed data, and supplies the encoded data to the image processing unit 927 and the audio data to the audio codec 923. The image processing unit 927 performs the decoding processes of the encoded data and generates the image data. The image data is supplied to the display unit 930, and the display of the image that is received is performed. The audio codec 923 outputs the audio that is received by converting the audio data into an analogue audio signal, and supplying the analogue audio signal to the speaker 924.

In a mobile telephone device that is configured in this manner, the image processing unit 927 is provided with the functions of the encoding device and the decoding device (the encoding method and the decoding method) of the present application. Therefore, it is possible to improve the encoding efficiency of the parallax image using the information relating to the parallax image. In addition, it is possible to decode the encoded data of the parallax image in which the encoding efficiency is improved by performing encoding using the information relating to the parallax image.

### Fifth Embodiment

### [Configuration Example of Recording and Reproduction Device]

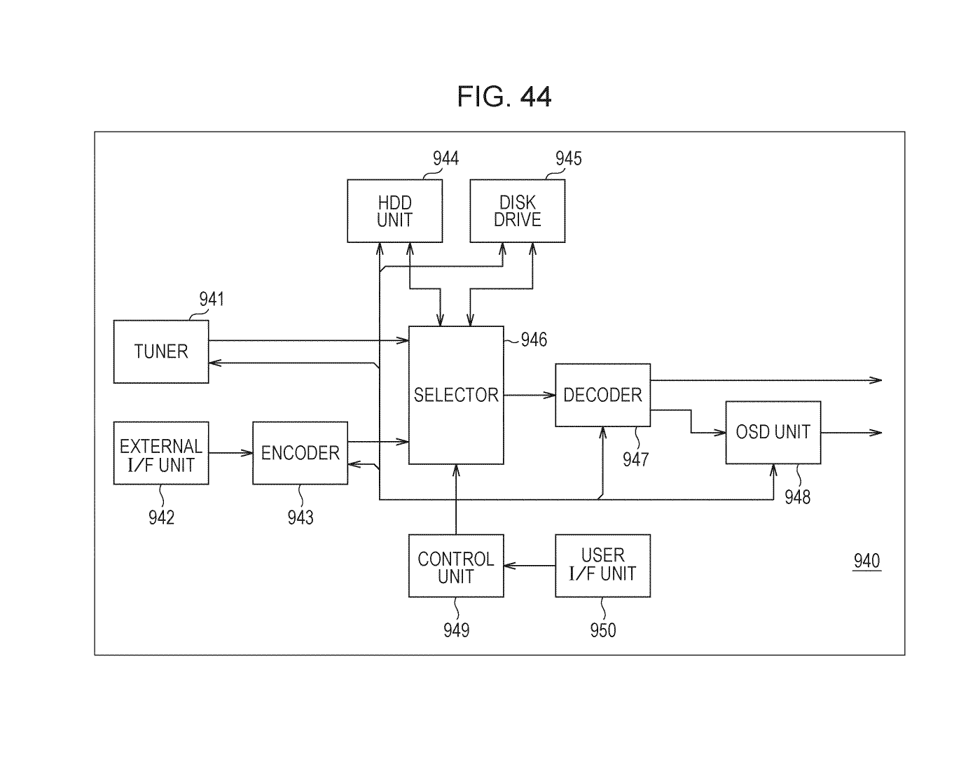

FIG. 44 shows an example of the schematic configuration of the recording and reproduction device to which the present technology is applied. A recording and reproduction device 940 records audio data and video data of a broadcast show that is received, for example, on a recording medium, and provides a user with the data that is recorded at a timing that corresponds to a command of the user. In addition, it is possible to cause the recording and reproduction device 940 to acquire the audio data and the video data from another device, for example, and to record the data onto the recording medium. Furthermore, the recording and reproduction device 940 can perform image display and audio output on a monitor device or the like by decoding and outputting the audio data and the video data that are recorded on the recording medium.

The recording and reproduction device 940 includes an a tuner 941, an external interface unit 942, an encoder 943, a HDD (Hard Disk Drive) unit 944, a disk drive 945, a selector 946, a decoder 947, an OSD (On-Screen Display) unit 948, a control unit 949 and a user interface unit 950.

The tuner 941 selects a desired channel from a broadcast signal that is received by the antenna (not shown). The tuner 941 outputs an encoded bitstream, which is obtained by demodulating the received signal of the desired channel, to the selector 946.

The external interface unit 942 is configured of at least one of an IEEE 1394 interface, a network interface unit, a USB interface, a flash memory interface or the like. The external interface unit 942 is an interface for connecting to external devices, a network, a memory card or the like, and performs data reception of the video data, the audio data and the like that are recorded.

The encoder 943 performs encoding using a predetermined method when the video data and the audio data that are supplied from the external interface unit 942 are not encoded, and outputs the encoded bitstream to the selector 946.

The HDD unit 944 records content data such as video and audio, various programs, other data and the like on a built-in hard disk, and, during reproduction and the like, reads out the recorded content from the hard disk.

The disk drive 945 performs recording and reproduction of a signal in relation to an optical disk that is mounted. The optical disk, for example, a DVD disk (DVD-Video, DVD-RAM, DVD-R, DVD-RW, DVD+R, DVD+RW and the like), a Blu-ray disk or the like.

During recording of the video and the audio, the selector 946 selects the encoded bitstream from one of the tuner 941 and the encoder 943, and supplies the encoded bitstream to one of the HDD unit 944 and the disk drive 945. In addition, during reproduction of the video and the audio, the selector 946 supplies the encoded bitstream, which is output from the HDD unit 944 or the disk drive 945, to the decoder 947.

The decoder 947 performs a decoding process of the encoded bitstream. The decoder 947 supplies the video data that is generated by performing the decoding process to the OSD unit 948. In addition, the decoder 947 outputs the audio data that is generated by performing the decoding process.

The OSD unit 948 generates the video data for displaying the menu screen and the like such as the item selection, superimposes the video data onto the video data that is output from the decoder 947 and outputs the result.

The user interface unit 950 is connected to the control unit 949. The user interface unit 950 is configured of an operation switch, a remote control signal reception unit and the like, and supplies an operation signal corresponding to a user operation to the control unit 949.

The control unit 949 is configured using a CPU, memory and the like. The memory stores the program that is executed by the CPU and the various data that is necessary for the CPU to perform the processes. The program that is stored in the memory is read out and executed by the CPU at a predetermined timing such as when the recording and reproduction device 940 starts up. By executing the program, the CPU controls each part such that the recording and reproduction device 940 performs an operation that corresponds to the user operation.

In a recording and reproduction device that is configured in this manner, the decoder 947 is provided with the function of the decoding device (the decoding method) of the present application. Therefore, it is possible to decode the encoded data of the parallax image in which the encoding efficiency is improved by performing encoding using the information relating to the parallax image.

### Sixth Embodiment

### [Configuration Example of Imaging Device]

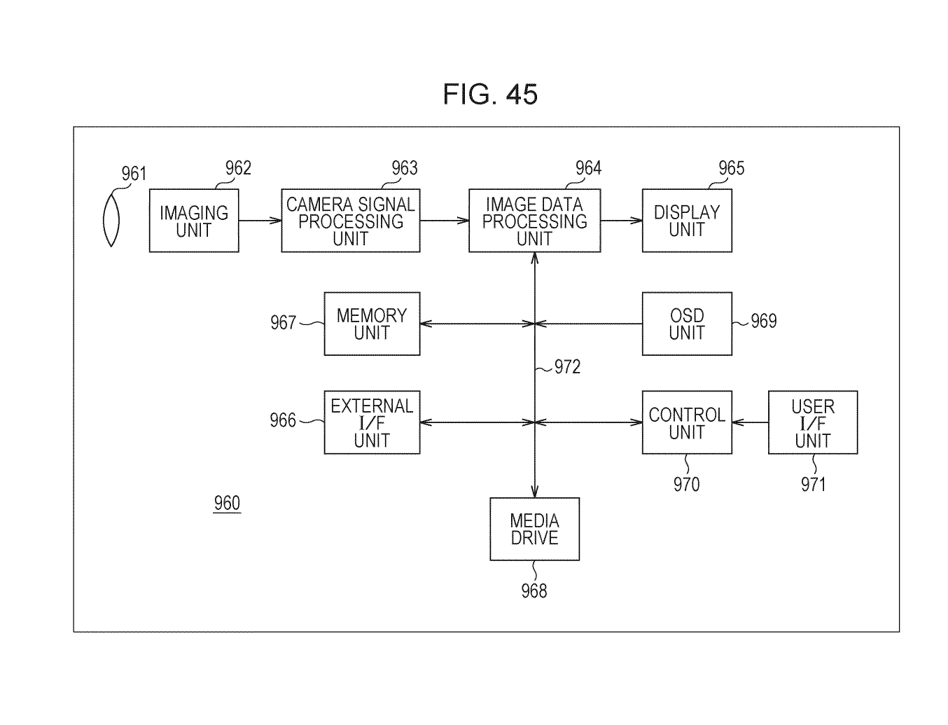

FIG. 45 shows an example of the schematic configuration of an imaging device to which the present technology is applied. An imaging device 960 images an object, causes the display unit to display an image of the object, records the image on a recording medium as image data.

The imaging device 960 includes an optical block 961, an imaging unit 962, a camera signal processing unit 963, an image data processing unit 964, a display unit 965, an external interface unit 966, a memory unit 967, a media drive 968, an OSD unit 969 and a control unit 970. In addition, a user interface unit 971 is connected to the control unit 970. Furthermore, the image data processing unit 964, the external interface unit 966, the memory unit 967, the media drive 968, the OSD unit 969, the control unit 970 and the like are connected to one another via a bus 972.

The optical block 961 is configured using a focus lens, an aperture mechanism or the like. The optical block 961 causes an optical image of the object to form on an imaging surface of the imaging unit 962. The imaging unit 962 is configured using a CCD or a CMOS image sensor, generates an electrical signal corresponding to the optical image using photoelectric conversion, and supplies the electrical signal to the camera signal processing unit 963.

The camera signal processing unit 963 performs various camera signal processes such as knee correction, gamma correction and color correction in relation to the electrical signal that is supplied from the imaging unit 962. The camera signal processing unit 963 supplies the post-camera signal processing image data to the image data processing unit 964.

The image data processing unit 964 performs the encoding process of the image data that is supplied from the camera signal processing unit 963. The image data processing unit 964 supplies the encoded data that is generated by performing the encoding process to the external interface unit 966 or the media drive 968. In addition, the image data processing unit 964 performs the decoding process of the encoded data that is supplied from the external interface unit 966 or the media drive 968. The image data processing unit 964 supplies the image data that is generated by performing the decoding process to the display unit 965. In addition, the image data processing unit 964 superimposes the display data, which is acquired from a process of supplying the image data that is supplied from the camera signal processing unit 963 to the display unit 965, or from the OSD unit 969, onto the image data. The image data processing unit 964 supplies the result thereof to the display unit 965.

The OSD unit 969 generates the display data such as menu screens and icons that are formed of symbols, characters or graphics, and outputs the display data to the image data processing unit 964.

The external interface unit 966 is configured of a USB input-output terminal or the like, for example, and when performing printing of the image, is connected to a printer. In addition, a drive is connected to the external interface unit 966 as necessary, removable media such as a magnetic disk or an optical disk is appropriately mounted therein, and a computer program that is read out therefrom is installed, as necessary. Furthermore, the external interface unit 966 includes a network interface that is connected to a predetermined network such as a LAN or the Internet. The control unit 970, for example, reads out the encoded data from the memory unit 967 according to the commands from the user interface unit 971, and can supply the encoded data from the external interface unit 966 to another device that is connected via the network. In addition, the control unit 970 acquires the encoded data and the image data that are supplied from another device via the network via the external interface unit 966, and can supply the encoded data and the image data to the image data processing unit 964.

Usable examples of the recording media that is driven by the media drive 968 include a magnetic disk, a magneto optical disk, an optical disk, or arbitrary removable media that can be read from and written to such as semiconductor memory. In addition, the type of removable media of the recording media is also arbitrary, and may be a tape device, a disk or a memory card. Naturally, the type may be a contactless IC card or the like.

In addition, the media drive 968 and the recording media may be integrated, for example, and be configured of a non-transportable recording medium such as a built-in hard disk drive or an SSD (Solid State Drive).

The control unit 970 is configured using a CPU, memory and the like. The memory stores the program that is executed by the CPU and the various data that is necessary for the CPU to perform the processes. The program that is stored in the memory is read out and executed by the CPU at a predetermined timing such as when the imaging device 960 starts up. By executing the program, the CPU controls each part such that the imaging device 960 performs an operation that corresponds to the user operation.

In an imaging device that is configured in this manner, the image data processing unit 964 is provided with the functions of the encoding device and the decoding device (the encoding method and the decoding method) of the present application. Therefore, it is possible to improve the encoding efficiency of the parallax image using the information relating to the parallax image. In addition, it is possible to decode the encoded data of the parallax image in which the encoding efficiency is improved by performing encoding using the information relating to the parallax image.

The embodiments of the present technology are not limited to the embodiments described above, and various modifications may be made within the scope not departing from the spirit of the present technology.

Furthermore, the present technology may adopt the following configurations.

(1) An image processing device that includes a setting unit that sets a calculation precision of a calculation that is used when performing a depth weighting prediction process with a depth image as a target using a depth weighting coefficient and a depth offset; a depth weighting prediction unit that generates a depth prediction image by performing the depth weighting prediction process in relation to the depth image using information relating to the depth image according to the calculation precision that is set by the setting unit; and an encoding unit that generates a depth stream by encoding the depth image using the depth prediction image that is generated by the depth weighting prediction unit.

(2) The image processing device according to (1), in which the setting unit sets the calculation precision to match between the calculation when encoding the depth image and the calculation when decoding the depth image.

(3) The image processing device according to (2), in which the setting unit sets the calculation precision when calculating the depth weighting coefficient.

(4) The image processing device according to (2) or (3), in which the setting unit sets the calculation precision when calculating the depth offset.

(5) The image processing device according to (3) or (4), in which the setting unit sets the calculation precision to a fixed point number precision.

(6) The image processing device according to (5), in which the depth weighting prediction unit performs a shift calculation during the calculation according to the calculation precision.

(7) The image processing device according to (6), in which the setting unit sets a fraction precision according to the shift calculation to a fraction precision of the depth image or greater.

(8) The image processing device according to (6), in which the setting unit sets a fraction precision of the depth image to a fraction precision according to the shift calculation or less.

(9) The image processing device according to any of (6) to (8) in which the setting unit sets a shift parameter that indicates a shift amount of the shift calculation, and in which the image processing device further comprises a delivery unit that delivers the depth stream that is generated by the encoding unit and the shift parameter that is set by the setting unit.

(10) The image processing device according to any of (2) to (9), in which the setting unit sets the calculation order when calculating the depth weighting coefficient.

(11) The image processing device according to any of (2) to (10), in which the setting unit sets the calculation order when calculating the depth offset.

(12) An image processing method in which an image processing device includes a setting step of setting a calculation precision of a calculation that is used when performing a depth weighting prediction process with a depth image as a target using a depth weighting coefficient and a depth offset; a depth weighting prediction step of generating a depth prediction image by performing the depth weighting prediction process in relation to the depth image using information relating to the depth image according to the calculation precision that is set by a process of the setting step; and an encoding step of generating a depth stream by encoding the depth image using the depth prediction image that is generated by a process of the depth weighting prediction step.

(13) An image processing device that includes a reception unit that receives a depth stream, which is encoded using a depth prediction image that is corrected using information relating to a depth image, and the information relating to the depth image; a decoding unit that generates the depth image by decoding the depth stream that is received by the reception unit; a setting unit that sets a calculation precision of a calculation that is used when performing a depth weighting prediction process with the depth image that is generated by the decoding unit as a target using a depth weighting coefficient and a depth offset; and a depth weighting prediction unit that generates the depth prediction image by performing the depth weighting prediction in relation to the depth image using the information relating to the depth image that is received by the reception unit according to the calculation precision that is set by the setting unit, in which the decoding unit decodes the depth stream using the depth prediction image that is generated by the depth weighting prediction unit.

(14) The image processing device according to (13), in which the setting unit sets the calculation precision to match between the calculation when encoding the depth image and the calculation when decoding the depth image.

(15) The image processing device according to (14), in which the setting unit sets the calculation precision when calculating at least one of the depth weighting coefficient and the depth offset.

(16) The image processing device according to (15), the setting unit sets the calculation precision to a fixed point number precision.

(17) The image processing device according to (16), in which the depth weighting prediction unit performs a shift calculation during the calculation according to the calculation precision, and in which the setting unit sets a fraction precision according to the shift calculation to a fraction precision of the depth image or greater.

(18) The image processing device according to (17), in which the reception unit receives a shift parameter that is set as a parameter that indicates a shift amount of the shift calculation, and in which the depth weighting prediction process performs the shift calculation based on the shift parameter.

(19) The image processing device according to any of (14) to (18), in which the setting unit sets the calculation order when calculating at least one of the depth weighting coefficient and the depth offset.

(20) An image processing method, in which an image processing device includes a reception step of receiving a depth stream, which is encoded using a depth prediction image that is corrected using information relating to a depth image, and the information relating to the depth image; a decoding step of generating the depth image by decoding the depth stream that is received by a process of the reception step; a setting step of setting a calculation precision of a calculation that is used when performing a depth weighting prediction process with the depth image that is generated by a process of the decoding step as a target using a depth weighting coefficient and a depth offset; and a depth weighting prediction step of generating the depth prediction image by performing the depth weighting prediction in relation to the depth image using the information relating to the depth image that is received by the process of the reception step according to the calculation precision that is set by a process of the setting step, in which, in the process of the decoding step, the depth stream is decoded using the depth prediction image that is generated by a process of the depth weighting prediction step.

### REFERENCE SIGNS LIST

50 ENCODING DEVICE, 61 SPS ENCODING UNIT, 123 CALCULATION UNIT, 134 MOTION PREDICTION AND COMPENSATION UNIT, 135 CORRECTION UNIT, 150 DECODING DEVICE, 152 VIEWPOINT COMBINING UNIT, 171 SPS DECODING UNIT, 255 ADDITION UNIT, 262 MOTION COMPENSATION UNIT, 263 CORRECTION UNIT

1. An image processing device, comprising:
a setting unit that sets a calculation precision of a calculation that is used when performing a depth weighting prediction process with a depth image as a target using a depth weighting coefficient and a depth offset;
a depth weighting prediction unit that generates a depth prediction image by performing the depth weighting prediction process in relation to the depth image using information relating to the depth image according to the calculation precision that is set by the setting unit; and
an encoding unit that generates a depth stream by encoding the depth image using the depth prediction image that is generated by the depth weighting prediction unit.

2. The image processing device according to claim 1,
wherein the setting unit sets the calculation precision to match between the calculation when encoding the depth image and the calculation when decoding the depth image.

3. The image processing device according to claim 2,
wherein the setting unit sets the calculation precision when calculating the depth weighting coefficient.

4. The image processing device according to claim 3,
wherein the setting unit sets the calculation precision when calculating the depth offset.

5. The image processing device according to claim 3,
wherein the setting unit sets the calculation precision to a fixed point number precision.

6. The image processing device according to claim 5,
wherein the depth weighting prediction unit performs a shift calculation during the calculation according to the calculation precision.

7. The image processing device according to claim 6,
wherein the setting unit sets a fraction precision according to the shift calculation to a fraction precision of the depth image or greater.

8. The image processing device according to claim 6,
wherein the setting unit sets a fraction precision of the depth image to a fraction precision according to the shift calculation or less.

9. The image processing device according to claim 6,
wherein the setting unit sets a shift parameter that indicates a shift amount of the shift calculation, and
wherein the image processing device further comprises a delivery unit that delivers the depth stream that is generated by the encoding unit and the shift parameter that is set by the setting unit.

10. The image processing device according to claim 2,
wherein the setting unit sets a calculation order when calculating the depth weighting coefficient.

11. The image processing device according to claim 10,
wherein the setting unit sets the calculation order when calculating the depth offset.

12. An image processing method,
wherein an image processing device comprises:
a setting step of setting a calculation precision of a calculation that is used when performing a depth weighting prediction process with a depth image as a target using a depth weighting coefficient and a depth offset;
a depth weighting prediction step of generating a depth prediction image by performing the depth weighting prediction process in relation to the depth image using information relating to the depth image according to the calculation precision that is set by a process of the setting step; and
an encoding step of generating a depth stream by encoding the depth image using the depth prediction image that is generated by a process of the depth weighting prediction step.

13. An image processing device, comprising:
a reception unit that receives a depth stream, which is encoded using a depth prediction image that is corrected using information relating to a depth image, and the information relating to the depth image;
a decoding unit that generates the depth image by decoding the depth stream that is received by the reception unit;
a setting unit that sets a calculation precision of a calculation that is used when performing a depth weighting prediction process with the depth image that is generated by the decoding unit as a target using a depth weighting coefficient and a depth offset; and
a depth weighting prediction unit that generates the depth prediction image by performing the depth weighting prediction in relation to the depth image using the information relating to the depth image that is received by the reception unit according to the calculation precision that is set by the setting unit,
wherein the decoding unit decodes the depth stream using the depth prediction image that is generated by the depth weighting prediction unit.

14. The image processing device according to claim 13,
wherein the setting unit sets the calculation precision to match between the calculation when encoding the depth image and the calculation when decoding the depth image.

15. The image processing device according to claim 14,
wherein the setting unit sets the calculation precision when calculating at least one of the depth weighting coefficient and the depth offset.

16. The image processing device according to claim 15,
wherein the setting unit sets the calculation precision to a fixed point number precision.

17. The image processing device according to claim 16,
wherein the depth weighting prediction unit performs a shift calculation during the calculation according to the calculation precision, and
wherein the setting unit sets a fraction precision according to the shift calculation to a fraction precision of the depth image or greater.

18. The image processing device according to claim 17,
wherein the reception unit receives a shift parameter that is set as a parameter that indicates a shift amount of the shift calculation, and
wherein the depth weighting prediction process performs the shift calculation based on the shift parameter.

19. The image processing device according to claim 14,
wherein the setting unit sets the calculation order when calculating at least one of the depth weighting coefficient and the depth offset.

20. An image processing method,
wherein an image processing device comprises:
a reception step of receiving a depth stream, which is encoded using a depth prediction image that is corrected using information relating to a depth image, and the information relating to the depth image;
a decoding step of generating the depth image by decoding the depth stream that is received by a process of the reception step;
a setting step of setting a calculation precision of a calculation that is used when performing a depth weighting prediction process with the depth image that is generated by a process of the decoding step as a target using a depth weighting coefficient and a depth offset; and
a depth weighting prediction step of generating the depth prediction image by performing the depth weighting prediction in relation to the depth image using the information relating to the depth image that is received by the process of the reception step according to the calculation precision that is set by a process of the setting step, and
wherein, in the process of the decoding step, the depth stream is decoded using the depth prediction image that is generated by a process of the depth weighting prediction step.
